(19) United States
(12) Patent Application Publication
(10) Pub. No.: US 2026/0309960 A1
(43) Pub. Date: Oct. 8, 2026

(54) OPTICAL SYSTEM AND CAMERA MODULE

(71) Applicant: LG INNOTEK CO., LTD., Seoul (KR)

(72) Inventor: Ju Yong SHIM, Seoul (KR)

(21) Appl. No.: 18/996,712

(22) PCT Filed: Sep. 5, 2023
(86) PCT No.: PCT/KR2023/013289

§ 371 Date: Jan. 17, 2025

(30) Foreign Application Priority Data
Oct. 18, 2022 (KR) 10-2022-0134427

(51) Int. Cl. G02B 13/00; G02B 1/04; G02B 3/00; G02B 7/02; G02B 9/64; H04N 23/55

(52) U.S. Cl. CPC G02B 13/0045; G02B 1/041; G02B 7/025; G02B 9/64; G02B 13/006; H04N 23/55; G02B 2003/0093

(57) ABSTRACT

An optical system according to an embodiment of the present invention includes a first lens to a seventh lens disposed along the optical axis, wherein the first lens has a negative (−) refractive power, the combined refractive power of the second lens to the seventh lens is a positive (+) refractive power, the second lens among the first lens to the seventh lens has a smallest effective diameter, and the effective diameter of the first lens is the greatest.

### TECHNICAL FIELD

The present invention relates to an optical system for improved optical performance and a camera module including the same.

### BACKGROUND ART

Advanced driving assistance system (ADAS) is an advanced driver assistance system that assists the driver in driving being configured to sense the situation ahead, judge the situation based on the sensed results, and control the behavior of the vehicle based on the situation judgment. For example, an ADAS sensor device detects a vehicle ahead and recognizes a lane. Afterwards, when the target lane, target speed, and target ahead are determined, the vehicle's electrical stability control (ESC), engine management system (EMS), motor driven power steering (MDPS), and the like are controlled. Representatively, ADAS can be implemented as an automatic parking system, a low-speed city driving assistance system, a blind spot warning system, and so on.

Sensor devices for detecting the situation ahead in ADAS include GPS sensors, laser scanners, front radar, LIDAR, and the like, and the most representative one is a camera for taking pictures of the front, rear, and sides of the vehicle.

These cameras can be disposed outside or inside the vehicle to detect the surroundings of the vehicle. In addition, the cameras can be disposed inside the vehicle to detect the situations of the driver and passengers. For example, the camera can photograph the driver at a location adjacent to the driver and detect the driver's health status, whether the driver is drowsy, whether the driver is drinking, and the like. In addition, the camera can photograph the passenger at a location adjacent to the passenger and detect whether the passenger is sleeping, health status, and the like, and provide the driver with information about the passenger.

In particular, the most important element for obtaining an image from a camera is the imaging lens that forms the image. Recently, interest in high performance such as high definition and high resolution has been increasing, and research on an optical system including multiple lenses is being conducted to implement this. However, there is a problem that the characteristics of the optical system change when the camera is exposed to a harsh environment, such as high temperature, low temperature, moisture, or high humidity, outside or inside the vehicle. In this case, the camera has a problem that it is difficult to uniformly derive excellent optical characteristics and aberration characteristics.

Accordingly, new optical systems and cameras that can solve the above-described problems are required.

### DETAILED DESCRIPTION OF THE INVENTION

### [Technical Subject]

An embodiment is intended to provide an optical system and a camera module having enhanced optical characteristics.

An embodiment is intended to provide an optical system and camera module having excellent optical performance in low-temperature to high-temperature environments.

An embodiment is intended to provide an optical system and camera module capable of preventing or minimizing changes in optical properties over a variety of temperature ranges.

### Technical Solution

In order to solve the above technical problems, an optical system according to an embodiment of the present invention includes a first lens to a seventh lens being disposed along the optical axis, wherein the first lens has a negative (−) refractive power, the combined refractive power of the second lens to the seventh lens has a positive (+) refractive power, the second lens among the first lens to the seventh lens has a smallest effective diameter, and the effective diameter of the first lens is the greatest.

The fourth lens, the fifth lens, and the seventh lens may be made of a plastic material, and at least one among the first lens to the third lens and the sixth lens may be made of a glass material.

The effective diameters of the sixth lens and the seventh lens may be smaller than the effective diameter of the fifth lens.

The object side surface of the second lens may have a flat surface.

Among the first lens to the seventh lens, the lens having the smallest absolute value of focal length may be one among the third lens to the fifth lens.

The absolute values of the focal lengths of the third to fifth lenses can satisfy the following conditional expression.<Conditional expression>|F3|≥|F4|≥|F5| (In the above conditional expression, F3 is the focal length of the third lens, F4 is the focal length of the fourth lens, and F5 is the focal length of the fifth lens.)

In order to solve the above technical problem, an optical system according to another embodiment of the present invention includes first to seventh lenses being disposed along an optical axis, wherein the first lens has negative (−) refractive power, the combined refractive power of the second to seventh lenses has positive (+) refractive power, and the effective diameter of the first lens may be larger than the effective diameter of the third lens.

The optical system includes a cemented lens in which a lens having positive (+) refractive power and a lens having negative (−) refractive power are bonded, and the cemented lens may be formed of two lenses being consecutively disposed among the third to fifth lenses.

The cemented lens may be made of a plastic material, and at least one among the first lens to the third lens and the sixth lens may be made of a glass material.

Among the first to seventh lenses, the absolute value of the focal length of the fifth lens may be the smallest, and the absolute value of the focal length of the sixth lens may be the largest.

At least one of the lenses being disposed most adjacent to the cemented lens on the object side of the cemented lens and the lenses being disposed most adjacent to the cemented lens on the sensor side of the cemented lens may have a biconvex shape.

The absolute value of the radius of curvature of the sensor side surface of the cemented lens may be smaller than the absolute value of the radius of curvature of the object side surface of the cemented lens.

In order to solve the above technical problem, an optical system according to another embodiment of the present invention includes first to seventh lenses being disposed along an optical axis, wherein among the first to seventh lenses, the absolute value of the focal length of the sixth lens is the largest, the absolute value of the focal length of the fifth lens is the smallest, and the following conditional expression can be satisfied. <Conditional expression>0.2<CG1/TTL <0.6 (In the conditional expression, CG1 is a distance between the first lens and the second lens on the optical axis, and TTL is a distance from an object side surface of the first lens in the optical axis to the image sensor.)

The ratio of the absolute values of the focal lengths of the sixth lens and the fifth lens may be greater than 5 times and less than 10 times.

The absolute values of the focal lengths of the third to fifth lenses can satisfy the following conditional expression. <Conditional expression>|F3|≥|F4|>|F5| (In the above conditional expression, F3 is the focal length of the third lens, F4 is the focal length of the fourth lens, and F5 is the focal length of the fifth lens.)

In the optical axis, the seventh lens may have the smallest thickness among the first to seventh lenses, and in the optical axis, the fourth lens may have the largest thickness among the first to seventh lenses.

The thickness of the second lens in the optical axis may be smaller than the thicknesses of the third lens and the fourth lens.

The first lens may have a meniscus shape convex toward the object side.

The third lens may have a biconvex shape.

The first lens, the fifth lens, and the seventh lens may have negative (−) refractive power, and the second lens, the third lens, the fourth lens, and the sixth lens may have positive (+) refractive power.

In order to solve the above technical problem, an optical system according to an embodiment of the present invention includes first to seventh lenses being disposed along an optical axis, wherein the first lens has negative (−) refractive power, the combined refractive power of the second to seventh lenses has positive (+) refractive power, and among the first to third lenses, the effective diameter of the second lens is the smallest, and the thickness of the second lens in the optical axis is greater than that of the first lens.

The fourth to seventh lenses may be made of plastic, and at least one among the first to third lenses may be made of glass.

The effective diameters of the sixth lens and the seventh lens may be smaller than the effective diameter of the fifth lens, and the effective diameter of the third lens among the first to seventh lenses may be the largest.

The second lens may have a meniscus shape convex toward the sensor side.

Among the first lens to the seventh lens, the lens having the smallest absolute value of focal length may be one among the third lens to the fifth lens.

The absolute values of the focal lengths among the third to fifth lenses can satisfy the following conditional expression. <Conditional expression>|F4|≥|F3|≥ |F5| (In the conditional expression, F3 is the focal length of the third lens, F4 is the focal length of the fourth lens, and F5 is the focal length of the fifth lens.)

In order to solve the above technical problem, an optical system according to another embodiment of the present invention includes first to seventh lenses being disposed along an optical axis, wherein the first lens has negative (−) refractive power, effective diameters of the sixth lens and the seventh lens are smaller than the effective diameter of the fifth lens, and the thickness of the second lens in the optical axis may be greater than a thickness of the first lens.

The first lens is made of glass, and the fourth lens and the fifth lens may be made of plastic.

The optical system includes a cemented lens in which a lens having positive (+) refractive power and a lens having negative (−) refractive power are bonded, and at least one of the lens being disposed closest to the cemented lens in the object side of the cemented lens and the lens being disposed closest to the cemented lens in the sensor side of the cemented lens may have a biconvex shape.

The absolute value of the radius of curvature of the sensor side surface of the cemented lens may be smaller than the absolute value of the radius of curvature of the object side surface of the cemented lens.

The object side surface of the cemented lens has a convex shape, and the sensor side surface of the cemented lens may have a concave shape.

The cemented lens may be composed of two lenses being consecutively disposed among the third lens to the fifth lens.

In order to solve the above technical problem, an optical system according to another embodiment of the present invention includes first to seventh lenses being disposed along an optical axis, wherein among the first to seventh lenses, the absolute value of the focal length of the second lens is the largest, the absolute value of the focal length of the fifth lens is the smallest, and a ratio of the absolute values of the focal lengths of the second lens and the fifth lens may be greater than 5 times and less than 10 times.

The ratio of the absolute values of the focal lengths of the second lens and the third lens may be greater than 2 and less than 10.

The absolute values of the focal lengths of the third to fifth lenses can satisfy the following conditional expression. <Conditional expression>|F4|≥|F3|≥|F5| (In the conditional expression, F3 is the focal length of the third lens, F4 is the focal length of the fourth lens, and F5 is the focal length of the fifth lens.)

In the optical axis, the fifth lens has the smallest thickness among the first to seventh lenses, and in the optical axis, the second lens may have the largest thickness among the first to seventh lenses.

The thickness of the second lens in the optical axis may be greater than the thicknesses of the third lens and the fourth lens.

Among the first to seventh lenses, the absolute value of the radius of curvature of the sensor side surface of the sixth lens may be the largest, and the absolute value of the radius of curvature of the sensor side surface of the fifth lens may be the smallest.

The third lens may have a biconvex shape.

The absolute value of the curvature radius of the object side surface of the third lens and the absolute value of the curvature radius of the sensor side surface of the third lens may be the same.

### Advantageous Effects

An optical system and a camera module according to an embodiment may have enhanced optical characteristics. In detail, in an optical system according to an embodiment, a plurality of lenses may have set thicknesses, refractive powers, and gap from adjacent lenses. Accordingly, an optical system and a camera module according to an embodiment may have enhanced MTF characteristics, aberration control characteristics, resolution characteristics, and the like in a range of set angle of view, and may have good optical performance in the edge portion of the angle of view.

In addition, an optical system and a camera module according to an embodiment can have good optical performance in a low temperature to high temperature range (−40° C. to 105° C.). In detail, a plurality of lenses included in the optical system can have set materials, refractive powers, and refractive indices. Accordingly, when the refractive index of each lens changes according to a temperature change and the focal length of each lens changes due to this, it can be mutually compensated by the plastic lens and the glass lens. That is, the optical system can effectively perform distribution of refractive power in a low temperature to high temperature range, and can prevent or minimize changes in optical characteristics in a low temperature to high temperature range. Therefore, an optical system and a camera module according to an embodiment can maintain enhanced optical characteristics in various temperature ranges.

In addition, an optical system and a camera module according to an embodiment can satisfy the set angle of view by mixing the plastic lens and the glass lens and implement excellent optical characteristics. As a result, the optical system can provide a slimmer vehicle camera module. Accordingly, the optical system and camera module can be provided for various applications and devices, and can have excellent optical characteristics even in harsh temperature environments, such as when exposed to the outside of a vehicle or inside a vehicle at high temperatures in the summer.

### BRIEF DESCRIPTION OF DRAWINGS

FIG. 1 is a side cross-sectional view of an optical system according to a first embodiment and a camera module having the same.

FIG. 2 is a side cross-sectional view for explaining the relationship between the nth and n-1th lenses according to FIG. 1.

FIG. 3 is a table showing lens characteristics of the optical system of FIG. 1.

FIG. 4 is a table showing aspherical coefficients of lenses in the optical system of FIG. 1.

FIG. 5 is a table showing the thickness of each lens and the gap between adjacent lenses in the optical system of FIG. 1.

FIG. 6 is a table showing sag values of lens surfaces of the third to sixth lenses in the optical system of FIG. 1.

FIG. 7 is a table showing chief ray angle (CRA) data at room temperature, low temperature, and high temperature according to the position of the image sensor in the optical system of FIG. 1.

FIG. 8 is a graph showing data on the diffraction modulation transfer function (MTF) of the optical system of FIG. 1 at room temperature.

FIG. 9 is a graph showing data on the diffraction MTF of the optical system of FIG. 1 at low temperature.

FIG. 10 is a graph showing data on the diffraction MTF of the optical system of FIG. 1 at high temperature.

FIG. 11 is a graph showing data on the aberration characteristics of the optical system of FIG. 1 at room temperature.

FIG. 12 is a graph showing data on the aberration characteristics of the optical system of FIG. 1 at low temperature.

FIG. 13 is a graph showing data on the aberration characteristics of the optical system of FIG. 1 at high temperature.

FIG. 14 is a graph showing the relative illumination according to the height of an image sensor according to a first embodiment.

FIG. 15 is a cross-sectional side view of an optical system and a camera module having the same according to a second embodiment.

FIG. 16 is a cross-sectional view for explaining the relationship between the nth and n-1th lenses according to FIG. 15.

FIG. 17 is a table showing the lens characteristics of the optical system of FIG. 15.

FIG. 18 is a table showing the aspherical coefficients of the lenses in the optical system of FIG. 15.

FIG. 19 is a table showing the thickness of each lens and the gap between adjacent lenses in the optical system of FIG. 15.

FIG. 20 is a table showing the sag values of the lens surfaces of the third to sixth lenses in the optical system of FIG. 15.

FIG. 21 is a table showing chief ray angle (CRA) data at room temperature, low temperature, and high temperature according to the position of the image sensor in the optical system of FIG. 15.

FIG. 22 is a graph showing data on the diffraction modulation transfer function (MTF) of the optical system of FIG. 15 at room temperature.

FIG. 23 is a graph showing data on the diffraction MTF of the optical system of FIG. 15 at low temperature.

FIG. 24 is a graph showing data on the diffraction MTF of the optical system of FIG. 15 at high temperature.

FIG. 25 is a graph showing data on the aberration characteristics of the optical system of FIG. 15 at room temperature.

FIG. 26 is a graph showing data on aberration characteristics at low temperatures of the optical system of FIG. 15.

FIG. 27 is a graph showing data on aberration characteristics at high temperatures of the optical system of FIG. 15.

FIG. 28 is a graph showing the relative illumination according to the height of the image sensor according to the second embodiment.

FIG. 29 is an example of a vehicle having an optical system according to an embodiment of the invention.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or disposed in “on (above)” or “below (under)” of each component, “on (above)” or “below (under)” means that it includes not only the case where the two components are directly in contact with, but also the case where one or more other components are formed or disposed between the two components. In addition, when expressed as “on (above)” or “below (under)”, the meaning of not only an upward direction but also a downward direction based on one component may be included.

In the description of the invention, the “object side surface” may mean a surface of a lens facing the object side with respect to the optical axis (OA), and the “sensor side surface” may mean a surface of a lens facing the imaging surface (image sensor) with respect to the optical axis. The “object side” may be the “object side surface,” and the “sensor side surface” may be the “image side.” A convex surface of a lens may mean a convex shape in the optical axis or the paraxial region, and a concave surface of a lens may mean a concave shape in the optical axis or the paraxial region. The radius of curvature, the center thickness, and the optical axis gap between lenses described in the table for lens data may mean values (unit: mm) in the optical axis. The vertical direction may mean a direction perpendicular to the optical axis, and the end of a lens or a lens surface may mean the end of an effective area of a lens through which incident light passes. The size of the effective diameter of the lens surface may have a measurement error of up to ±0.4 mm depending on the measurement method, and the like. The paraxial region means a very narrow region near the optical axis, and is a region where the distance of light falling from the optical axis OA is almost 0. Hereinafter, the meaning of the optical axis may include the center of each lens or a very narrow region near the optical axis.

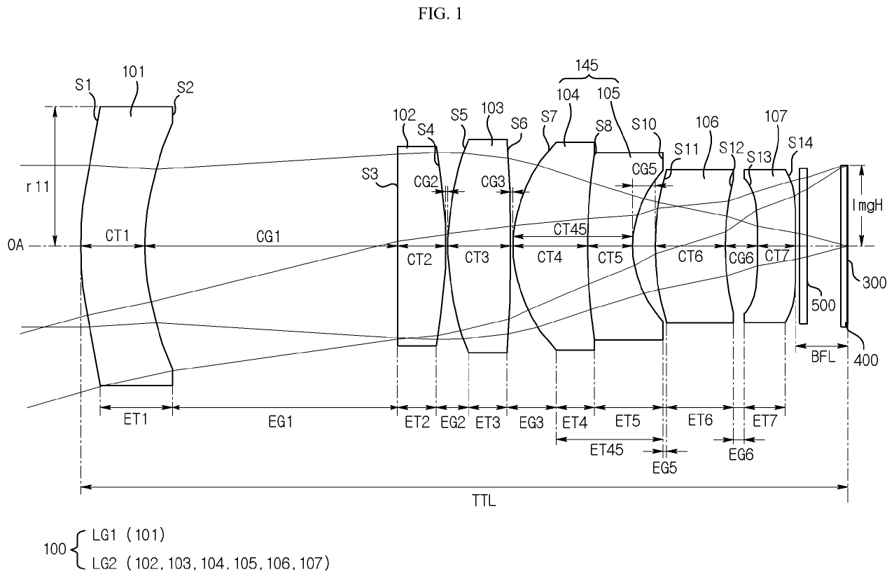

As shown in FIG. 1, an optical system 1000 according to a first embodiment of the present invention may include five or more lenses. The optical system 1000 and the camera module having the same may be mounted inside or outside a vehicle to monitor a driver or sense external objects or lanes. The material of the lenses may be selected from glass or plastic, and the linear expansion coefficient of glass is smaller than that of plastic. Accordingly, glass lenses are employed to suppress changes in the focal imaging position due to temperature changes. However, glass lenses are more expensive than plastic lenses, and there is a problem that it is difficult to meet the demand for low cost. Therefore, the lenses in the optical system 1000 are required to have a mixed configuration of glass lenses and plastic lenses. By employing such plastic lenses, the optical system 1000 can provide weight reduction and low cost by reducing the thickness of the plastic lenses, and can provide good correction for various aberrations such as spherical aberration and chromatic aberration due to the plastic lenses. Additionally, plastic lenses can provide aspherical lenses, which can help minimize distortion in the edge portion.

The optical system 1000 may include n lenses, where the nth lens may be the last lens adjacent to the image sensor 300, and the (n-1)th lens may be the lens closest to the last lens. n is an integer greater than or equal to 5, for example, it may be 5 to 8. The n lenses may have a ratio of plastic lenses to glass lenses in a range of 2:3 to 2:6 or in a range of 3:4 to 3:5.

The optical system 1000 may include a plurality of lens groups LG1 and LG2. In detail, each of a plurality of lens groups LG1 and LG2 includes at least one lens. For example, the optical system 1000 may include a first lens group LG1 and a second lens group LG2, which are sequentially disposed from the object side toward the image sensor 300 along the optical axis OA.

The number of lenses in the first lens group LG1 and the second lens group LG2 may be different from each other. The number of lenses in the second lens group LG2 may be greater than the number of lenses in the first lens group LG1, for example, greater than four or more than five times the number of lenses in the first lens group LG1. The first lens group LG1 may include at least one lens. The first lens group LG1 may have three or less lenses. The first lens group LG1 may preferably be one lens. The second lens group LG2 may include two or more lenses. The second lens group LG2 may have four to seven lenses every day. The second lens group LG2 may preferably be six lenses.

The first lens group LG1 may include at least one lens made of a glass material. The first lens group LG1 may provide a lens closest to the object side as a lens made of a glass material. Such a glass material may prevent surface damage because a change in expansion and contraction according to an external temperature is small, and the surface is not easily scratched.

As for the lens material of the second lens group LG2, at least one lens made of glass and at least one lens made of plastic may be mixed. In the second lens group LG2, at least one lens made of plastic may be disposed in the sensor side rather than the lens made of glass. The second lens group LG2 may include two or more lenses made of glass, for example, 2 to 4 lenses. The second lens group LG2 may be, for example, 2 to 6 lenses. As another example, the second lens group LG2 may have one or more lenses made of plastic. The second lens group LG2 may include two or more lenses made of plastic, for example, 2 to 4 plastic lenses.

At least one lens closest to an object in the optical system 1000 may be a glass material. Three or more lenses closest to an object, for example, three to five lenses, may be a glass material. Since the rate of change in contraction and expansion of the glass lenses according to the temperature change is smaller than that of the plastic material, the glass lenses may be disposed in an area adjacent to the outside within the lens barrel.

At least one lens closest to the image sensor 300 in the optical system 1000 may be a plastic material. For example, at least two lenses closest to the image sensor 300 may be a plastic material, and preferably, at least two lenses adjacent to the image sensor 300 may be a plastic material. That is, since the nth and n-1th lenses in the optical system 1000 are disposed as plastic lenses, various aberrations may be corrected with respect to incident light of the image sensor 300.

Within the optical system 1000, lenses made of plastic material can be consecutively disposed, and lenses made of glass material can be consecutively disposed. Within the optical system 1000, lenses made of plastic material can be disposed between lenses made of glass material. Within the optical system 1000, lenses made of glass material can be disposed between lenses made of plastic material.

Each of the lenses 101 to 107 may have an object side surface and a sensor side surface. In the optical system, the number of lenses having an aspherical sensor side surface and an aspherical object side surface may be greater than the number of plastic lenses. In the optical system, the number of lenses having a spherical sensor side surface and a spherical object side surface may be smaller than that of lenses having both sides aspherical. Since the optical system 1000 includes more aspherical lenses than spherical lenses, various aberrations may be corrected.

Among the lenses of the optical system 1000, a lens having a maximum refractive index may be located adjacent to the first lens group LG1 or the object. The maximum refractive index may be 1.7 or more. The chromatic dispersion of light incident on a lens having the maximum refractive index can be increased, and the center thickness can be made thinner than the edge thickness. In addition, since the lens having the maximum refractive index is disposed on the object side, it is easy to change the radius of curvature of the second and subsequent lenses, and the center thickness can be increased.

Within the optical system 1000, a lens having a maximum effective diameter may be disposed closest to the object side. Within the optical system 1000, a lens having a maximum effective diameter may be disposed at a center portion of the object side and the sensor side. The effective diameter of the lens may increase and then decrease as it goes from the object side to the sensor side. The effective diameter of the lens may decrease and then increase and then decrease again as it goes from the object side to the sensor side. Through this, since the light incident on the optical system 1000 is structured to move away from the optical axis and then gather back toward the optical axis, the optical system 1000 can form a stable optical path.

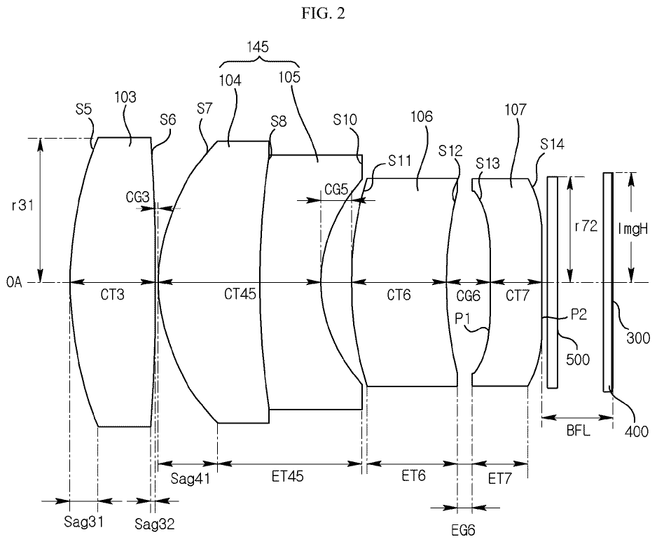

The effective diameter may be the diameter of the effective area on which valid light is incident from each lens. The effective diameter is the length in the direction X and Y being orthogonal to the optical axis, and is the average of the effective diameter on the object side surface of each lens and the effective diameter on the sensor side surface. The “diameter of the lens surface” may mean the “effective diameter of the lens.” The “diameter of the lens” may be the diameter of the entire lens including the flange portion of the lens in addition to the effective area of the lens. Although the flange of the lens is not illustrated in FIGS. 1 and 2, the flange may be a portion that protrudes perpendicularly to the optical axis from the side surface of the lens so that the lens is coupled to the barrel. Valid light may not be incident on the flange. A spacer may be additionally disposed between the flanges of different lenses so that the lenses are coupled to the barrel.

Each of the lenses 101 to 107 may include an effective area and an ineffective area. The effective area may be an area through which light incident on each of the lenses passes. That is, the effective area may be defined as an effective area or effective diameter through which the incident light is refracted to implement optical characteristics. The ineffective area may be disposed around the periphery of the effective area. The ineffective area may be an area through which valid light is not incident from a plurality of lenses. That is, the ineffective area may be an area unrelated to the optical characteristics. In addition, an end of the ineffective area may be an area fixed to a lens barrel or the like that accommodates the lens.

Within the optical system 1000, the total top length (TTL) may be more than 2 times, for example, more than 4 times and less than 12 times, than ImgH. The total track length (TTL) is the distance from the center of the object side surface of the first lens to the top surface of the image sensor 300 on the optical axis OA. ImgH is the distance from the optical axis OA to the diagonal end of the image sensor 300 or ½ of the maximum diagonal length. Within the optical system 1000, the effective focal length (EFL) is provided to be 10 mm or more and the angle of view (FOV) is provided to be less than 45 degrees, so that the optical system may be provided as a standard optical system in a vehicle camera module. For example, the optical system and the camera module according to an embodiment may be applied to an advanced driving assistance system (ADAS) camera provided inside or outside the vehicle.

The optical system 1000 may have a condition of TTL/ImgH of 5 or more and 7.5 or more, for example, 6 or more and 7 or less. By setting the value of TTL/ImgH to 5 or more and 7.5 times or less, the optical system 1000 may provide a vehicle lens optical system. The total number of lenses of the first and second lens groups LG1 and LG2 is 8 or less. Accordingly, the optical system 1000 may provide an image without exaggeration or distortion of the image formed.

Within the optical system 1000, the effective diameter of at least one plastic lens may be smaller than the length of the image sensor 300. The effective diameter is the diameter or length of the effective area where light is incident. The length of the image sensor 300 is the maximum length of the diagonal in the direction orthogonal to the optical axis OA. Within the optical system 1000, the number of lenses having an effective diameter larger than the length of the image sensor 300 may be 50% or more or 60% or more, and the number of lenses having an effective diameter smaller than the length of the image sensor 300 may be less than 50% or less than 40%.

The optical system 1000 may include at least one cemented lens 145 therein. The cemented lens 145 is a lens in which at least two lenses having different refractive powers are bonded, and the distance between the two lenses may be less than 0.01 mm. The cemented lens 145 may be a lens in which two lenses having different focal lengths are bonded. The bonding of the two lenses may be bonded with an adhesive. The effective diameter of at least one or all lenses disposed on the object side with respect to the cemented lens 145 may be greater than the length of the image sensor 300. The effective diameter of at least one lens disposed on the sensor side with respect to the cemented lens 145 may be less than the length of the image sensor 300. Also, the object side lens 104 of the cemented lens 145 may be greater than the length of the image sensor 300, and the sensor side lens 105 may be greater than the length of the image sensor 300.

The lenses between the cemented lenses 145 and the first lens 101 may be made of glass or plastic. The lenses disposed between the cemented lenses 145 and the image sensor 300 may be made of plastic. The lenses between the cemented lenses 145 and the first lens 101 may be spherical lenses on both sides or aspherical lenses on both sides. The lenses disposed between the cemented lenses 145 and the image sensor 300 may be aspherical lenses on both sides. Both surfaces are object side surface and sensor side surface. Therefore, by arranging the aspherical lenses between the cemented lenses 145 and the image sensor 300, the optical performance can be improved by correcting the curvature aberration and the chromatic aberration.

In an optical axis OA, the first lens group LG1 and the second lens group LG2 may have set gaps. In the optical axis OA, the optical axis gap between the first lens group LG1 and the second lens group LG2 may be an optical axis gap between the sensor side surface of the lens closest to the sensor side among the lenses in the first lens group LG1 and the object side of the lens closest to the object side surface among the lenses in the second lens group LG2. The optical axis gap between the first lens group LG1 and the second lens group LG2 may be three to five times or less of the optical axis distance of the first lens group LG1, for example, may be in a range of four to five times the optical axis distance of the first lens group LG1.

The optical axis distance between the first lens group LG1 and the second lens group LG2 may be equal to or less than twice the optical axis distance of the second lens group LG2, for example, in a range of 1.8 to 1.2 times. The optical axis distance of the second lens group LG2 is an optical axis distance between the object side of the lens closest to the object side surface of the second lens group LG2 and the sensor side surface of the lens closest to the image sensor 300.

Here, among the lens surfaces of the first lens group LG1 and the second lens group LG2, two surfaces facing each other, for example, a sensor side surface of the object side lens may be concave and an object side surface of the sensor side lens may be a flat surface. That is, a sensor side surface closest to a sensor side surface in the first lens group LG1 may be concave, and an object side surface closest to an object side surface in the second lens group LG2 may be a flat surface. The first lens group LG1 diffuses light incident through the object side, and the second lens group LG2 may refract light diffused through the first lens group LG1 into an area of the image sensor 300.

The first lens group LG1 has a negative (−) refractive power, and the second lens group LG2 may have a positive (+) refractive power. A lens closest to an object side among the lenses of the first lens group LG1 has a negative (−) refractive power, and a lens closest to a sensor side among the lenses of the second lens group LG2 may have a negative (−) refractive power. When the focal length is represented by an absolute value, the focal length of the first lens group LG1 may be greater than that of the second lens group LG2, for example, in a range of 5 to 10 times greater than that of the second lens group LG2. The effective focal length (EFL) of the optical system 1000 may be smaller than the absolute value of the focal length of the first lens group LG1. The effective focal length (EFL) of the optical system 1000 may be smaller than the absolute value of the focal length of the first lens group LG1 and may be greater than the absolute value of the focal length of the second lens group LG2.

The number of lenses having positive (+) refractive power in the optical system 1000 may be equal to or greater than the number of lenses having negative (−) refractive power. The number of lenses having negative (−) refractive power may be 50% or more of the total number of lenses. The average refractive index of the lenses having positive (+) refractive power may be greater than the average of the lenses having negative (−) refractive power. Accordingly, the dispersion value of the lenses having negative (−) refractive power may be smaller than the dispersion value of the lenses having positive (+) refractive power.

The lens unit 100 may be a mixture of glass lenses and plastic lenses. The number of plastic lenses may be 60% or less of the total number of lenses, and may be in the range of 30% to 60% or 30% to 50%. Accordingly, when more plastic lenses are disposed inside the camera module, the weight of the camera module can be reduced, and the camera module is easy to polish and process due to the plastic material, is resistant to external impacts, has high price competitiveness, and is easy to secure materials. In addition, various aberrations can be corrected by the plastic lens, so that optical performance deterioration can be prevented.

The first embodiment of the invention can reduce the weight of the camera module by further mixing a plastic lens into the optical system 1000, can provide a lower manufacturing cost, can suppress the deterioration of optical characteristics due to temperature change, can allow various types of plastic lenses to replace glass lenses, and can facilitate polishing and processing of lens surfaces such as aspherical or free-form surfaces.

The lens unit 100 may include lenses of a first material and lenses of a second material disposed along the optical axis OA. The first material may be a glass material, and the second material may be a plastic material. The lenses of the first material may be disposed between the lenses of the second material. The lenses of the second material may be disposed between the lenses of the first material.

The lens unit 100 may include a first material lens having an aspherical surface along the optical axis OA, lenses of the first material having a spherical surface, and lenses of the second material having an aspherical surface. The first material may be a glass material, and the second material may be a plastic material. The lens of the first material having a spherical surface may be disposed between the lenses of the second material having an aspherical surface. The lens of the second material may be disposed between the lens of the first material having an aspherical surface and the lens of the first material having a spherical surface.

The effective diameter of the lens closest to the object side within the lens unit 100 may be larger than the effective diameter of the lens closest to the image sensor 300. Accordingly, the brightness of the optical system can be controlled. The effective diameter may be the average effective diameter of the object side surface and the sensor side surface of each lens. By controlling the effective diameter size of each lens, the optical system 1000 can control the incident light to compensate for the deterioration of the optical characteristics due to resolution and temperature change, improve the chromatic aberration control characteristics, and improve the vignetting characteristics of the optical system 1000.

The lens unit 100 may comprise a first lens 101, a second lens 102, a third lens 103, a fourth lens 104, a fifth lens 105, a sixth lens 106, and a seventh lens 107 aligned from the object side to the sensor side along the optical axis.

Within the lens unit 100, the plastic lens may be a cemented lens or at least one lens adjacent to the image sensor. The focal length (F6) of the sixth lens 106 may be the largest within the optical system and may be larger than the focal length (absolute value) of the second lens group LG2. That is, the condition of |FLG2|<F6 may be satisfied.

Inside the lens unit 100, there may be three or more lenses, for example, four or more, larger than the average effective diameter of the plastic lenses. When the average effective diameter of the plastic lenses is PLca_Aver and the average effective diameter of the glass lenses is GLca_Aver, the condition of PLca_Aver<GLca_Aver may be satisfied. In addition, the condition of 1<GLca_Aver/PLca_Aver<1.5 may be satisfied. In addition, the relationship between the length of the image sensor 300 and the average effective diameter PLca_Aver of the plastic lenses may satisfy the condition of 1≤PLca_Aver/(ImgH*2)<1.5. In addition, the relationship between the average effective diameter of the glass lens and the length of the image sensor 300 may satisfy the condition of 1.1<GLca_Aver/(ImgH*2)<1.5. The difference between the maximum length of the image sensor 300 and the effective diameter of the plastic lens may not be large. Accordingly, by arranging a plastic lens with a small effective diameter adjacent to the image sensor 300, the plastic lenses can disperse color from the center portion to the edge portion of the image sensor 300.

The average effective diameter of the glass materials may be 10 mm or more, for example, in the range of 10 mm to 15 mm. The average effective diameter of the plastic material may be 8 mm or more, for example, in the range of 8 mm to 12 mm. The lens having the minimum effective diameter may be made of plastic, and the lens having the maximum effective diameter may be made of glass. The minimum effective diameter in the lens unit 100 may be in the range of 7 mm to 10 mm, and the maximum effective diameter may be in the range of 11 mm to 18 mm. The plastic lens is designed to have a smaller effective diameter than the glass lens and is disposed so as not to touch the lens barrel, thereby minimizing changes in optical performance due to temperature changes. In addition, the optical system 1000 may improve resolution and chromatic aberration control characteristics by controlling incident light, and may improve vignetting characteristics of the optical system 1000.

The optical system 1000 or the camera module may include an image sensor 300. The image sensor 300 may detect light and convert the light into an electrical signal. The image sensor 300 may detect light sequentially passing through the lens unit 100. The image sensor 300 may include an element capable of detecting incident light, such as a charge coupled device (CCD) or a complementary metal oxide semiconductor (CMOS).

Here, the length of the image sensor 300 is the maximum length in the diagonal direction orthogonal to the optical axis OA, and may be smaller than the effective diameter of the lens closest to the object within the first lens group LG1 and larger than the effective diameter of the lens closest to the sensor within the second lens group LG2. Here, the number of lenses having an effective diameter larger than the length of the image sensor 300 may be 4 to 6, and the number of lenses having an effective diameter smaller than the length of the image sensor 300 may be 1 to 3.

The optical system 1000 or the camera module may include a filter 500. The filter 500 may be disposed between the second lens group LG2 and the image sensor 300. The filter 500 may be disposed between the lens closest to the sensor side among the lenses of the lens unit 100 and the image sensor 300. For example, the filter 500 may be disposed between the nth lens and the image sensor 300.

A cover glass 400 is disposed between the filter 500 and the image sensor 300, protects an upper portion of the image sensor 192, and can prevent the reliability of the image sensor 192 from being deteriorated. The cover glass 400 may be removed. The cover glass 400 may be a protective glass.

The filter 500 may include an infrared filter or an infrared cut-off filter (IR cut-off). The filter 500 may allow light of a set wavelength band to pass therethrough and filter light of a different wavelength band. When the filter 500 includes an infrared filter, it may block radiant heat emitted from external light from being transmitted to the image sensor 300. Furthermore, the filter 500 may allow visible light to pass through and reflect infrared light.

The optical system 1000 according to the first embodiment may include an aperture (Stop). The aperture may adjust the amount of light incident on the optical system 1000. In the lenses disposed between the object and the aperture, the effective diameter of the lens surfaces tends to increase from the object side to the aperture. In the lens surfaces disposed between the aperture and the sensor, the effective diameter of the lens surfaces tends to decrease from the aperture to the sensor side. The tendency for the effective diameter of the lens surfaces to increase or decrease does not only mean the case where the effective diameter of the lens surfaces increases or decreases. For example, it also includes the case where the effective diameter of the lens surfaces increases and then decreases from the aperture to the sensor side.

The aperture may be disposed at a set position. For example, the aperture may be disposed on the periphery of the object side surface or sensor side surface of the lens closest to the object side among the lenses of the second lens group LG2. Unlike this, the aperture may be disposed on the periphery of the object side surface or sensor side surface of the object side lens of the first lens group LG1. Unlike this, at least one lens selected from among the plurality of lenses may function as an aperture. In detail, the object side surface or sensor side surface of one lens selected from among the lenses of the optical system 1000 may function as an aperture for controlling the amount of light.

In the optical system 1000 of the first embodiment, the sum of the refractive indices of the lenses of the lens unit 100 may be 8 or more, for example, in the range of 8 to 15, and the average of the refractive indices may be in the range of 1.58 to 1.7. The sum of the Abbe numbers of each of the lenses may be 300 or more, for example, in the range of 310 to 350, and the average of the Abbe numbers may be 50 or less, for example, in the range of 35 to 47. The sum of the center thicknesses of the entire lens may be 18 mm or more, for example, in the range of 20 to 25 mm, and the average of the center thicknesses may be in the range of 2.8 to 3.5 mm. The sum of the central gaps between the lenses on the optical axis OA may be 10 mm or more, for example, in the range of 10 to 18 mm, and may be smaller than the sum of the center thicknesses of the lenses. In addition, the average value of the effective diameter of each of the lens surfaces S1 to S14 of the lens unit 100 can be provided in a range of 8 mm or more, for example, 8 mm to 15 mm.

In the optical system according to the first embodiment of the invention, the angle of view (diagonal) may be 50 degrees or less, for example, in the range of 20 degrees to 50 degrees. The F number of the optical system or the camera module may be 2.4 or less, for example, in the range of 1.4 to 2.4 or in the range of 1.5 to 1.8. In the optical system according to an embodiment of the invention, the maximum angle of view (diagonal) may be 50 degrees or less, for example, in the range of 20 degrees to 50 degrees. The vehicle optical system may have a horizontal angle of view (FOV_H) in a Y-axis direction that is greater than 20 degrees and less than 40 degrees, for example, in the range of 25 degrees to 35 degrees. In addition, the vertical angle of view is provided with a smaller angle than the horizontal angle of view, and may be 20 degrees or less, for example, in the range of 10 degrees to 20 degrees. At this time, the sensor length in a horizontal direction (Y) can be 8.064 mm±0.5 mm, and the sensor height in the vertical direction (X) can be 4.54 mm±0.5 mm. The horizontal field of view (FOV_H) is the field of view with reference to the horizontal length of the sensor. Accordingly, the focus imaging position can be suppressed from being changed due to temperature change, and it can be provided with a vehicle camera in which various aberrations are well corrected.

Since the first embodiment is an optical system being applied to a vehicle camera, the first lens 101 may be provided as a glass material even though it is designed using a plastic lens and a glass lens together. This is because the glass material has the advantage of being scratch-resistant and insensitive to external temperature compared to the plastic material. The first lens 101 may be a glass mold lens having an aspherical surface and made of glass material. The glass mold lens may be manufactured by placing an optical glass ingot inside a mold having an aspherical shape and through a heating and compression process.

In order to more effectively prevent scratches caused by foreign substances or objects disposed inside a vehicle, a glass lens may be used as the first lens 101, and the object side surface of the first lens 101 may have a gently curved shape so as not to come into contact with external structures. Through this, scratches caused by contact with external structures may be minimized. For driver monitoring, front/rear photography of the vehicle, or lane detection and detection of objects falling around the vehicle while the vehicle is being driven, the angle of view may be more than 20 degrees and less than 40 degrees, and may be, for example, in the range of 25 degrees to 35 degrees. This horizontal angle of view may be a preset angle for an advanced driver assistance system (ADAD).

The optical system 1000 according to a first embodiment may further include a reflective member for changing the path of light. The reflective member may be implemented as a prism that reflects incident light of the first lens group LG1 toward the lenses. Hereinafter, the optical system according to the embodiment will be described in detail.

An optical system according to a first embodiment of the invention will be described.

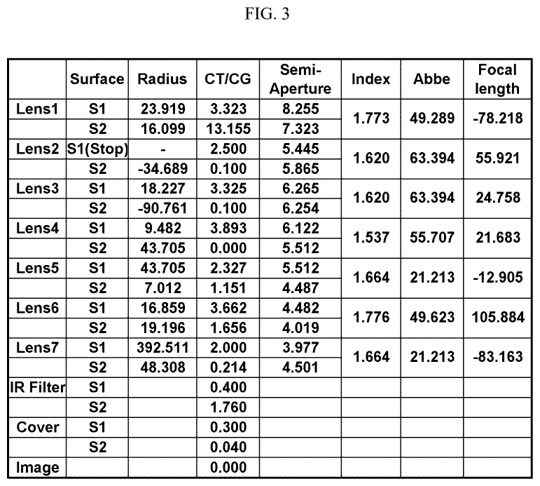

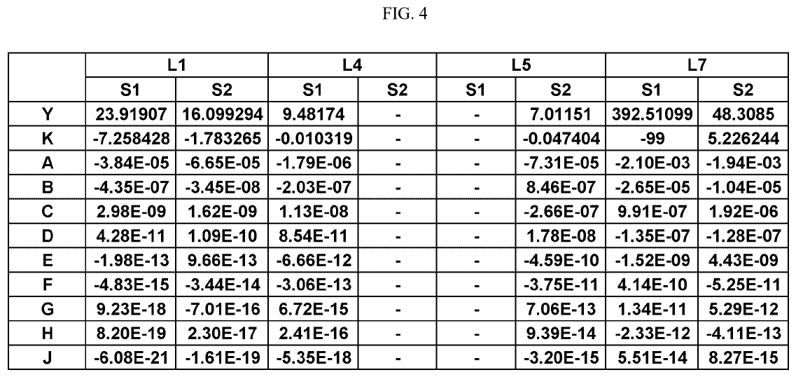

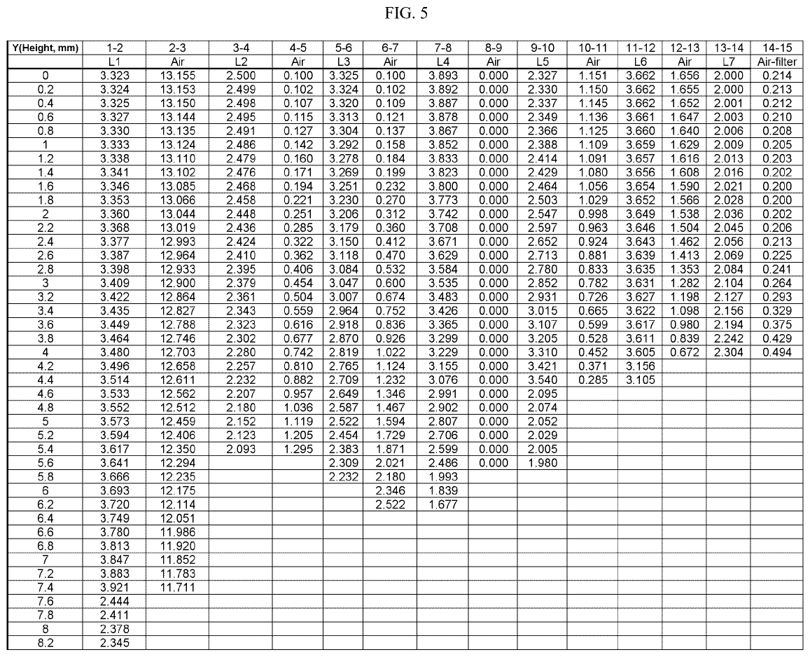

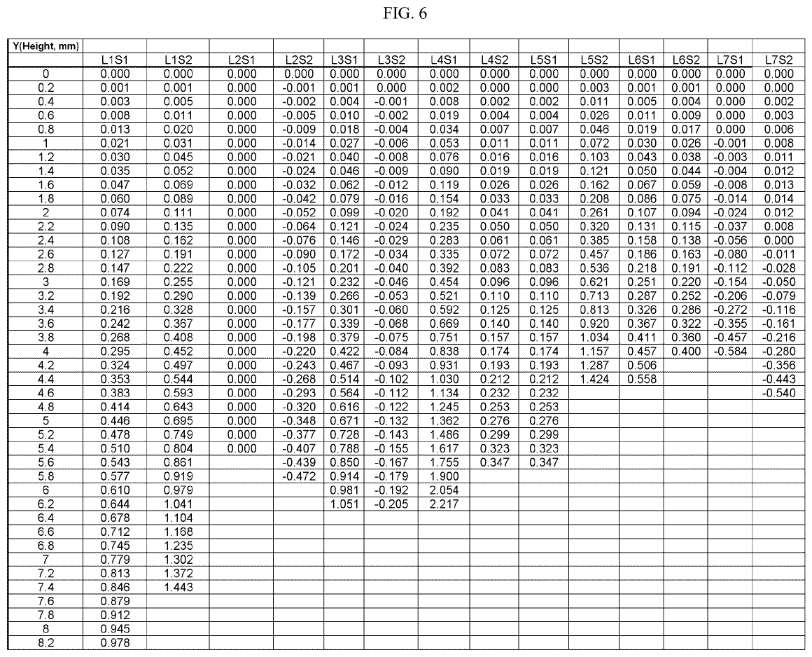

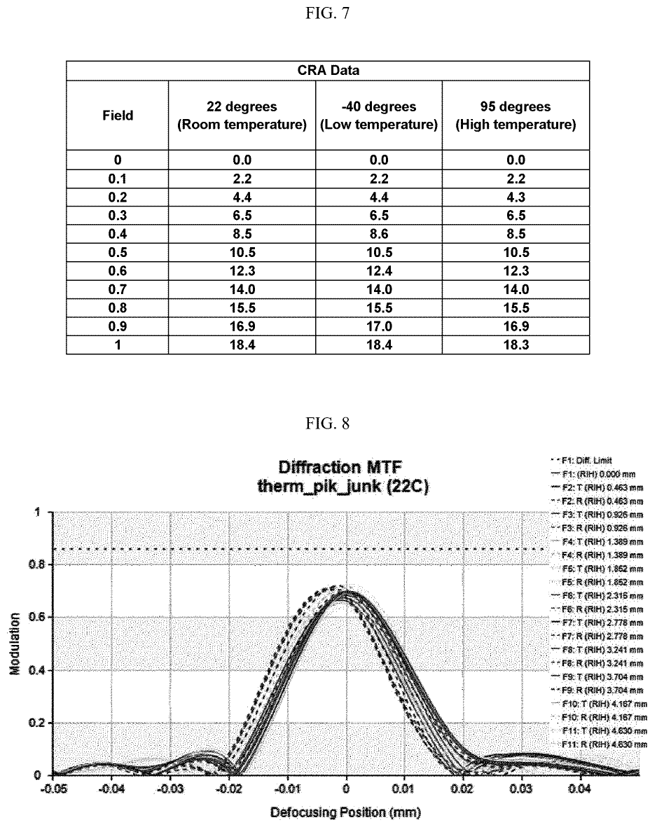

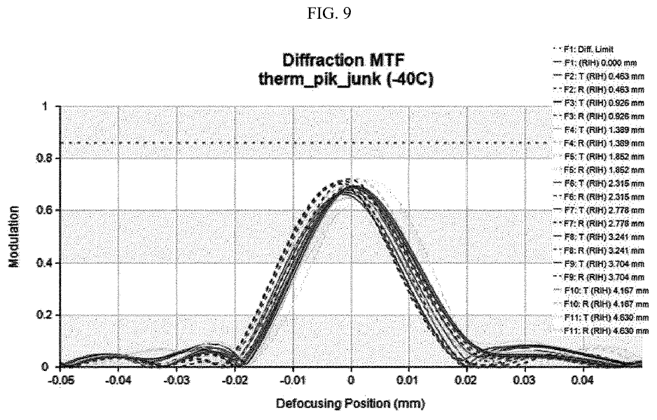

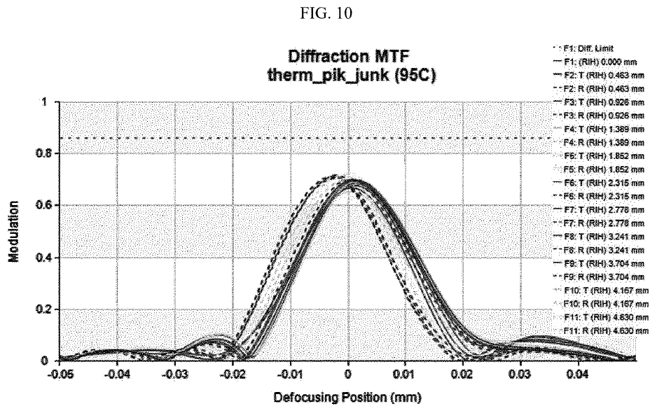

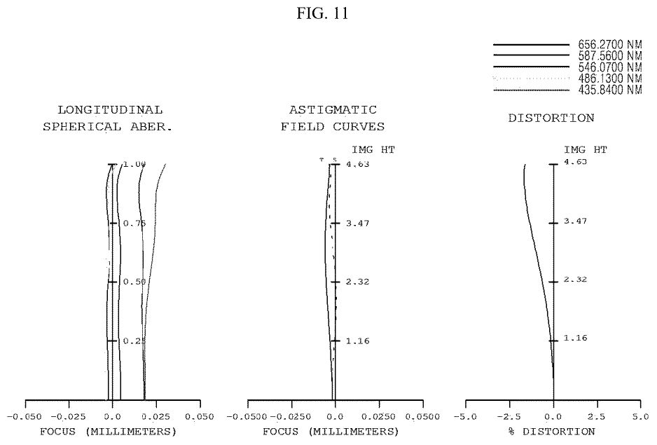

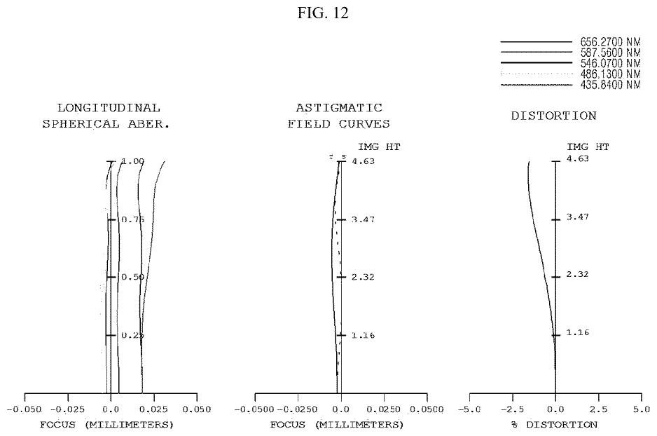

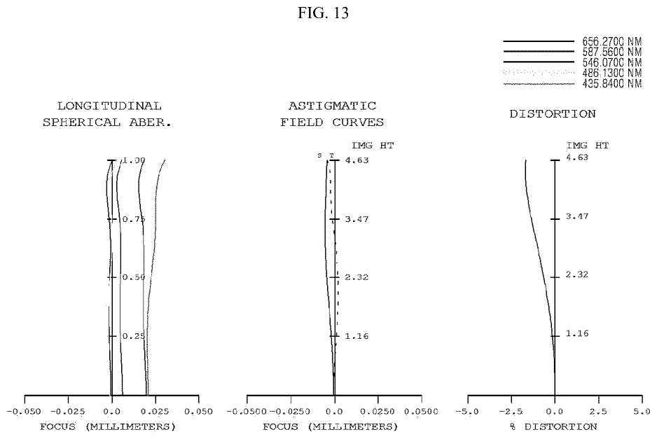

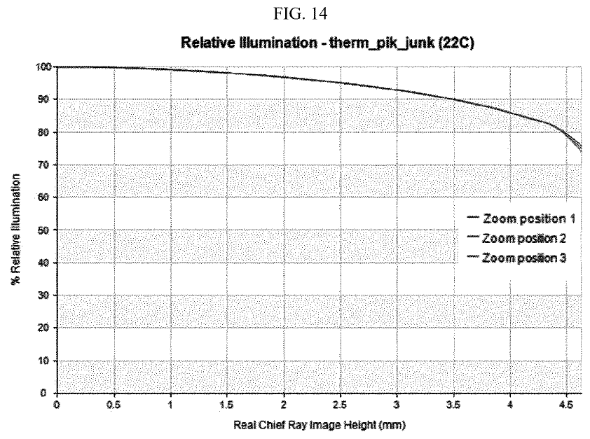

FIG. 1 is a side cross-sectional view of an optical system according to a first embodiment and a camera module having the same; FIG. 2 is a side cross-sectional view for explaining the relationship between the nth and n-1th lenses according to FIG. 1; FIG. 3 is a table showing lens characteristics of the optical system of FIG. 1; FIG. 4 is a table showing aspherical coefficients of lenses in the optical system of FIG. 1; FIG. 5 is a table showing the thickness of each lens and the gap between adjacent lenses in the optical system of FIG. 1; FIG. 6 is a table showing sag values of lens surfaces of the third to sixth lenses in the optical system of FIG. 1; FIG. 7 is a table showing chief ray angle (CRA) data at room temperature, low temperature, and high temperature according to the position of the image sensor in the optical system of FIG. 1; FIG. 8 is a graph showing data on the diffraction modulation transfer function (MTF) of the optical system of FIG. 1 at room temperature; FIG. 9 is a graph showing data on the diffraction MTF of the optical system of FIG. 1 at low temperature; FIG. 10 is a graph showing data on the diffraction MTF of the optical system of FIG. 1 at high temperature; FIG. 11 is a graph showing data on the aberration characteristics of the optical system of FIG. 1 at room temperature; FIG. 12 is a graph showing data on the aberration characteristics of the optical system of FIG. 1 at low temperature; FIG. 13 is a graph showing data on the aberration characteristics of the optical system of FIG. 1 at high temperature; and FIG. 14 is a graph showing the relative illumination according to the height of an image sensor according to a first embodiment.

Referring to FIGS. 1 to 4, the optical system 1000 includes a lens unit 100, and the lens unit 100 includes first to seventh lenses 101 to 107. The first to seventh lenses 101 to 107 may be sequentially disposed along the optical axis OA of the optical system 1000. Light corresponding to information on an object may pass through the first to seventh lenses 101 to 107 and the filter 500 and may be incident on an image sensor 300.

The first lens 101 is the lens closest to the object side in the first lens group LG1. The seventh lens 107 is the lens closest to the image sensor 107 within the second lens group LG2 or the lens unit 100. The first lens 101 may be a first lens group LG1, and the second to seventh lenses 102, 103, 104, 105, 106, and 107 may be a second lens group LG2. An aperture may be disposed on either the circumference of the object side or the sensor side surface of the first lens 101, or the circumference of the object side or the sensor side surface of the second lens 102. For example, the aperture (Stop) may be disposed on the circumference of the object side surface of the second lens 102.

The first lens 101 can be disposed closest to the object side. The first lens 101 can be disposed farthest from the sensor side. The first lens 101 can have negative (−) refractive power in an optical axis OA. The first lens 101 can include a plastic material or a glass material, and can be, for example, may be a glass material. The first lens 101 made of a glass material can reduce changes in the center position, the radius of curvature, and the like due to temperature changes according to the surrounding environment, and can protect the incident side surface of the optical system 1000.

The first surface S1 on the object side of the first lens 101 with respect to the optical axis may be convex, and the second surface S2 on the sensor side may be concave. The first lens 101 may have a meniscus shape that is convex toward the object side. The first lens 101 is made of glass and may have an aspherical surface. The aspherical coefficients of the first and second surfaces S1 and S2 may be provided as S1 of L1 and S2 of L1 in FIG. 4. The first lens 101 may be manufactured as a lens having an aspherical surface by injection molding a glass material. The first lens 101 may be a glass mold lens having an aspherical surface and made of a glass material. The glass mold lens may be manufactured by placing an optical glass ingot inside a mold that will have an aspherical shape and through a heating and compression process.

The effective radius (r11) of the first lens 101 may be larger than the effective radius of the plastic lenses. Unlike this, at least one of the object side surface and the sensor side surface of the first lens 101 may have a free surface, that is, a non-rotationally symmetrical surface.

The effective diameter of the sensor side surface of the second lens 102 can be designed to be smaller than the effective diameter of the object side surface by the shape of the lens surface of the first lens 101. The first surface S1 of the first lens 101 can be provided without a critical point from the optical axis OA to the end of the effective area, that is, the edge. The second surface S2 of the first lens 101 can be provided without a critical point.

The refractive index (n1) of the first lens 101 can satisfy the condition of n1>1.7 or n1>1.72. Since the refractive index (n1) of the first lens 101 is the largest inside the lens unit 100, the radius of curvature of the first and second lenses 101 and 102 can be increased, and lens manufacturing can be easy. If the refractive index (n1) of the first lens 101 is smaller than the condition, the lens surface must be formed sharply concave or convex in order to increase the refractive power of the first and second lenses 101 and 102. In this case, lens manufacturing is not easy, the lens defect rate increases, and this can cause a decrease in yield.

The second lens 102 may be disposed secondly on the object side. The second lens 102 may be disposed sixthly on the sensor side. The second lens 102 may be disposed between the first lens 101 and the third lens 103. The second lens 102 may have a negative (−) refractive power in an optical axis OA. The second lens 102 may include a plastic or glass material. For example, the second lens 102 may be formed of a glass material.

With respect to the optical axis OA, the object side third surface S3 of the second lens 102 may be a flat surface, and the sensor side fourth surface S4 may be convex. The object side third surface S3 of the second lens 102 may have a smoothly curved surface. Although it is difficult to form a curved surface when manufacturing a lens made of a glass material, since the object side third surface S3 of the second lens 102 is formed in a flat plate, manufacturing may be easy. The second lens 102 is made of a glass material, and may be a spherical surface. At least one or all among the third surface S3 and the fourth surface S4 may be spherical. At least one or all of the third surface S3 and the fourth surface S4 may be provided from the optical axis OA to the end of the effective area without a critical point.

The aperture (Stop) may be disposed along the circumference of the object side third surface S3 of the second lens 102. The combined focal length of the second to seventh lenses 102 to 107 disposed on the sensor side of the aperture may have a positive (+) value, and the TTL may be reduced within the range of the angle of view, enabling miniaturization of the optical system. Accordingly, a decrease in the yield by weight of the optical system may be prevented, and production efficiency may be enhanced. In addition, the optical system may be miniaturized by reducing the TTL at a horizontal angle of view (FOV_H) of 25 degrees to 36 degrees.

The third lens 103 may be disposed third from the object side. The third lens 103 may be disposed fifth from the sensor side. The third lens 103 may be disposed between the second lens 102 and the fourth lens 104. The third lens 103 may have positive (+) refractive power in an optical axis OA. The third lens 103 may include a plastic or glass material. For example, the third lens 103 may be provided as a glass material.

The object side fifth surface S5 of the third lens 103 with respect to the optical axis may be convex, and the sensor side sixth surface S6 may be convex. The third lens 103 may have a shape in which both sides are convex with respect to the optical axis OA. Since both sides of the third lens 103 are provided to be convex, the TTL and the number of lenses of the optical system can be minimized, and light can be effectively refracted. The third lens 103 may be made of glass and may be spherical. At least one or both of the fifth surface S5 and the sixth surface S6 may be spherical. At least one or both of the fifth surface S5 and the sixth surface S6 may be provided without a critical point from the optical axis OA to the end of the effective area.

The fourth lens 104 may be disposed fourth from the object side. The fourth lens 104 may be disposed fourth from the sensor side. The fourth lens 104 may be disposed between the third lens 103 and the fifth lens 105. The fourth lens 104 may have positive (+) or negative (−) refractive power in the optical axis OA. The fourth lens 104 may have positive (+) refractive power. The fourth lens 104 may have positive (+) refractive power different from the refractive power of the fifth lens 105. The fourth lens 104 may include a plastic or glass material. For example, the fourth lens 104 may be provided with a plastic material. The fourth lens 104 may be provided with the same material as the fifth lens 105.

The object side seventh surface S7 of the fourth lens 104 with respect to the optical axis may be convex, and the sensor side eighth surface S8 may be concave. The fourth lens 104 may have a meniscus shape that is convex toward the object side. The fourth lens 104 is made of a plastic material and may have an aspherical surface. At least one or both of the seventh surface S7 and the eighth surface S8 may be spherical. For example, the object side seventh surface S7 may be aspherical, and the sensor side eighth surface S8 may be spherical. The aspherical coefficient of the seventh surface S7 may be provided as S1 of L4 of FIG. 4. The seventh surface S7 and the eighth surface S8 may be provided without a critical point from the optical axis OA to the end of the effective area.

The fifth lens 105 may be disposed fifth from the object side. The fifth lens 105 may be disposed third from the sensor side. The fifth lens 105 may be disposed between the fourth lens 104 and the sixth lens 106. The fifth lens 105 may have positive (+) or negative (−) refractive power in the optical axis OA. The fifth lens 105 may have negative (−) refractive power. The fifth lens 105 may have negative (−) refractive power that is different from the refractive power of the fourth lens 104. The fifth lens 105 may include a plastic or glass material. For example, the fifth lens 105 may be provided with a plastic material. The fifth lens 105 may be provided with the same material as the fourth lens 104.

The fifth lens 105 may have a convex ninth surface S9 on the object side and a concave tenth surface S10 on the sensor side with respect to the optical axis OA. The fifth lens 105 may have a meniscus shape in which the object side is convex with respect to the optical axis OA. The fifth lens 105 may be made of a plastic material and may have an aspherical surface. At least one surface of the ninth surface S9 and the tenth surface S10 may be an aspherical surface. For example, the object side ninth surface S9 of the fifth lens 105 may be a spherical surface, and the sensor side tenth surface S10 of the fifth lens 105 may be an aspherical surface. The aspherical coefficient of the tenth surface S10 may be provided as S2 of L5 in FIG. 4. At least one or both of the ninth and tenth surfaces S9 and S10 of the fifth lens 105 can be provided without a critical point from the optical axis OA to the end of the effective area.

The fourth lens 104 and the fifth lens 105 can be bonded. The bonding surface between the fourth lens 104 and the fifth lens 105 can be defined as the eighth surface S8. The eighth surface S8 can be the same surface as the ninth surface of the fifth lens 105. The object side surface of the cemented lens 145 can be convex, and the sensor side surface can be concave. The gap between the fourth and fifth lenses 104 and 105 can be less than 0.01 mm, and can be bonded with an adhesive. The gap between the fourth and fifth lenses 104 and 105 can be less than 0.01 mm from the optical axis OA to the end of the effective area. The fourth and fifth lenses 104 and 105 can have opposite refractive powers. The bonding surface S8 of the cemented lens 145 may be spherical, and the non-bonded surface S7 and S10 of the cemented lens 145 may be aspherical.

The value of the radius of curvature of the bonding surface S8 of the cemented lens 145 may be greater than 30. For example, the value of the radius of curvature of the bonding surface S8 of the cemented lens 145 may be greater than 50. The bonding surface S8 of the cemented lens 145 may be formed in a gentle shape. Through this, the bonding process of the fourth lens 104 and the fifth lens 105 forming the cemented lens 145 is advantageous, and the bonding maintenance strength can be increased.

The product of the refractive power of the object side fourth lens 104 of the cemented lens 145 and the refractive power of the sensor side fifth lens 105 may be less than 0. The product of the focal length of the object side fourth lens 104 of the cemented lens 145 and the focal length of the sensor side fifth lens 105 may be less than 0. Accordingly, the aberration characteristics of the optical system can be improved. When the refractive powers of the two lenses of the cemented lens 145 are the same, there is a limit to the improvement of aberration.

With respect to the cemented lens 145, the third lens 103 on the object side and the sixth lens 106 on the sensor side can have positive refractive power. Accordingly, the third lens 103, the cemented lens 145, and the sixth lens 106 can refract some of the incident light in the direction of the optical axis and mutually correct chromatic aberration. The focal length of the third lens 103 being disposed on the object side with respect to the cemented lens 145 can be smaller than the focal length of the sixth lens 106 being disposed on the sensor side. The power of the third lens 103 being disposed on the object side with respect to the cemented lens 145 can be greater than the power of the sixth lens 106 being disposed on the sensor side.

The effective diameter of the fourth lens 104 may be larger than the diagonal length of the image sensor 300. The effective diameter of the fourth lens 104 is an average of the effective diameters of the seventh surface S7 and the eighth surface S8, and may be larger than the diagonal length of the image sensor 300. The effective diameter of the fifth lens 105 may be smaller than the effective diameter of the fourth lens 104 and larger than the diagonal length of the image sensor 300.

When the effective diameter of the seventh surface S7 of the fourth lens 104 is CA_L4S1 and the effective diameter of the eighth surface S8 is CA_L4S2, the effective diameters of the seventh and eighth surfaces S7 and S8 can satisfy the condition of 1<CA_L4S1/CA_L4S2<1.5. When the effective diameter of the ninth surface S9 of the fifth lens 105 is CA_L5S1 and the effective diameter of the tenth surface S10 is CA_L5S2, the effective diameters of the ninth and tenth surfaces can satisfy the condition of 1<CA_L5S1/CA_L5S2<1.5.

The cemented lens 145 is bonded with plastic lenses having different refractive indices and has an aspherical refractive surface. When the lenses positioned on the sensor side of the cemented lens 145 are spherical lenses or glass lenses, aspherical aberration can be compensated. Since the position of the cemented lens 145 is located in any two consecutive lenses among the third to sixth lenses that are in the middle or behind the middle within the lens unit 100, chromatic aberration correction can be more efficient.

The sixth lens 106 may be disposed sixth from the object side. The sixth lens 106 may be disposed second from the sensor side. The sixth lens 106 may be disposed between the fifth lens 106 and the seventh lens 107. The sixth lens 106 may have positive (+) or negative (−) refractive power in the optical axis OA. The sixth lens 106 may have positive (+) refractive power. The sixth lens 106 may include a plastic or glass material. For example, the sixth lens 106 may be provided as a glass material.

The sixth lens 106 may have a convex eleventh surface S11 on the object side and a concave twelfth surface S12 on the sensor side with respect to the optical axis OA. The sixth lens 106 may have a meniscus shape that is convex from the optical axis OA toward the object side. At least one or both of the eleventh surface S11 and the twelfth surface S12 may be spherical. For example, both the eleventh surface S11 and the twelfth surface S12 may be spherical.

The eleventh surface S11 of the sixth lens 106 can be provided without a critical point from the optical axis OA to the end of the effective area. The twelfth surface S12 can be provided without at least one critical point from the optical axis OA to the end of the effective area.

The seventh lens 107 may be disposed closest to the sensor side. The seventh lens 107 may be disposed farthest from the object side. The seventh lens 107 may have positive (+) or negative (−) refractive power on the optical axis OA. The seventh lens 107 may have negative (−) refractive power. The seventh lens 107 may include a plastic or glass material. For example, the seventh lens 107 may be made of a plastic material.

The object side 13th surface S13 of the seventh lens 107 on the optical axis may be convex, and the sensor side 14th surface S14 may be concave. The seventh lens 107 may have a meniscus shape that is convex toward the object side. At least one surface among the 13th surface S13 and the 14th surface S14 may be aspherical. For example, both the 13th surface S13 and the 14th surface S14 may be aspherical. The aspherical coefficients of the 13th and 14th surfaces S13 and S14 may be provided as S1 and S2 of L7 in FIG. 4.

The thirteenth surface S13 of the seventh lens 107 may have a critical point from the optical axis OA to the end of the effective area. When the thirteenth surface S13 has a critical point, it may be located at 50% or more of the effective radius (r71) from the optical axis OA, or in a range of 52% to 70%, or in a range of 53% to 60%. When the fourteenth surface S14 has a critical point, it may be located at 70% or more of the effective radius (r72) from the optical axis OA, or in a range of 70% to 90%, or in a range of 75% to 85%.

The seventh lens 107 may be a plastic lens that is closest to the image sensor 300. In addition, by arranging one or more plastic lenses adjacent to the image sensor 300, aberrations such as spherical aberration and chromatic aberration can be improved by a lens surface having an aspherical surface, and the influence on the resolution can be controlled. In addition, by arranging a plastic lens as a lens adjacent to the image sensor 300, it can be insensitive to assembly tolerances compared to a glass lens. That is, being insensitive to assembly tolerances means that even when the assembly is performed with a slight difference compared to the design during assembly, the optical performance may not be significantly affected. In addition, by providing one lens 107 adjacent to the image sensor 300 as a plastic material, the optical performance can be improved by a lens surface having an aspherical surface, and for example, aberration characteristics can be improved and resolution deterioration can be prevented.

At least one or both of the 13th surface S13 and the 14th surface S14 of the seventh lens 107 may have a critical point. The 13th surface S13 of the seventh lens 107 may have a first critical point P1 from the optical axis OA to an end of the effective area. The first critical point P1 of the 13th surface S13 may be located at 55% or more of the effective radius from the optical axis OA, or in a range of 55% to 75% or in a range of 60% to 70%. The first critical point of the 13th surface S13 may be located at a distance of 2 mm or more from the optical axis OA, for example, in a range of 2.1 mm to 2.5 mm or in a range of 2.2 mm to 2.3 mm. As another example, the 13th surface S13 may be provided without a critical point. The 13th surface S13 having the first critical point P1 can refract incident light to the center portion and the edge portion, and improve aberration. The first and second critical points P1 and P2 are points where the sign of the gradient value with respect to the optical axis OA and the direction perpendicular to the optical axis OA changes from positive (+) to negative (−) or from negative (−) to positive (+), and may mean a point where the gradient value is 0. In addition, the first and second critical points P1 and P2 may be points where the gradient value of the tangent passing through the lens surface increases and then decreases, or points where it decreases and then increases.

The fourteenth surface S14 of the seventh lens 107 can have at least one second critical point P2 from the optical axis OA to the end of the effective area. The second critical point P2 of the fourteenth surface S14 can be located at a distance of 60% or more of the effective radius (r72) from the optical axis OA, or in a range of 60% to 80% or in a range of 65% to 75%. The second critical point P2 of the fourteenth surface S14 can be located at a distance of 2.9 mm or more from the optical axis OA, for example, in a range of 2.9 mm to 3.9 mm or in a range of 3.1 mm to 3.7 mm. Accordingly, the second critical point P2 is disposed closer to the edge than the first critical point P1, so that the seventh lens 107 can refract incident light to the edge portion of the image sensor 300.

The average effective radius of the 13th and 14th surfaces S13 and S14 of the 7th lens 107 is disposed to be smaller than ImgH, which is half the diagonal length of the image sensor 300, and this can refract light to the edge portion of the image sensor 300 by the 14th surface S14 having the second critical point P2.

As shown in FIG. 2 and FIG. 6, sag41 represents the height from the center of the seventh surface S7 of the fourth lens 104 to the lens surface in the direction (X, Y) orthogonal to the optical axis OA, and the maximum value of sag41 may be the height at the edge of the seventh surface S5.

Sag42 represents the height from the center of the eighth surface S8 of the fourth lens 104 to the lens surface in the direction (X, Y) orthogonal to the optical axis OA, and the maximum value of sag42 may be the height at the edge of the eighth surface S8. Sag52 represents the height from the center of the ninth surface S9 of the fifth lens 105 to the lens surface in the direction (X, Y) orthogonal to the optical axis OA, and the maximum value of sag52 may be the height at the edge of the ninth surface S9.

Sag61 represents the height from the center of the eleventh surface S11 of the sixth lens 106 to the lens surface in the direction (X, Y) orthogonal to the optical axis OA, and the maximum value of sag61 may be the height at the edge of the eleventh surface S11. sag62 is the height from the center of the twelfth surface S12 of the sixth lens 106 to the lens surface in the direction (X, Y) orthogonal to the optical axis OA, and the maximum sag value is the height at the edge.

The maximum sag values can satisfy the following.

The condition of Max_sag51<Max_sag52<Max_sag41 can be satisfied.

The difference between Max_sag52 and Max_sag61 can be less than 1. By setting the sag value between these adjacent glass and plastic lenses, the light loss between the glass and plastic lenses can be reduced.

In FIG. 6, when the sag value is a positive value, the lens surface is located on the sensor side with respect to a straight line orthogonal to the optical axis OA, and when the sag value is a negative value, the lens surface is located on the object side with respect to a straight line orthogonal to the optical axis OA. In addition, when comparing the object side and sensor side surfaces of each lens, the object side and sensor side surfaces of the seventh lens 107 may be surfaces having the smallest difference between the maximum and minimum sag values. This is because the distance between the object side and sensor side surfaces of the seventh lens 107 is constant, and the average of the curvature radii may be larger than the average of the curvature radii of the other lenses.

As shown in FIGS. 1 and 2, the center thicknesses of the first to seventh lenses 101 to 107 are represented by CT1 to CT7, the edge thicknesses at the ends of the effective areas of each lens are represented by ET1 to ET7, the center gap between two adjacent lenses is represented by CG1 to CG6, and the edge gap between the edges of each lens are represented by EG1 to EG6. Here, the center thickness of the cemented lens 145 is CT34, and the edge thickness is represented by ET45.

Referring to FIG. 2, back focal length (BFL) is the optical axis distance from the image sensor 300 to the center of the last lens. In FIG. 1, TTL is the optical axis distance from the center of the first surface S1 of the first lens 101 to the upper surface of the image sensor 300.

FIG. 3 is an example of lens data of the optical system of the embodiment of FIG. 1. As shown in FIG. 3, the radius of curvature of the optical axis OA of the first to seventh lenses 101, 102, 103, 104, 105, 106, and 107, the thickness of the lenses, the center distance between the lenses, the refractive index at the d-line, the Abbe's Number, and the size of the clear aperture CA can be set.

As shown in FIG. 4, among the lenses of the lens unit 100 in the embodiment, the lens surfaces of the first, second, sixth, and seventh lenses 101, 102, 106, and 107 may include aspherical surfaces having a 30th aspherical coefficient. For example, the first, second, sixth, and seventh lenses 101, 102, 106, and 107 may include lens surfaces having a 30th aspherical coefficient. As described above, since the aspherical surface having a 30th aspherical coefficient (a value other than “0”) can significantly change the aspherical shape of the edge portion, the optical performance of the edge portion of the field of view (FOV) can be well corrected.

As shown in FIG. 5, the thickness T1 to T7 of the first to seventh lenses 101, 102, 103, 104, 105, 106, and 107 and the gap G1 to G6 between adjacent two lenses can be set. As shown in FIG. 5, the thickness T1 to T7 of each lens in a Y-axis direction can be expressed for every gap of 0.1 mm or 0.2 mm or more, and the gap G1 to G6 between each lens can be expressed for every gap of 0.1 mm or 0.2 mm or more.

Referring to FIGS. 3 and 5, the object side third surface S3 of the second lens 102 may be flat and have an infinite curvature radius. When comparing the absolute values of the curvature radii of each lens, among the lens surfaces having curvature, the curvature radius of the object side 13th surface S13 of the seventh lens 107 in the optical axis OA may be the maximum, and the curvature radius of the sensor side 10th surface S10 of the fifth lens 105 may be the minimum among the lenses. The difference between the maximum curvature radius and the minimum curvature radius among the lens surfaces having curvature may be 50 times or more, for example, 52 to 58 times.

When explaining the center thickness of the lenses based on the optical axis, the center thickness (CT4) of the fourth lens 104 is the largest among the lenses, and the center thickness (CT7) of the seventh lens 107 is the smallest among the lenses. The difference between the maximum center thickness and the minimum center thickness among the lenses may be in the range of 1.5 mm or more and 2.5 mm or less.

When explaining the center gap (CG) between the lenses, the center gap (CG1) between the first lens 101 and the second lens 102 may be maximum, and the center gap between the second and third lenses 102 and 103 may be minimum. Here, the minimum center gap excludes the bonding surface of the cemented lens 145. The difference between the maximum center gap and the minimum center gap among the lenses being spaced may be 10 mm or more, for example, in the range of 10 mm to 15 mm.

When explaining about the effective diameter, the lens having the maximum effective diameter may be disposed between the first lens 101 closest to the object and the seventh lens 107 closest to the image sensor 300. The lens having the maximum effective diameter may be a glass lens. The lens having the maximum effective diameter may be disposed closest to the object side. The lens having the maximum effective diameter may be the first lens 101. Here, the effective diameter is an average of the effective diameters of the object side surface and the sensor side surface of each lens. The lens surface having the maximum effective diameter may be the object side first surface S1 of the first lens 101.

The lens having the minimum effective diameter may be any one of the plastic lenses, and may be disposed, for example, closest to the image sensor 300. The lens having the minimum effective diameter may be the seventh lens 107. The lens surface having the minimum effective diameter may be the thirteenth surface S13 of the seventh lens 107.

The effective diameters of each of the first to fourth lenses 101 to 104 adjacent to the object side may be larger than the effective diameters of the fifth, sixth, and seventh lenses 105, 106, and 107 adjacent to the sensor side. The effective diameters of the first to fourth lenses 101 to 104 may be larger than the diagonal length of the image sensor 300. The average effective diameters of the sixth lens 106 and the seventh lens 107 may be smaller than the diagonal length of the image sensor 300. Accordingly, light incident through a plurality of lenses aligned along the optical axis may be guided to the image sensor 300.

When explaining the refractive index, the refractive index of the first lens 101 is the largest among the lenses and may be greater than 1.7, for example, greater than 1.72. The refractive index of the fourth lens 104 is the smallest among the lenses and may be less than 1.6, for example, less than 1.55. The difference between the maximum refractive index and the minimum refractive index may be 0.2 or more. By providing a high refractive index lens made of glass closest to an object, and providing one of the lenses adjacent to the glass lens and the cemented lens as a low refractive index lens made of plastic, the incidence efficiency can be increased, and the refractive power between the glass lens and the plastic lens can be adjusted to guide it to the image sensor 300.

When comparing the Abbe numbers, the Abbe numbers of the second lens 102 and the third lens 103 are the largest among the lenses and can be 60 or more. The Abbe numbers of the fifth lens 105 and the seventh lens 107 are the smallest among the lenses and can be 25 or less. The difference between the maximum refractive index and the minimum Abbe number can be 40 or more. By making the Abbe numbers of the second lens 102 and the third lens 103 adjacent to the cemented lens 145 the largest and providing the Abbe numbers of the fifth lens 105 and the seventh lens 107 adjacent to the image sensor 300 the smallest, the color dispersion of light traveling between the glass lenses can be controlled and the color dispersion between the glass and plastic lenses can be increased to guide it to the image sensor 300.

The focal lengths (F1, F5, F7) of the first, fifth, and seventh lenses 101, 105, and 107 may have negative (−) signs. The first, fifth, and seventh lenses 101, 105, and 107 may have negative (−) refractive power. The focal lengths (F2, F3, F4, and F6) of the second, third, fourth, and sixth lenses 102, 103, 104, and 106 may have positive (+) signs. The second, third, fourth, and sixth lenses 102, 103, 104, and 106 may have positive (+) refractive power. The second, third, and fourth lenses 102, 103, and 104 having positive (+) refractive power may be disposed on the sensor side of the first lens 101 having negative (−) refractive power. Through this, light incident on the object side can move away from the optical axis direction and then gather again in the optical axis direction, thereby forming a stable optical path.

In addition, the first lens 101 and the second lens 102, which are adjacently disposed lenses, can satisfy the following conditions.

Condition 1: The refractive index of the lens with positive refractive power<the refractive index of the lens with negative refractive power

Condition 2: Dispersion value of a lens with positive refractive power>Dispersion value of a lens with negative refractive power

Here, among the glass lenses, the second lens 102 has positive refractive power and the first lens 101 has negative refractive power, so that according to Conditions 1 and 2, the refractive index of the second lens is smaller than the refractive index of the first lens, and the dispersion value of the second lens is larger than the dispersion value of the first lens. Chromatic aberration occurring in the glass lens can be corrected by the glass lens. In addition, since the first lens 101 and the second lens 102, which are glass lenses disposed in series, satisfy the refractive index difference of 0.1 or more and 0.16 or less and the Abbe number difference of 20 or more and 60 or less, the chromatic aberration occurring in the glass lens can be compensated for by the glass lens.

The optical system has chromatic aberration, and chromatic aberration is corrected by using cemented lenses or two lenses disposed in series. As the temperature changes from low to high, the lens repeatedly contracts and expands. Since the lens characteristics of lenses of the same material change the same amount according to the temperature change, it is effective to correct chromatic aberration between lenses of the same material even when the temperature changes.

Therefore, in a first embodiment of the present invention, chromatic aberration occurring in a glass lens is corrected using the first lens 101 and the second lens 102, and chromatic aberration occurring in a plastic lens is corrected using the fourth lens 104 and the fifth lens 105.

The chromatic aberration occurring in the plastic lens can be compensated for by the plastic lens when the fourth lens 104 and the fifth lens 105, which are the cemented lenses, satisfy the refractive index difference of 0.1 or more and 0.15 or less and the Abbe number difference of 20 or more and 60 or less. The refractive index difference is rounded to the third decimal place, and the Abbe number difference is rounded to the first decimal place to compare the values.

In addition, by arranging glass lenses with relatively high Abbe numbers on the object side of the plastic lenses, color dispersion can be reduced by the glass lenses and color dispersion can be increased by the plastic lenses.

When comparing the focal lengths in absolute values, the focal length of the sixth lens 106 is the largest among the lenses, and may be 80 or more or 100 or more. The sixth lens 106 may have the largest focal length and the smallest refractive power. The focal length of the fifth lens 105 is the smallest among the lenses, and may be 20 or less or 15 or less. Among the lenses excluding the cemented lens 145, the lens having the minimum focal length may be the third lens 103. The third lens 103 may be 30 or less or 25 or less. The difference between the maximum focal length and the minimum focal length may be 50 or more or 80 or more. Accordingly, the optical system may have improved MTF characteristics, aberration control characteristics, resolution characteristics, and the like in a range of set angle of view, and may have good optical performance in the edge portion of the angle of view.

There is a critical point on the sensor side of the seventh lens 107. The critical point is the point where the trend of the sag value changes. That is, the point where the sag value increases and then decreases, or the point where the sag value decreases and then increases. Referring to FIG. 6, it can be seen that the critical point exists on the sensor side of the seventh lens 107 between a point 1.8 mm apart and a point 2.0 mm apart in the direction perpendicular to the optical axis. On the sensor side of the seventh lens 107, the sag value increases to a point 1.9 mm apart in the direction perpendicular to the optical axis, and then decreases from a point 1.9 mm apart to a point 4.6 mm apart in the direction perpendicular to the optical axis. When a critical point exists on the sensor side of the 7th lens 107, that is, on the sensor side of the last lens, that is, on the lens surface closest to the sensor, TTL can be reduced, making it easy to miniaturize and lighten the optical system.

The thickness (T1) of the first lens 101 may be a difference of 1 or more times the maximum thickness and the minimum thickness, for example, 1 to 1.2 times, and the center thickness (CT1) may be a minimum and the edge thickness (ET1) may be a maximum. The thickness (T2) of the second lens 102 may be a maximum thickness in a range of 1 to 1.3 times the minimum thickness. The second lens 102 may be a maximum center thickness (CT2) and a minimum edge thickness (ET2). The thickness (T3) of the third lens 103 may be a maximum at the center and a minimum at the edge, and the maximum thickness is in a range of 1.5 to 2 times the minimum thickness. The thickness (T4) of the fourth lens 104 may be a maximum at the center and a minimum at the edge, and the maximum thickness is in a range of 1.8 to 2.2 times the minimum thickness. The thickness (T5) of the fifth lens 105 may be minimum at the center and maximum at the edge and the maximum thickness is in a range of 1.2 to 1.7 times the minimum thickness. The thickness (T6) of the sixth lens 106 may be maximum at the center and minimum at the edge and the maximum thickness is in a range of 1.0 to 1.3 times the minimum thickness. The thickness (T7) of the seventh lens 107 may be minimum at the center and maximum at the edge and the maximum thickness is in a range of 1 to 1.2 times the minimum thickness.

The center thickness (CT45) of the cemented lens 145 may be greater than the edge thickness (ET45). The center thickness (CT45) of the cemented lens 145 is the distance from the center of the object side seventh surface S7 of the fourth lens 104 to the center of the tenth surface S10 of the fifth lens 105, and the edge thickness (ET45) is the distance from the end of the effective area of the seventh surface S7 to the tenth surface S10 in the optical axis direction. The maximum thickness of the cemented lens 145 is at the center portion, the minimum thickness is at the edge portion, and the maximum thickness may be in a range of 1 to 1.2 times the minimum thickness.

Among the gaps (G1-G6) between the lenses, the first gap (G1) between the first and second lenses 101 and 102 may have a maximum in the center portion and a minimum in the edge portion. The second gap (G2) between the second and third lenses 102 and 103 may have a maximum in the edge portion and a minimum in the center portion. The third gap (G3) between the third and fourth lenses 103 and 104 may have a maximum in the edge and a minimum in the center portion. The fifth gap (G5) between the fifth and sixth lenses 105 and 106 may have a maximum in the center portion and a minimum in the edge portion. The sixth gap (G6) between the sixth and seventh lenses 106 and 107 may have a maximum in the center portion and a minimum in the edge portion.

As shown in FIG. 7, in the optical system and camera module of FIG. 1, the chief ray angle (CRA) may be 10 degrees or more, for example, in a range of 10 to 35 degrees or 10 to 25 degrees, at 1-field, which is the end of the diagonal length of the image sensor. In addition, the difference in the chief ray angle from a low temperature (−40 degrees) to a high temperature (95 degrees) may be 1 degree or less. Accordingly, even if the temperature changes from a low temperature to a high temperature, the difference in the angle of the chief ray is not large and stable optical performance can be achieved.

As shown in FIG. 14, a graph showing the relative illumination according to the image height in the optical system according to a first embodiment shows that the relative illumination is 70% or more, for example, 75% or more from the center of the image sensor to the diagonal end. That is, it can be seen that there is almost no difference in the relative illumination (zoom positions 1, 2, and 3) according to room temperature, low temperature, and high temperature up to 4.5 mm from the optical axis.

FIGS. 8 to 10 are graphs showing diffraction modulation transfer function (MTF) at room temperature, low temperature, and high temperature in the optical system of FIG. 1, and are graphs showing modulation according to spatial frequency. As shown in FIGS. 8 to 10, in a first embodiment of the present invention, the deviation of MTF at low temperature or high temperature with respect to room temperature may be less than 10%, that is, 7% or less.

FIGS. 11 to 12 are graphs showing aberration characteristics at room temperature, low temperature, and high temperature in the optical system of FIG. 1. FIGS. 11 to 13 are graphs measuring spherical aberration (longitudinal spherical aberration), astigmatic field curves, and distortion from left to right in the aberration graphs. In FIGS. 11 to 13, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graphs for astigmatism and distortion are graphs for light in wavelength bands of about 546 nm. In the aberration diagrams of FIGS. 11 to 13, it can be interpreted that the closer each curve at room temperature, low temperature, and high temperature is to the Y-axis, the better the aberration correction function is. It can be seen that the optical system 1000 according to a first embodiment has measurement values close to the Y-axis in almost all areas. That is, the optical system 1000 according to the first embodiment has improved resolution and can have good optical performance not only in the center portion of the field of view (FOV) but also in the edge portion. Here, the low temperature is −20 degrees or lower, for example, in the range of −20 to −40 degrees, the room temperature is in the range of 22 degrees±5 degrees or in the range of 18 degrees to 27 degrees, and the high temperature can be in the range of 85 degrees or higher, for example, in the range of 85 degrees to 105 degrees. Accordingly, it can be seen that the decrease in the luminance ratio (modulation) from the low temperature to the high temperature of FIGS. 11 to 13 is less than 10%, for example, 5% or lower, or is hardly changed.

Table 1 compares changes in optical characteristics such as EFL, BFL, F number (F #), TTL, and field of view (FOV) at room temperature, low temperature, and high temperature in an optical system according to a first embodiment of the present invention, and it can be seen that the change rate of optical characteristics at low temperature is 5% or less, for example, 3% or less, with respect to room temperature, and it can be seen that the change rate of optical characteristics at low temperature is 5% or less, for example, 3% or less, with respect to room temperature.

TABLE 1

| | | | | Low | High |
|---|---|---|---|---|---|
| | Room | Low | High | temperature/ | temperature/ |
| | temper- | temper- | temper- | Room | Room |
| | ature | ature | ature | temperature | temperature |
| EFL(F) | 15.2996 | 15.2793 | 15.3256 | 99.86% | 100.16% |
| BFL | 2.5000 | 2.4971 | 2.5035 | 99.88% | 100.14% |
| F# | 1.6000 | 1.5975 | 1.6031 | 99.84% | 100.19% |
| TTL | 39.9073 | 39.8426 | 39.9834 | 99.83% | 100.19% |
| FOV | 34.1913 | 34.2176 | 34.1588 | 100.07% | 99.90% |

Therefore, as shown in Table 1, it can be seen that the change in optical characteristics according to the temperature change from low temperature to high temperature, for example, the change rate of effective focal length (EFL), TTL, BFL, F number, and field of view (FOV), is 10% or less, that is, 5% or less, for example, in the range of 0 to 5%. This makes it possible to design temperature compensation for plastic lenses even when using at least one or two or more plastic lenses, thereby preventing a decrease in the reliability of optical characteristics.

The optical system of the first embodiment disclosed above can effectively control aberration characteristics such as chromatic aberration and distortion aberration, and can have good optical performance not only in the center portion of the field of view (FOV) but also in the edge portion.

Table 2 shows the items of the mathematical formulas described above in the optical system 1000 of the first embodiment, including the total track length (TTL) (mm), back focal length (BFL), effective focal length (F) (mm), ImgH (mm), effective diameter (CA) (mm), thickness (mm), TTL (mm), TD (mm) which is the optical axis distance from the first surface S1 to the fourteenth surface S14, the focal lengths (F1, F2, F3, F4, F5, F6, and F7) (mm) of each of the first to seventh lenses, sum of refractive indices, sum of Abbe numbers, sum of thicknesses (mm), sum of gaps between adjacent lenses, effective diameter characteristics, sum of refractive indices of glass lenses, sum of refractive indices of plastic materials, angle of view (FOV) (degree), edge thickness (ET), focal lengths of the first and second lens groups, F number, and the like.

TABLE 2

| Category | Value | Category | Value |
|---|---|---|---|
| F | 15.2996 | ET1 | 3.7723 |
| F1 | −78.2177 | ET2 | 2.0006 |
| F2 | 55.9210 | ET3 | 1.9989 |
| F3 | 24.7582 | ET4 | 2.0074 |
| F4 | 21.6827 | ET5 | 3.5371 |
| F5 | −12.9047 | ET6 | 3.4809 |
| F6 | 105.8840 | ET7 | 2.0999 |
| F7 | −83.1631 | F-number | 1.600 |
| F_LG1 | −78.2177 | FOV | 34.1913 |
| F_LG2 | 13.1732 | EPD | 9.5622 |
| ΣIndex | 11.6546 | BFL | 2.7135 |
| ΣAbbe | 323.8362 | TD | 37.1938 |
| ΣCT | 21.031 | ImgH | 4.630 |
| ΣCG | 16.162 | SD | 20.7157 |
| CA_max | 16.510 | TTL | 39.9073 |
| CA_min | 7.594 | GLca_Aver | 11.384 |
| CA_Aver | 11.145 | PLca_Aver | 10.967 |
| CT_max | 3.893 | Image sensor | 3840*2160 |
| CT_min | 2.000 | CT_Aver | 3.231 |

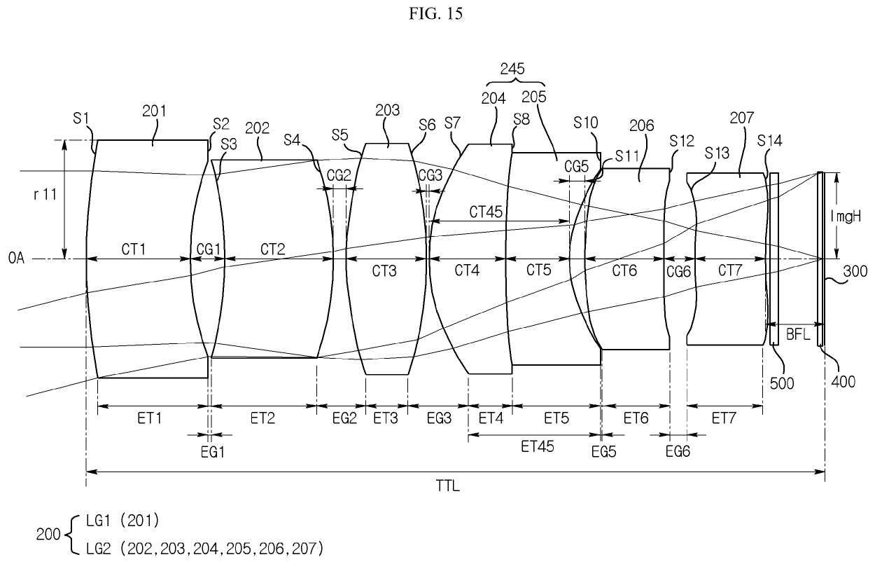

As shown in FIG. 15, the optical system 1500 according to a second embodiment of the present invention may include five or more lenses. The optical system 1500 and the camera module having the same may be mounted inside or outside a vehicle to monitor a driver or sense external objects or lanes. The material of the lenses may be selected from glass or plastic, and the coefficient of linear expansion of glass material is smaller than that of plastic material. Accordingly, glass lenses are employed to suppress changes in the focal imaging position due to temperature changes. However, glass lenses are expensive compared to plastic lenses, and there is a problem that it is difficult to meet the demand for low cost. Therefore, the lenses in the optical system 1500 are required to have a mixed configuration of glass lenses and plastic lenses. By employing such plastic lenses, the optical system 1500 can provide weight reduction and low cost by reducing the thickness of the plastic lenses, and excellent correction for various aberrations such as spherical aberration and chromatic aberration can be achieved by the plastic lenses. In addition, plastic lenses can provide aspherical lenses, which can help minimize distortion in the edge portion.

The optical system 1500 may include n lenses, where the nth lens may be the last lens adjacent to the image sensor 300, and the (n-1)th lens may be the lens closest to the last lens. n is an integer greater than or equal to 5, for example, 5 to 8. The n lenses may have a ratio of glass lenses to plastic lenses in a range of 2:3 to 2:6 or in a range of 3:4 to 3:5.

The optical system 1500 may include a plurality of lens groups LG1 and LG2. In detail, each of the plurality of lens groups LG1 and LG2 includes at least one lens. For example, the optical system 1500 may include a first lens group LG1 and a second lens group LG2 that are sequentially disposed along the optical axis OA from the object side toward the image sensor 300.

The number of lenses of each of the first lens group LG1 and the second lens group LG2 may be different. The number of lenses of the second lens group LG2 may be greater than the number of lenses of the first lens group LG1, for example, more than four times or more than five times the number of lenses of the first lens group LG1. The first lens group LG1 may include at least one lens. The first lens group LG1 may have three or fewer lenses. The first lens group LG1 may preferably include one lens. The second lens group LG2 may include two or more lenses. The second lens group LG2 may include four to seven lenses. The second lens group LG2 may preferably include six lenses.

The first lens group LG1 may include at least one lens made of glass. The first lens group LG1 may provide the lens closest to the object side as a lens made of glass. Such glass material has a small amount of expansion and contraction change due to external temperature change and the surface is not easily scratched, so that surface damage can be prevented.

The lens material of the second lens group LG2 may be a mixture of at least one glass lens and at least one plastic lens. In the second lens group LG2, at least one plastic lens may be disposed on a sensor side relative to the glass lens. The second lens group LG2 may include two or more glass lenses, for example, two to four glass lenses. The second lens group LG2 may include, for example, two to six lenses. As another example, the second lens group LG2 may have one or more plastic lenses. The second lens group LG2 may include two or more plastic lenses, for example, two to four plastic lenses.

At least one lens closest to the object in the optical system 1500 may be made of glass. Three or more lenses, for example, three to five lenses, closest to the object may be made of glass. Since the rate of contraction and expansion of lenses made of glass is smaller than that of lenses made of plastic due to temperature changes, lenses made of glass may be disposed in an area adjacent to the outside within the lens barrel.

At least one lens closest to the image sensor 300 in the optical system 1500 may be made of plastic. For example, at least two lenses closest to the image sensor 300 may be made of plastic, and preferably, at least two lenses adjacent to the image sensor 300 may be made of plastic. That is, since the n-th and (n-1)th lenses in the optical system 1500 are disposed as plastic lenses, various aberrations can be corrected for the incident light of the image sensor 300.

Within the optical system 1500, lenses made of plastic material can be sequentially disposed, and lenses made of glass material can be sequentially disposed. Within the optical system 1500, lenses made of plastic material can be disposed between lenses made of glass material. Within the optical system 1500, lenses made of glass material can be disposed between lenses made of plastic material.

Each of the lenses 201 to 207 can have an object side and a sensor side. The optical system can have a greater number of lenses having an aspherical sensor side surface and an aspherical object side surface than the number of plastic lenses. The optical system can have a smaller number of lenses having a spherical sensor side surface and a spherical object side surface than a double-sided aspherical lens. Since the optical system 1500 has more aspherical lenses than spherical lenses, various aberrations can be corrected.

Among the lenses of the optical system 1500, a lens having a maximum refractive index can be positioned adjacent to the first lens group LG1 or the object. The maximum refractive index can be 1.8 or more. The color dispersion of light incident on the lens having a maximum refractive index can be increased, and the center thickness can be made thinner than the edge thickness. In addition, since the lens having a maximum refractive index is positioned on the object side, it is easy to change the radius of curvature of the second and subsequent lenses, and the center thickness can be increased.

Within the optical system 1500, a lens having the maximum effective diameter may be disposed at the center portion of the object side and the sensor side. The effective diameter of the lens may increase and then decrease as it moves from the object side to the sensor side. The effective diameter of the lens may decrease and then increase and then decrease again as it moves from the object side to the sensor side. Through this, since the light incident on the optical system 1500 is structured to move away from the optical axis and then gather back to the optical axis, the optical system 1500 can form a stable optical path.

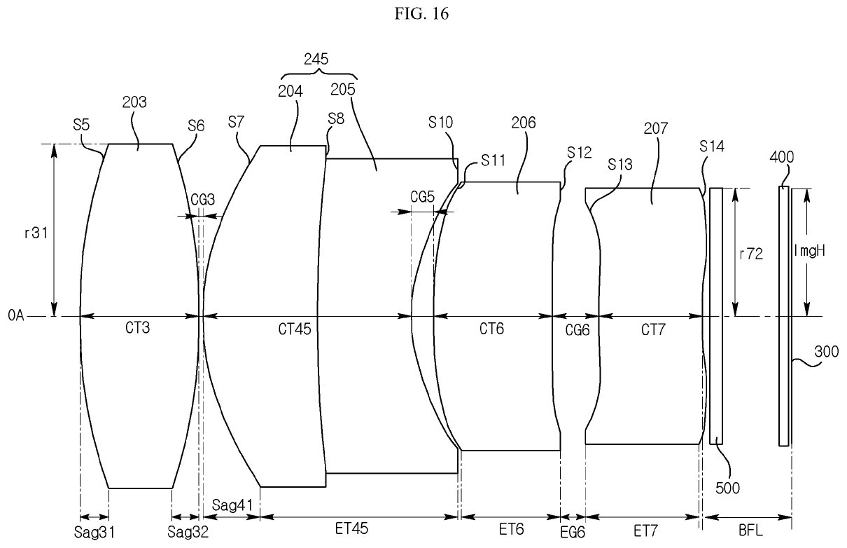

The effective diameter may be the diameter of the effective area on which valid light is incident from each lens. The effective diameter is the length in the direction (X, Y) orthogonal to the optical axis, and is the average of the effective diameter on the object side surface of each lens and the effective diameter on the sensor side surface. The “diameter of the lens surface” may mean the “effective diameter of the lens.” The “diameter of the lens” may be the diameter of the entire lens including the flange portion of the lens in addition to the effective area of the lens. Although the flange of the lens is not illustrated in FIGS. 15 and 16, the flange may be a portion protruding perpendicular to the optical axis from the side surface of the lens so that the lens is coupled to the barrel. Valid light may not be incident on the flange. A spacer may be additionally disposed between the flanges of different lenses so that the lenses are coupled to the barrel.

Each of the lenses 201 to 207 may include an effective region and an ineffective region. The effective region may be a region through which light incident on each of the lenses passes. That is, the effective region may be defined as an effective region or effective diameter through which the incident light is refracted to implement optical characteristics. The ineffective region may be disposed around the periphery of the effective region. The ineffective region may be a region through which effective light is not incident from a plurality of lenses. That is, the ineffective region may be a region unrelated to the optical characteristics. In addition, an end of the ineffective region may be a region being fixed to a lens barrel or the like that accommodates the lens.

Within the optical system 1500, the total top length (TTL) may be more than 2 times, for example, more than 4 times and less than 12 times, than the ImgH. The total track length (TTL) is the distance from the center of the object side surface of the first lens to the top surface of the image sensor 300 on the optical axis OA. The ImgH is the distance from the optical axis OA to the diagonal end of the image sensor 300 or ½ of the maximum diagonal length. Within the optical system 1500, the effective focal length (EFL) is provided to be 10 mm or more and the angle of view (FOV) is provided to be less than 45 degrees, so that the optical system may be provided as a standard optical system in a vehicle camera module. For example, the optical system and the camera module according to an embodiment may be applied to a camera for an advanced driving assistance system (ADAS) being provided inside or outside a vehicle.

The optical system 1500 may have a condition of TTL/ImgH of 5 or more and 7.5 or more, for example, 6 or more and 7.5 or less. By setting the value of TTL/ImgH to 5 or more and 7.5 times or less, the optical system 1500 may provide a vehicle lens optical system. The total number of lenses of the first and second lens groups LG1 and LG2 is 8 or less. Accordingly, the optical system 1500 may provide an image without exaggeration or distortion of the image being formed.

The effective diameter of at least one plastic lens within the optical system 1500 may be smaller than the length of the image sensor 300. The effective diameter is the diameter or length of the effective area where light is incident. The length of the image sensor 300 is the maximum length of the diagonal in the direction orthogonal to the optical axis OA. The number of lenses having an effective diameter larger than the length of the image sensor 300 within the optical system 1500 may be 50% or more or 60% or more, and the number of lenses having an effective diameter smaller than the length of the image sensor 300 may be less than 50% or less than 40%.

The optical system 1500 may include at least one cemented lens 245 therein. The cemented lens 245 may be a lens in which at least two lenses having different refractive powers are bonded, and a gap between the two lenses may be less than 0.01 mm. The cemented lens 245 may be a lens in which two lenses having different focal lengths are bonded. The bonding of the two lenses may be bonded using an adhesive. The effective diameter of at least one lens or all lenses disposed on the object side with respect to the cemented lens 245 may be larger than the length of the image sensor 300. The effective diameter of at least one lens disposed on the sensor side with respect to the cemented lens 245 may be smaller than the length of the image sensor 300. In addition, among the cemented lenses 245, the object side lens 203 may be larger than the length of the image sensor 300, and the sensor side lens 204 may be larger than the length of the image sensor 300.

The lenses between the cemented lens 245 and the first lens 201 may be made of glass or plastic. The lenses disposed between the cemented lens 245 and the image sensor 300 may be made of plastic. The lenses between the cemented lens 245 and the first lens 201 may be spherical lenses on both sides or aspherical lenses on both sides. The lenses disposed between the cemented lens 245 and the image sensor 300 may be aspherical lenses on both sides. The two sides are the object side and the sensor side. Therefore, by arranging the aspherical lenses between the cemented lens 245 and the image sensor 300, it is possible to correct curvature aberration and chromatic aberration, thereby improving optical performance.

The first lens group LG1 and the second lens group LG2 in the optical axis OA may have a set gap. The optical axis gap between the first lens group LG1 and the second lens group LG2 in the optical axis OA may be the optical axis gap between the sensor side of the lens closest to the sensor side among the lenses in the first lens group LG1 and the object side of the lens closest to the object side among the lenses in the second lens group LG2. The optical axis gap between the first lens group LG1 and the second lens group LG2 may be 1 time or less of the optical axis distance of the first lens group LG1, and may be, for example, in the range of 0.1 to 1 time of the optical axis distance of the first lens group LG1.

The optical axis distance between the first lens group LG1 and the second lens group LG2 may be 0.2 times or less than the optical axis distance of the second lens group LG2, and may be, for example, in a range of 0.01 times to 0.2 times. The optical axis distance of the second lens group LG2 is the optical axis distance between the object side surface of the lens closest to the object side of the second lens group LG2 and the sensor side surface of the lens closest to the image sensor 300.

Here, among the lens surfaces of the first lens group LG1 and the second lens group LG2, two surfaces facing each other, for example, the sensor side surface of the object side lens may be concave, and the object side surface of the sensor side lens, may be concave. That is, the sensor side surface closest to the sensor side in the first lens group LG1 may be concave, and the object side surface closest to the object side in the second lens group LG2 may be concave. The first lens group LG1 may diffuse light incident through the object side, and the second lens group LG2 may refract light diffused through the first lens group LG1 into an area of the image sensor 300.

The first lens group LG1 may have negative (−) refractive power, and the second lens group LG2 may have positive (+) refractive power. Among the lenses of the first lens group LG1, the lens closest to the object side may have negative (−) refractive power, and among the lenses of the second lens group LG2, the lens closest to the sensor side may have negative (−) refractive power. When the focal length is expressed as an absolute value, the focal length of the first lens group LG1 may be larger than the focal length of the second lens group LG2, for example, 5 times or more, for example, in a range of 5 to 15 times. The effective focal length (EFL) of the optical system 1500 may be smaller than the absolute value of the focal length of the first lens group LG1. The effective focal length (EFL) of the optical system 1500 may be smaller than the absolute value of the focal length of the first lens group LG1 and larger than the absolute value of the focal length of the second lens group LG2.

The number of lenses having positive (+) refractive power in the optical system 1500 may be equal to or greater than the number of lenses having negative (−) refractive power. The number of lenses having positive (+) refractive power may be 50% or greater than the total number of lenses. The average refractive index of the lenses having positive (+) refractive power may be greater than the average refractive index of the lenses having negative (−) refractive power. Accordingly, the dispersion value of the lenses having negative (−) refractive power may be greater than the dispersion value of the lenses having positive (+) refractive power.

The lens unit 200 may be a mixture of glass lenses and plastic lenses. The number of plastic lenses may be 60% or more of the total number of lenses, and may be in the range of 40% to 85% or 60% to 80%. Accordingly, when more plastic lenses are disposed within the camera module, the weight of the camera module can be reduced, and the camera module is easy to polish and process due to the plastic material, is resistant to external impacts, has high price competitiveness, and is easy to secure materials. In addition, various aberrations can be corrected by the plastic lens, so that optical performance deterioration can be prevented.

An embodiment of the invention can reduce the weight of a camera module by further mixing a plastic lens into the optical system 1500, provide a lower manufacturing cost, suppress deterioration of optical characteristics due to temperature change, enable various types of plastic lenses to replace glass lenses, and facilitate polishing and processing of lens surfaces such as aspherical or free-form surfaces.

The lens unit 200 may include lenses of a first material and lenses of a second material gap along the optical axis OA. The first material may be a glass material, and the second material may be a plastic material. The lenses of the first material may be disposed between the lenses of the second material. The lenses of the second material may be disposed between the lenses of the first material.

The lens unit 200 may include a first material lens having an aspherical surface along the optical axis (OA), lenses of the first material having a spherical surface, and lenses of the second material having an aspherical surface. The first material may be a glass material, and the second material may be a plastic material. The lens of the first material having a spherical surface may be disposed between the lenses of the second material having an aspherical surface. The lens of the second material may be disposed between the lens of the first material having an aspherical surface and the lens of the first material having a spherical surface.

The effective diameter of the lens closest to the object side within the lens unit 200 may be larger than the effective diameter of the lens closest to the image sensor 300. Accordingly, the brightness of the optical system can be controlled. The effective diameter may be the average effective diameter of the object side and the sensor side of each lens. By controlling the effective diameter size of each lens, the optical system 1500 can control the incident light to compensate for the deterioration of the optical characteristics due to resolution and temperature change, improve the chromatic aberration control characteristics, and improve the vignetting characteristics of the optical system (1500).

The lens unit 200 may include a first lens 201, a second lens 202, a third lens 203, a fourth lens 204, a fifth lens 205, a sixth lens 206, and a seventh lens 207 aligned from the object side to the sensor side along the optical axis.

Within the lens unit 200, when the focal length is an absolute value, the focal length of the lens closest to the object may be greater than the focal length of the plastic lens. Here, the plastic lens may be at least one lens disposed on the sensor side of the cemented lens, or at least one lens adjacent to the image sensor.

The lens unit 200 may be disposed in a camera module having an inner barrel on one side or the entire inner surface of a lens barrel. The lens unit 200 may be disposed in a camera module having a plurality of inner barrels around different lenses of the lens barrel. The lens unit 200 may be disposed in a camera module having a first inner barrel in contact with an outer surface of at least one lens of the lens barrel and a second inner barrel in contact with an outer surface of at least one lens. The lens unit 200 may be disposed in a camera module having a plurality of inner barrels each of which is disposed between an outer surface of at least one lens or two or more lenses and the lens barrel. The lens unit 200 may be disposed in a camera module in which a plurality of inner barrels has a material different from a material of the lens barrel.

Among the lenses constituting the lens unit 200, at least some of the lenses made of glass may be disposed in the lens barrel, and at least some of the lenses made of plastic may be disposed in the inner barrel disposed within the lens barrel. Through this, the optical system 1500 can maintain resolution according to temperature change. The lens unit 200 may be disposed in a camera module having different barrels to minimize decentering of a lens, for example, a plastic lens that expands according to temperature change. The lens barrel in which the lens unit 200 is disposed has a plurality of inner barrels within the lens barrel, thereby maintaining the resolution of the optical system according to temperature change and suppressing deformation of the lenses. Therefore, the effective diameter of at least some of the lenses made of glass included in the lens unit 200 may be smaller than the effective diameter of at least some of the lenses made of plastic.

Within the lens unit 200, there may be at least one lens, for example, at least two lenses, each of which is larger than the average effective diameter of the plastic lenses. When the average effective diameter of the plastic lenses is PLca_Aver and the average effective diameter of the glass lenses is GLca_Aver, the condition of PLca_Aver<GLca_Aver may be satisfied. In addition, the condition of 1<GLca_Aver/PLca_Aver<1.5 may be satisfied. In addition, the relationship between the length of the image sensor 300 and the average effective diameter (PLca_Aver) of the plastic lenses may satisfy the condition of 1≤PLca_Aver/(ImgH*2)<1.5. In addition, the relationship between the average effective diameter of the glass lens and the length of the image sensor 300 may satisfy the condition of 1.1<GLca_Aver/(ImgH*2)<1.5. The difference between the maximum length of the image sensor 300 and the effective diameter of the plastic lens may not be large. Accordingly, by arranging a plastic lens with a small effective diameter adjacent to the image sensor 300, the plastic lenses can disperse color from the center portion of the image sensor 300 to the edge portion.

The average effective diameter of the glass materials may be 10 mm or more, for example, in the range of 10 mm to 15 mm. The average effective diameter of the plastic material may be 8 mm or more, for example, in the range of 8 mm to 12 mm. The lens having the minimum effective diameter may be made of plastic, and the lens having the maximum effective diameter may be made of glass. The minimum effective diameter in the lens unit 200 may be in the range of 7 mm to 10 mm, and the maximum effective diameter may be in the range of 11 mm to 15 mm. The plastic lens is designed to have a smaller effective diameter than the glass lens and is disposed so as not to touch the lens barrel, thereby minimizing changes in optical performance due to temperature changes. In addition, the optical system 1500 may improve resolution and chromatic aberration control characteristics by controlling incident light, and may improve vignetting characteristics of the optical system 1500.

The optical system 1500 or the camera module may include an image sensor 300. The image sensor 300 may detect light and convert the light into an electrical signal. The image sensor 300 may detect light sequentially passing through the lens unit 200. The image sensor 300 may include an element capable of detecting incident light, such as a charge coupled device (CCD) or a complementary metal oxide semiconductor (CMOS).

Here, the length of the image sensor 300 is the maximum length in the diagonal direction orthogonal to the optical axis OA, and may be smaller than the effective diameter of the lens closest to the object within the first lens group LG1 and larger than the effective diameter of the lens closest to the sensor within the second lens group LG2. Here, the number of lenses having an effective diameter larger than the length of the image sensor 300 may be 4 to 6, and the number of lenses having an effective diameter smaller than the length of the image sensor 300 may be 1 to 3.

The optical system 1500 or the camera module may include a filter 500. The filter 500 may be disposed between the second lens group LG2 and the image sensor 300. The filter 500 may be disposed between the image sensor 300 and a lens closest to a sensor, among the lenses of the lens unit 200. For example, the filter 500 may be disposed between the nth lens and the image sensor 300.

The cover glass 400 is disposed between the filter 500 and the image sensor 300, protects an upper portion of the image sensor 192, and prevents the reliability of the image sensor 192 from being deteriorated. The cover glass 400 may be removed. The cover glass 400 may be a protective glass.

The filter 500 may include an infrared filter or an infrared cut-off filter (IR cut-off). The filter 500 may allow light of a set wavelength band to pass through and filter out light of a different wavelength band. When the filter 500 includes an infrared filter, it may block radiant heat emitted from external light from being transmitted to the image sensor 300. Furthermore, the filter 500 may pass through visible light and reflect infrared light.

The optical system 1500 according to the embodiment may include an aperture (stop). The aperture may adjust the amount of light incident on the optical system 1500. In the lenses disposed between the object and the aperture, the effective diameter of the lens surfaces tends to increase from the object side to the aperture. In the lens surfaces disposed between the aperture and the sensor, the effective diameter of the lens surfaces tends to decrease from the aperture to the sensor side. The tendency for the effective diameter of the lens surfaces to increase or decrease does not only mean the case where the effective diameter of the lens surfaces increases or decreases. For example, it also includes the case where the effective diameter of the lens surfaces increases and then decreases as it goes from the aperture to the sensor side.

The aperture may be disposed at a set position. For example, the aperture may be disposed around the object side or sensor side of the lens closest to the object side among the lenses of the second lens group LG2. Unlike this, the aperture may be disposed around the object side surface or sensor side surface of the object side lens of the first lens group LG1. Unlike this, at least one lens selected from among the plurality of lenses may function as an aperture. In detail, the object side surface or sensor side surface of one lens selected from among the lenses of the optical system 1500 may function as an aperture for controlling the amount of light.

In the optical system 1500 of the embodiment, the sum of the refractive indices of the lenses of the lens unit 200 may be 8 or more, for example, in the range of 8 to 15, and the average of the refractive indices may be in the range of 1.58 to 1.7. The sum of the Abbe numbers of each of the lenses may be 270 or more, for example, in the range of 280 to 350, and the average of the Abbe numbers may be 50 or less, for example, in the range of 35 to 47. The sum of the center thicknesses of the entire lens may be 20 mm or more, for example, in the range of 25 to 30 mm, and the average of the center thicknesses may be in the range of 3.5 to 4.0 mm. The sum of the central gaps between the lenses in the optical axis OA may be 3 mm or more, for example, in the range of 4 to 6 mm, and may be smaller than the sum of the center thicknesses of the lenses. In addition, the average value of the effective diameter of each of the lens surfaces S1 to S14 of the lens unit 200 may be provided as 8 mm or more, for example, in the range of 8 to 15 mm.

In an optical system according to a second embodiment of the invention, the angle of view (diagonal) may be 50 degrees or less, for example, in the range of 20 to 50 degrees. The F number of the optical system or the camera module may be 2.4 or less, for example, in the range of 1.4 to 2.4 or 1.5 to 1.8. In an optical system according to an embodiment of the invention, the maximum angle of view (diagonal) may be 50 degrees or less, for example, in the range of 20 to 50 degrees. The vehicle optical system may have a horizontal angle of view (FOV_H) in a Y-axis direction that is greater than 20 degrees and less than 40 degrees, for example, in the range of 25 to 35 degrees. In addition, the vertical angle of view is provided at a smaller angle than the horizontal angle of view, and may be 20 degrees or less, for example, in the range of 10 to 20 degrees. At this time, the sensor length in the horizontal direction (Y) can be 8.064 mm±0.5 mm, and the sensor height in the vertical direction (X) can be 4.54 mm±0.5 mm. The horizontal field of view (FOV_H) is the field of view with respect to the horizontal length of the sensor. Accordingly, the focus focusing position can be suppressed from changing due to temperature change, and it can be provided as a vehicle camera in which various aberrations are well corrected.

Since the second embodiment is an optical system applied to a vehicle camera, the first lens 201 may be provided as a glass material even though it is designed using a plastic lens and a glass lens together. This is because the glass material has the advantage of being scratch-resistant and insensitive to external temperature compared to the plastic material. The first lens 201 may be a glass mold lens having an aspherical surface and made of glass material. The glass mold lens may be manufactured by placing an optical glass ingot inside a mold having an aspherical shape and through a heating and compression process.

In order to more effectively prevent scratches caused by foreign substances or objects disposed inside a vehicle, a glass lens may be used as the first lens 201, and the object-side surface of the first lens 201 may have a gently curved shape so as not to come into contact with external structures. Through this, scratches caused by contact with external structures may be minimized. For driver monitoring, front/rear photographing of the vehicle, or lane detection and detection of objects around the vehicle while the vehicle is being driven, the angle of view may be more than 20 degrees and less than 40 degrees, and may be, for example, in the range of 25 degrees to 35 degrees. This horizontal angle of view may be a preset angle for an advanced driver assistance system (ADAS).

The optical system 1500 according to the second embodiment may further include a reflective member for changing the path of light. The reflective member may be implemented as a prism that reflects the incident light of the first lens group LG1 toward the lenses. Hereinafter, the optical system according to the embodiment will be described in detail.

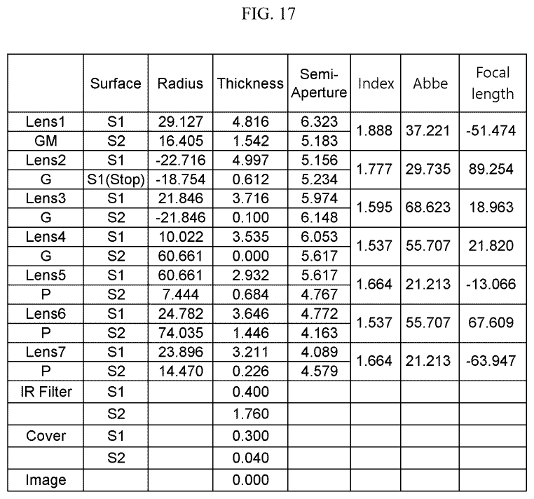

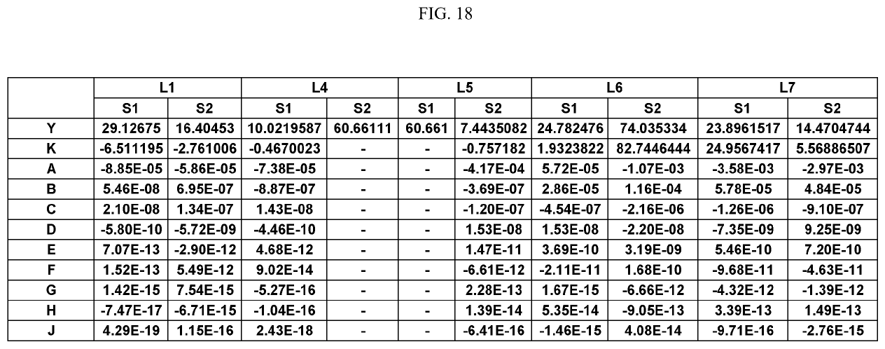

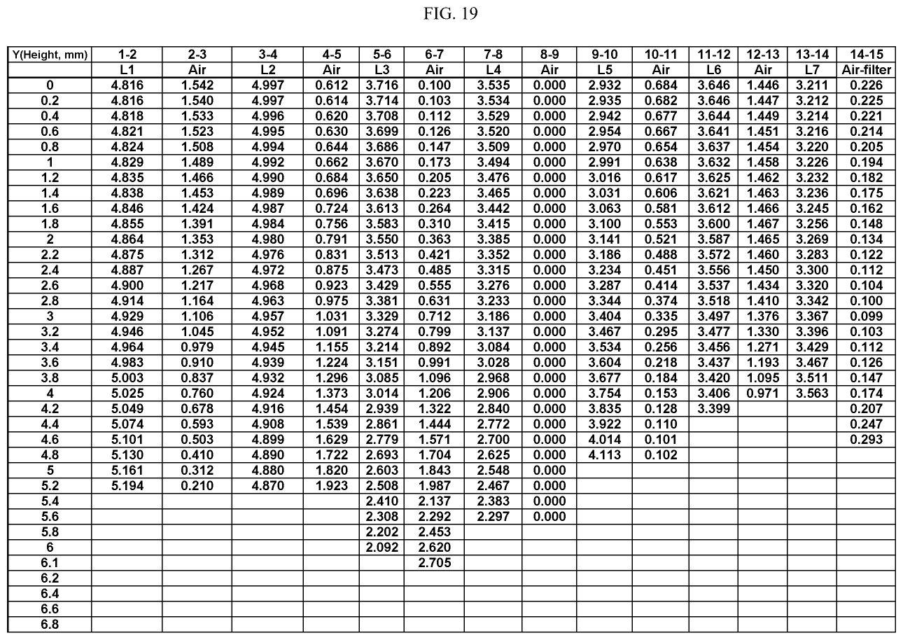

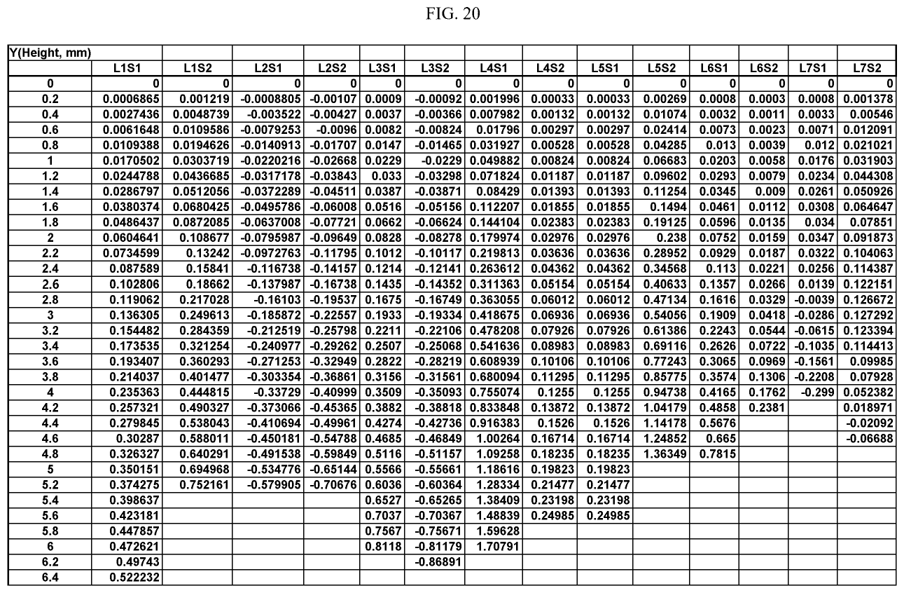

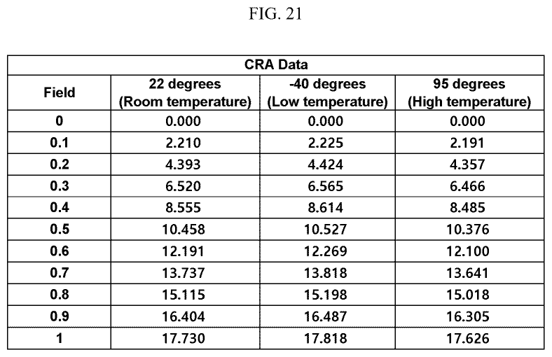

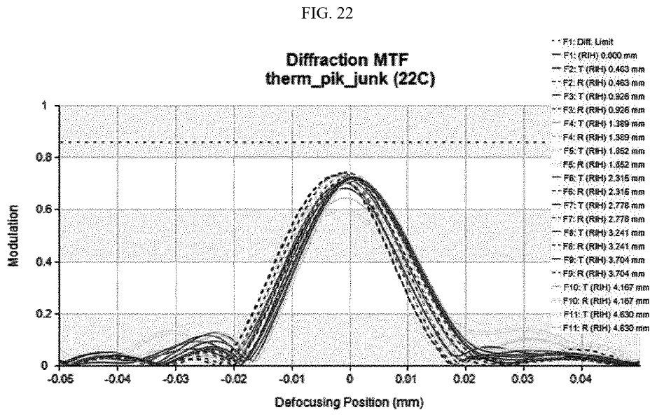

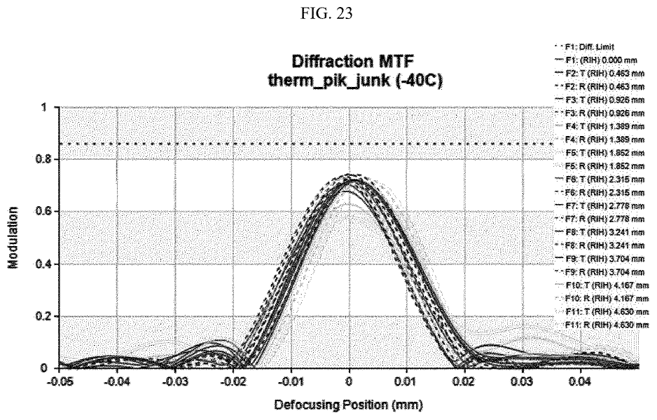

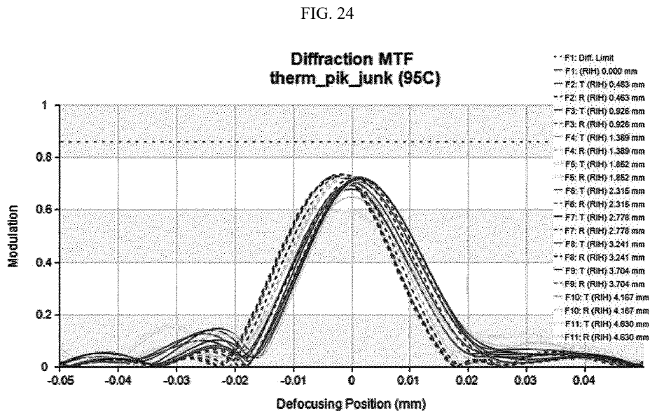

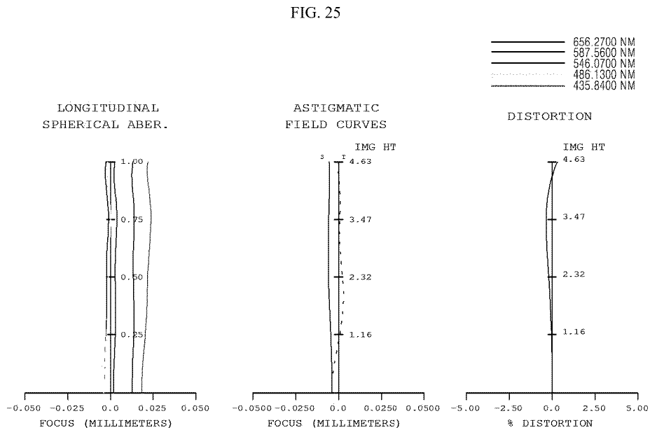

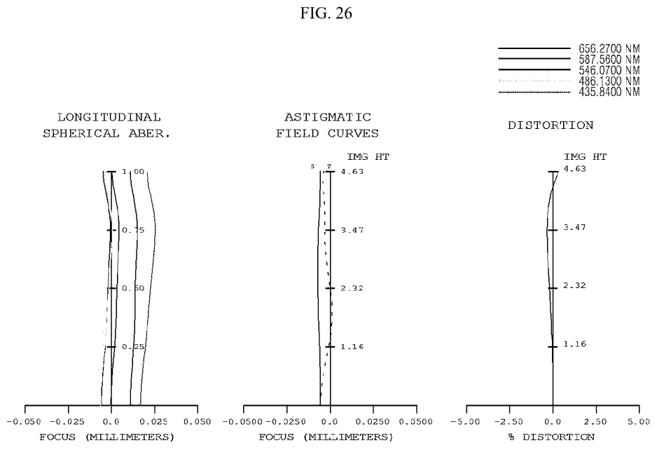

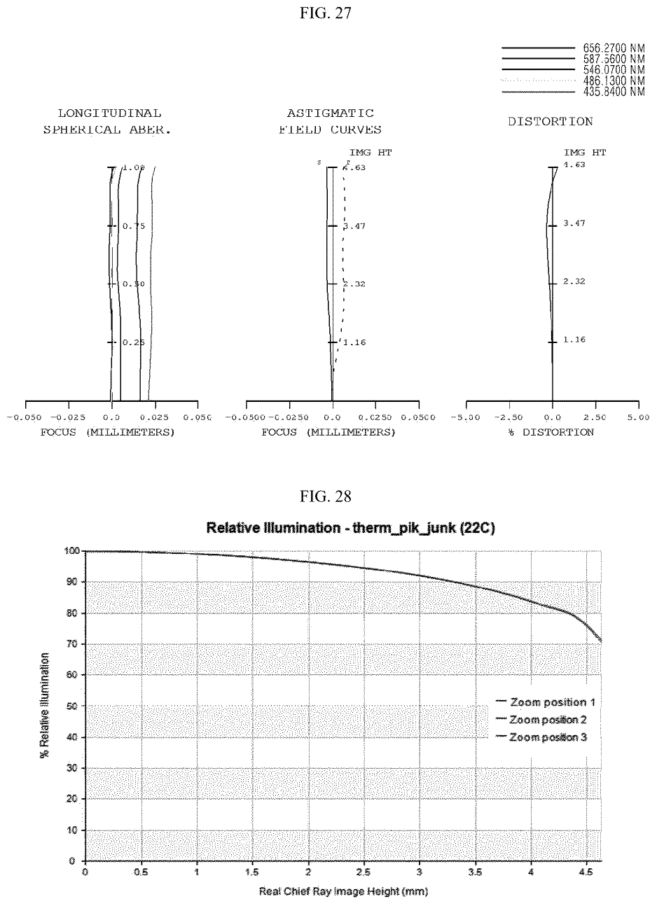

An optical system according to a second embodiment of the invention will be described. FIG. 15 is a cross-sectional side view of an optical system and a camera module having the same according to a second embodiment; FIG. 16 is a cross-sectional view for explaining the relationship between the nth and n-1th lenses according to FIG. 15; FIG. 17 is a table showing the lens characteristics of the optical system of FIG. 15; FIG. 18 is a table showing the aspherical coefficients of the lenses in the optical system of FIG. 15; FIG. 19 is a table showing the thickness of each lens and the gap between adjacent lenses in the optical system of FIG. 15; FIG. 20 is a table showing the sag values of the lens surfaces of the third to sixth lenses in the optical system of FIG. 15; FIG. 21 is a table showing chief ray angle (CRA) data at room temperature, low temperature, and high temperature according to the position of the image sensor in the optical system of FIG. 15; FIGS. 22 to 24 are graphs showing data on diffraction modulation transfer function (MTF) of the optical system of FIG. 15 at room temperature, low temperature, and high temperature; FIGS. 25 to 27 are graphs showing data on aberration characteristics of the optical system of FIG. 15 at room temperature, low temperature, and high temperature; and FIG. 28 is a graph showing relative illumination according to the height of the image sensor according to a second embodiment.

Referring to FIGS. 15 to 18, the optical system 1500 includes a lens unit 200, and the lens unit 200 may include first to seventh lenses 201 to 207. The first to seventh lenses 201 to 207 may be sequentially disposed along the optical axis OA of the optical system 1500. Light corresponding to information on an object may pass through the first to seventh lenses 201 to 207 and the filter 500 to be incident on the image sensor 300.

The first lens 201 is the lens closest to the object side in the first lens group LG1. The seventh lens 207 is the lens closest to the image sensor 207 within the second lens group LG2 or the lens unit 200. The first lens 201 may be the first lens group LG1, and the second to seventh lenses 202, 203, 204, 205, 206, and 207 may be the second lens group LG2. An aperture may be disposed on either the circumference of the object side surface or the sensor side surface of the first lens 201, or the circumference of the object side surface or the sensor side surface of the second lens 202. For example, the aperture (stop) may be disposed on the circumference of the object side surface of the second lens 202.

The first lens 201 may be disposed closest to the object side. The first lens 201 may be disposed farthest from the sensor side. The first lens 201 may have a negative (−) refractive power in the optical axis OA. The first lens 201 may include a plastic material or a glass material, and may be, for example, a glass material. The first lens 201 made of a glass material may reduce a change in a center position and a radius of curvature due to temperature changes according to a surrounding environment, and may protect an incident side surface of the optical system 1500.

The object side first surface S1 of the first lens 201 may be convex and the sensor side second surface S2 may be concave with respect to the optical axis. The first lens 201 may have a meniscus shape that is convex toward the object side. The first lens 201 is made of a glass material and may have an aspherical surface. Aspherical coefficients of the first and second surfaces S1 and S2 may be provided as LIS1 and L1S2 of FIG. 18. The first lens 201 may be manufactured as a lens having an aspherical surface by injection molding a glass material. The first lens 201 may be a glass mold lens having an aspherical surface and made of a glass material. The glass mold lens may be manufactured through heating and compression processes by putting an optical glass ingot in a mold that will have an aspherical shape.

The effective radius r11 of the first lens 201 may be greater than the effective radius of the plastic lenses. Unlike this, at least one of the object side surface and the sensor side surface of the first lens 201 may have a free surface, that is, a non-rotational symmetric surface.

Since the first surface S1 is convex and the second surface S2 is concave, incident light may be refracted in a direction away from the optical axis OA, and a gap between the first and second lenses 201 and 202 may be reduced. Also, the effective diameter of the sensor side surface of the second lens 202 may be designed to be smaller than the effective diameter of the object side surface due to the shape of the lens surface of the first lens 201. The first surface S1 of the first lens 201 may be provided without a critical point from the optical axis OA to the end of the effective area, that is, the edge. The second surface S2 of the first lens 201 may be provided without a critical point.

The refractive index n1 of the first lens 201 may satisfy the condition of n1>1.8 or n1>1.82. Since the refractive index n1 of the first lens 201 is the largest within the lens unit 200, the radius of curvature of the first and second lenses 201 and 202 can be increased, and lens manufacturing can be facilitated. If the refractive index n1 of the first lens 201 is less than the condition, the lens surface must be formed to be sharply concave or convex in order to increase the refractive power of the first and second lenses 201 and 202, and in this case, lens manufacturing is not easy, the lens defect rate increases, and this can cause a decrease in yield.

The second lens 202 may be disposed second from the object side. The second lens 202 may be disposed sixth from the sensor side. The second lens 202 may be disposed between the first lens 201 and the third lens 203. The second lens 202 may have a positive (+) refractive power in the optical axis OA. The second lens 202 may include a plastic or glass material. For example, the second lens 202 may be provided as a glass material.

With respect to the optical axis OA, the object side third surface S3 of the second lens 202 may be concave, and the sensor side fourth surface S4 may be convex. The second lens 202 may have a meniscus shape convex toward the sensor side. The second lens 202 is made of a glass material and may be a spherical surface. At least one or all of the third surface S3 and the fourth surface S4 may be spherical.

The aperture (stop) can be disposed around the sensor side fourth surface S4 of the second lens 202. The aperture can reduce the TTL within the field of view range, and the optical system can be miniaturized. Accordingly, the yield by weight of the optical system can be prevented from decreasing, and the production efficiency can be enhanced. In addition, the optical system can be miniaturized by reducing the TTL within the horizontal field of view (FOV_H) of 25 degrees to 36 degrees.

The third lens 203 may be disposed third from the object side. The third lens 203 may be disposed fifth from the sensor side. The third lens 203 may be disposed between the second lens 202 and the fourth lens 204. The third lens 203 may have a positive (+) refractive power in the optical axis OA. The third lens 203 may include a plastic or glass material. For example, the third lens 203 may be provided as a glass material.

The object-side fifth surface S5 of the third lens 203 may be convex with respect to the optical axis, and the sensor side sixth surface S6 may be convex. The third lens 203 may have a shape in which both surfaces are convex with respect to the optical axis OA. The third lens 203 is made of a glass material and may be a spherical surface. At least one or all of the fifth and sixth surfaces S5 and S6 may be spherical. At least one or all of the fifth and sixth surfaces S5 and S6 may be provided without a critical point from the optical axis OA to the end of the effective area.

Since both sides of the third lens 203 are provided convexly, the TTL and the number of lenses of the optical system can be minimized, and light can be effectively refracted. In addition, when the radius of curvature of the fifth surface S5 of the third lens 203 is L3R1, and the radius of curvature of the sixth surface S6 is L3R2, the condition of L3R1>|L3R2| can be satisfied. When this condition is satisfied, the light is efficiently refracted by the fifth surface S5, so that the effective diameters of the fourth to seventh lenses 204 to 207 can be guided so as not to increase, and the TTL can be reduced. If the condition of L3R1<|L3R2| exists, a lot of aberration may occur on the object side surface of the third lens 203, the refractive efficiency of light may decrease on the sensor side surface, the effective diameters of the rear lenses may increase, and the TTL may also become larger. The absolute values of the radii of curvature on both sides of the third lens 203 can be the same. When the condition of L3R1=|L3R2| is satisfied, since each of the object side surface and the sensor side surface has a convex shape with the same curvature, so that the same optical characteristics can be obtained regardless of the direction in which one surface or the other surface of the third lens 203 is disposed, and through this lens assembly can become facilitated.

The fourth lens 204 may be disposed fourth from the object side. The fourth lens 204 may be disposed fourth from the sensor side. The fourth lens 204 may be disposed between the third lens 203 and the fifth lens 205. The fourth lens 204 may have a positive (+) or negative (−) refractive power in the optical axis OA. The fourth lens 204 may have a positive (+) refractive power. The fourth lens 204 may have a positive (+) refractive power that is different from that of the fifth lens 205. The fourth lens 204 may include a plastic material or a glass material. For example, the fourth lens 204 may be made of a plastic material. The fourth lens 204 may be made of the same material as the fifth lens 205.

The seventh surface S7 on the object side of the fourth lens 204 with respect to the optical axis may be convex, and the eighth surface S8 on the sensor side may be concave. The fourth lens 204 may have a meniscus shape that is convex toward the object side. The fourth lens 204 is made of a plastic material and may have an aspherical surface. At least one or both of the seventh surface S7 and the eighth surface S8 may be aspherical. The seventh surface S7 and the eighth surface S8 may be provided without a critical point from the optical axis OA to the end of the effective area.

The fifth lens 205 may be disposed fifth from the object side. The fifth lens 205 may be disposed third from the sensor side. The fifth lens 205 may be disposed between the fourth lens 204 and the sixth lens 206. The fifth lens 205 may have a positive (+) or negative (−) refractive power in the optical axis OA. The fifth lens 205 may have a negative (−) refractive power. The fifth lens 205 may have a negative (−) refractive power different from that of the fourth lens 204. The fifth lens 205 may include a plastic material or a glass material. For example, the fifth lens 205 may be made of a plastic material. The fifth lens 205 may be provided with the same material as the fourth lens 204.

With respect to the optical axis OA, the ninth surface S9 on the object side of the fifth lens 205 may be convex, and the tenth surface S10 on the sensor side may be concave. The fifth lens 205 may have a meniscus shape that is convex from the optical axis OA toward the object. The fifth lens 205 may be made of a plastic material and may have an aspherical surface. At least one surface of the ninth surface S9 and the tenth surface S10 may be an aspherical surface. At least one or both of the ninth and tenth surfaces S9 and S10 of the fifth lens 205 may be provided without a critical point from the optical axis OA to the end of the effective area.

The fourth lens 204 and the fifth lens 205 can be bonded. The bonding surface between the fourth lens 204 and the fifth lens 205 can be defined as the eighth surface S8. The eighth surface S7 can be the same surface as the ninth surface of the fifth lens 205. The object side surface of the cemented lens 245 can be convex, and the sensor side surface can be concave. The gap between the fourth and fifth lenses 204 and 205 can be less than 0.01 mm, and can be bonded with an adhesive. The gap between the fourth and fifth lenses 204 and 205 can be less than 0.01 mm from the optical axis OA to the end of the effective area. The fourth and fifth lenses 204 and 205 can have opposite refractive powers. The combined refractive power of the fourth and fifth lenses 204 and 205 can have positive (+) refractive power.

The value of the radius of curvature of the bonding surface S8 of the bonding lens 245 may be greater than 30. For example, a value of the radius of curvature of the bonding surface S8 of the cemented lens 245 may be greater than 50. The bonding surface S8 of the cemented lens 245 may be formed in a gentle shape. Through this, the bonding process of the fourth lens 204 and the fifth lens 205 forming the cemented lens 245 is advantageous, and the bonding holding power can be increased.

The product of the refractive power of the object side fourth lens 204 of the cemented lens 245 and the refractive power of the sensor side fifth lens 205 may be less than 0. The product of the focal length of the object side fourth lens 205 of the cemented lens 245 and the focal length of the sensor side fifth lens 205 may be less than 0. Accordingly, the aberration characteristics of the optical system can be improved. If the refractive powers of the two lenses of the cemented lens 245 are the same, there is a limit to the improvement of aberration.

The combined refractive power of the cemented lens 245 has positive refractive power, and the fourth lens 204 on the object side and the fifth lens 205 on the sensor side with respect to the cemented lens 245 can have positive refractive power. Accordingly, the fourth lens 204, the cemented lens 245, and the fifth lens 205 can refract some of the incident light in the direction of the optical axis, and can mutually correct chromatic aberration. The focal length of the fourth lens 204 being disposed on the object side with respect to the cemented lens 245 can be smaller than the focal length of the fifth lens 205 being disposed on the sensor side. The power of the fourth lens 204 being disposed on the object side with respect to the cemented lens 245 can be greater than the power of the fifth lens 205 being disposed on the sensor side.

The effective diameter of the fourth lens 204 may be larger than the diagonal length of the image sensor 300. The effective diameter of the fourth lens 204 is an average of the effective diameters of the seventh surface S7 and the eighth surface S8, and may be larger than the diagonal length of the image sensor 300. The effective diameter of the fifth lens 205 may be smaller than the effective diameter of the fourth lens 204 and larger than the diagonal length of the image sensor 300.

When the effective diameter of the seventh surface S7 of the fourth lens 204 is CA_L4S1 and the effective diameter of the eighth surface S8 is CA_L4S2, the effective diameters of the seventh and eighth surfaces S7 and S8 can satisfy the condition of 1<CA_L4S1/CA_L4S2<1.5. When the effective diameter of the ninth surface S9 of the fifth lens 205 is CA_L5S1 and the effective diameter of the tenth surface S10 is CA_L5S2, the effective diameters of the ninth and tenth surfaces can satisfy the condition of 1<CA_L5S1/CA_L5S2<1.5.

The cemented lens 245 can be bonded with plastic lenses having different refractive indices. The object side and the sensor side of the cemented lens 245 can have aspherical surfaces, and the bonded surface can have a spherical surface. By increasing the plastic material lens included in the optical system, the weight of the optical system can be reduced, and the plastic material makes it easy to polish and process, is resistant to external impacts, has high price competitiveness, and can be easily secured. In addition, various aberrations can be corrected by the plastic lens, so that optical performance deterioration can be prevented. If the lenses disposed on the sensor side rather than the cemented lens 245 are aspherical lenses or plastic lenses, spherical aberration can be compensated. In addition, since the lenses disposed on the sensor side rather than the cemented lens 245 are plastic lenses and are disposed as lenses with small effective diameters, the light traveling through the plastic lens to the image sensor 300 can be effectively guided. Since the position of the cemented lens 245 is located in any two consecutive lenses among the third to sixth lenses located in the middle or behind the middle within the lens unit 200, chromatic aberration correction can be more efficient.

The sixth lens 206 may be disposed sixth from the object side. The sixth lens 206 may be disposed second from the sensor side. The sixth lens 206 may be disposed between the fifth lens 205 and the seventh lens 207. The sixth lens 206 may have a positive (+) or negative (−) refractive power in the optical axis OA. The sixth lens 206 may have a positive (+) refractive power. The sixth lens 206 may include a plastic material or a glass material. For example, the sixth lens 206 may be made of a plastic material.

With respect to the optical axis OA, the eleventh surface S11 on the object side of the sixth lens 206 may be convex, and the twelfth surface S12 on the sensor side may be concave. The sixth lens 206 may have a meniscus shape that is convex from the optical axis OA to the object side. Unlike this, the sixth lens 206 may have a shape that is convex on both sides. At least one or both of the eleventh surface S11 and the twelfth surface S12 may be aspherical. The aspherical coefficients of the eleventh and twelfth surfaces S11 and S12 may be provided as L1 and L2 of L6 of FIG. 18.

The eleventh surface S11 of the sixth lens 206 can be provided without a critical point from the optical axis OA to the end of the effective area. The twelfth surface S12 can be provided without at least one critical point from the optical axis OA to the end of the effective area.

The seventh lens 207 may be disposed closest to the sensor side. The seventh lens 207 may be disposed farthest from the object side. The seventh lens 207 may have positive (+) or negative (−) refractive power on the optical axis OA. The seventh lens 207 may have negative (−) refractive power. The seventh lens 207 may include a plastic or glass material. For example, the seventh lens 207 may be made of a plastic material.

The object side 13th surface S13 of the seventh lens 207 on the optical axis may be convex, and the sensor side 14th surface S14 may be concave. The seventh lens 207 may have a meniscus shape that is convex toward the object side. At least one surface among the 13th surface S13 and the 14th surface S14 may be aspherical. For example, both the 13th surface S13 and the 14th surface S14 may be aspherical. The aspherical coefficients of the 13th and 14th surfaces S13 and S14 may be provided as S1 and S2 of L7 of FIG. 18.

The thirteenth surface S13 of the seventh lens 207 may have a critical point from the optical axis OA to the end of the effective area. When the thirteenth surface S13 has a critical point, it may be located at 50% or more of the effective radius (r71) from the optical axis OA, or in a range of 52% to 70%, or in a range of 53% to 60%. When the fourteenth surface S14 has a critical point, it may be located at 70% or more of the effective radius (r72) from the optical axis OA, or in a range of 70% to 90%, or in a range of 75% to 85%.

The seventh lens 207 may be a plastic lens that is closest to the image sensor 300. In addition, by arranging two or more plastic lenses adjacent to the image sensor 300, aberrations such as spherical aberration and chromatic aberration can be improved by the lens surface having an aspherical surface, and the influence on the resolution can be controlled. In addition, by arranging the plastic lens as the lens adjacent to the image sensor 300, it can be insensitive to the assembly tolerance compared to a glass lens. That is, being insensitive to the assembly tolerance means that even if the assembly is slightly different from the design during assembly, the optical performance may not be significantly affected. In addition, by providing the two lenses 206 and 207 adjacent to the image sensor 300 as plastic, the optical performance can be improved by the lens surface having an aspherical surface, and for example, aberration characteristics can be improved and resolution deterioration can be prevented.

The sixth lens 206 and the seventh lens 207 are disposed spaced apart from each other, but may include the characteristics of a cemented lens. The sixth lens 206 and the seventh lens 207 may have opposite refractive powers. The product of the refractive power of the sixth lens 206 and the refractive power of the seventh lens 207 may be less than 0. The product of the focal length of the sixth lens 206 and the focal length of the seventh lens 207 may be less than 0. Accordingly, the aberration characteristics of the optical system may be improved. If the refractive powers of two lenses having the characteristics of a cemented lens are the same, there is a limit to the improvement of aberrations.

The sixth lens 206 and the seventh lens 207 may be formed of the same material. The sixth lens 206 and the seventh lens 207 may be formed of a plastic material. The sixth lens 206 and the seventh lens 207 may be formed of the same material as the cemented lens 245.

At least one or both of the 13th surface S13 and the 14th surface S14 of the seventh lens 207 may have a critical point. The 13th surface S13 of the seventh lens 207 may have a first critical point P1 from the optical axis OA to an end of the effective area. The first critical point P1 of the 13th surface S13 may be located at 55% or more of the effective radius from the optical axis OA, or in a range of 55% to 75% or in a range of 60% to 70%. The first critical point of the 13th surface S13 may be located at a distance of 2 mm or more from the optical axis OA, for example, in a range of 2.1 mm to 2.5 mm or in a range of 2.2 mm to 2.3 mm. As another example, the 13th surface S13 may be provided without a critical point. The 13th surface S13 having the first critical point P1 can refract incident light to the center portion and the edge portion, and improve aberration. The first and second critical points P1 and P2 are points where the sign of the gradient value with respect to the optical axis OA and the direction perpendicular to the optical axis OA changes from positive (+) to negative (−) or from negative (−) to positive (+), and may mean a point where the gradient value is 0. In addition, the first and second critical points P1 and P2 may be points where the gradient value of the tangent passing through the lens surface increases and then decreases, or points where the gradient value decreases and then increases.

The fourteenth surface S14 of the seventh lens 207 can have at least one second critical point P2 from the optical axis OA to the end of the effective area. The second critical point P2 of the fourteenth surface S14 can be located at a distance of 60% or more of the effective radius (r72) from the optical axis OA, or in a range of 60% to 80% or in a range of 65% to 75%. The second critical point P2 of the fourteenth surface S14 can be located at a distance of 2.9 mm or more from the optical axis OA, for example, in a range of 2.9 mm to 3.9 mm or in a range of 3.1 mm to 3.7 mm. Accordingly, the second critical point P2 is disposed closer to the edge than the first critical point P1, so that the seventh lens 207 can refract incident light to the edge portion of the image sensor 300.

The average effective radius of the 13th and 14th surfaces S13 and S14 of the 7th lens 207 is disposed to be smaller than ImgH, which is half the diagonal length of the image sensor 300, and this can refract light to the edge portion of the image sensor 300 by the 14th surface S14 having the second critical point P2.

As shown in FIGS. 15 and 16, the center thicknesses of the first to seventh lenses 201 to 207 are represented by CT1 to CT7, the edge thicknesses at the ends of the effective areas of each lens are represented by ET1 to ET7, the center gap between two adjacent lenses is represented by CG1 to CG6, and the edge gaps between the edges of each lens are represented by EG1 to EG6. Here, the center thickness of the cemented lens 245 is CT45, and the edge thickness is represented by ET45.

Referring to FIG. 16, back focal length (BFL) is the optical axis distance from the image sensor 300 to the center of the last lens. In FIG. 15, TTL is the optical axis distance from the center of the first surface S1 of the first lens 201 to the upper surface of the image sensor 300.

FIG. 17 is an example of lens data of the optical system of a second embodiment of FIG. 15. As shown in FIG. 17, a radius of curvature at the optical axis OA of the first to seventh lenses 201, 202, 203, 204, 205, 206, and 207, the thickness of the lenses, the distance between the lenses, the refractive index at the d-line, the Abbe's Number, and the size of the clear aperture (CA) can be set.

As shown in FIG. 18, among the lenses of the lens unit 200 of the second embodiment, the lens surfaces of the first, fourth, fifth, sixth, and seventh lenses 201, 204, 205, 206, and 207 may include aspherical surfaces having a 30th-order aspherical surface coefficient. For example, the first, fourth, fifth, sixth, and seventh lenses 201, 204, 205, 206, and 207 may include lens surfaces having a 30th-order aspherical surface coefficient. As described above, since the aspherical surface having a 30th-order aspherical surface coefficient (a numerical value other than “0”) can significantly change the aspherical shape of the edge portion, the optical performance of the edge portion of the field of view (FOV) can be well corrected.

As shown in FIG. 19, the thickness (T1-T7) of the first to seventh lenses 201, 202, 203, 204, 205, 206, and 207 and the gaps (G1-G6) between adjacent two lenses can be set. As shown in FIG. 19, the thickness (T1-T7) of each lens in a Y-axis direction can be expressed at intervals of 0.1 mm or 0.2 mm or more, and the gaps (G1-G6) between each lens can be expressed at intervals of 0.1 mm or 0.2 mm or more.

Referring to FIGS. 17 and 19, when comparing the absolute values of the curvature radii of each lens, the curvature radii of the twelfth surface S12 of the sixth lens 206 on the optical axis (OA) may be the largest among the lenses, and the curvature radii of the tenth surface S10 of the fifth lens 205 may be the smallest among the lenses. The difference between the maximum curvature radii and the minimum curvature radii may be 10 times or more, for example, 10 to 15 times.

With respect to the optical axis, when explaining the center thickness of the lenses, the center thickness (CT2) of the second lens 202 is the largest among the lenses, and the center thickness (CT5) of the fifth lens 205 is the smallest among the lenses. The difference between the maximum center thickness and the minimum center thickness among the lenses may be in the range of 1.5 mm or more and 2.5 mm or less.

When explaining the center gap (CG) between the lenses, the center gap (CG1) between the first lens 201 and the second lens 202 may be the maximum, and the center gap (CG3) between the third and fourth lenses 203 and 204 may be the minimum. Here, the minimum center gap excludes the bonding surface of the cemented lens 245. The difference between the maximum center gap and the minimum center gap among the spaced lens gaps may be 1.2 mm or more, for example, in the range of 1.3 mm to 1.8 mm. In addition, by providing the maximum center gap between the lenses to be 70% or less of the maximum center thickness, for example, in the range of 30% to 70%, it is possible not to increase the thickness of the camera module that applies the plastic lens having a thin thickness without increasing the center gap compared to the center thickness of each lens.

When explaining about the effective diameter, the lens having the maximum effective diameter may be disposed between the first lens 201 closest to the object and the seventh lens 207 closest to the image sensor 300. The lens having the maximum effective diameter may be a glass lens. The lens having the maximum effective diameter may be disposed between the first lens 201 and the cemented lens 245. The lens having the maximum effective diameter may be the third lens 203. Here, the effective diameter is the average of the effective diameters of the object side surface and the sensor side surface of each lens. The lens surface having the maximum effective diameter may be the sixth surface S6 of the third lens 203 or the object side surface of the cemented lens 245.

The lens having the minimum effective diameter may be any one of the plastic lenses, for example, the seventh lens 207 adjacent to the image sensor 300. For example, the effective diameter of the seventh lens 207 may be the minimum within the lens unit 200. The lens surface having the minimum effective diameter may be the thirteenth surface S13 of the seventh lens 207.

The effective diameters of each of the first to fourth lenses 201 to 204 adjacent to the object side may be larger than the effective diameters of the fifth, sixth, and seventh lenses 205, 206, and 207 adjacent to the sensor side. The effective diameters of the first to fourth lenses 201 to 204 may be larger than the diagonal length of the image sensor 300. The average effective diameter of the seventh lens 207 may be smaller than the diagonal length of the image sensor 300. Accordingly, light incident through a plurality of lenses aligned along the optical axis may be guided to the image sensor 300.

When explaining the refractive index, the refractive index of the first lens 201 may be the largest among the lenses and may be greater than 1.8, for example, greater than 1.82. Either or both of the second lens 202 and the sixth lens 206 may have the smallest refractive index among the lenses. For example, it may be less than 1.6, for example, less than 1.55. The difference between the maximum refractive index and the minimum refractive index may be 0.2 or more. By providing a high refractive index lens made of glass closest to the object and providing a lens adjacent to the glass lens and a lens adjacent to the image sensor 300 as a low refractive index lens made of plastic, the incidence efficiency may be increased, and the refractive power between the glass lens and the plastic lens may be adjusted to guide the image sensor 300.

When comparing the Abbe numbers, the Abbe number of the third lens 203 is the largest among the lenses and can be 60 or more. The Abbe numbers of the fifth lens 205 and the seventh lens 207 are the smallest among the lenses and can be 25 or less. The difference between the maximum refractive index and the minimum Abbe number can be 40 or more. By making the Abbe number of the third lens 203 adjacent to the cemented lens 245 the largest and providing the Abbe number of the seventh lens 207 with a low refractive index adjacent to the image sensor 300 the smallest, the color dispersion of light traveling between the lenses made of glass can be controlled and the color dispersion between the lenses made of glass and plastic can be increased to guide it to the image sensor 300.

The focal lengths (F1, F5, and F7) of the first, fifth, and seventh lenses 201, 205, and 207 may have negative (−) signs. The first, fifth, and seventh lenses 201, 205, and 207 may have negative (−) refractive power. The focal lengths (F3, F4, F5, and F6) of the third, fourth, fifth, and sixth lenses 203, 204, 205, and 206 may have positive (+) signs. The third, fourth, fifth, and sixth lenses 203, 204, 205, and 206 may have positive (+) refractive power. The second, third, and fourth lenses 202, 203, and 204 having positive (+) refractive power may be disposed on the sensor side of the first lens 201 having negative (−) refractive power. Through this, light incident on the object side can move away from the optical axis direction and then gather again in the optical axis direction, thereby forming a stable optical path.

In addition, the sixth lens 206 and the seventh lens 207, which are adjacently disposed lenses, can satisfy the following conditions.

Condition 1: The refractive index of the lens with positive refractive power<the refractive index of the lens with negative refractive power

Condition 2: Dispersion value of a lens with positive refractive power>dispersion value of a lens with negative refractive power

Here, among the plastic lenses, the sixth lens 206 has positive refractive power and the seventh lens 207 has negative refractive power, so that according to conditions 1 and 2, the refractive index of the sixth lens is smaller than that of the seventh lens, and the dispersion value of the sixth lens is larger than the dispersion value of the seventh lens. Chromatic aberration occurring in the plastic lens can be corrected by the plastic lens. In addition, since the sixth lens 206 and the seventh lens 207, which are plastic lenses being consecutively disposed, satisfy the refractive index difference of 0.1 or more and 0.15 or less and the Abbe number difference of 20 or more and 60 or less, the chromatic aberration occurring in the plastic lens can be compensated for by the plastic lens.

The optical system has chromatic aberration, and chromatic aberration is corrected by using cemented lenses or two lenses disposed in series. As the temperature changes from low to high, the lens repeatedly contracts and expands. Since the lens characteristics of lenses of the same material change the same amount according to the temperature change, it is effective to correct chromatic aberration between lenses of the same material even when the temperature changes.

Therefore, in a second embodiment of the present invention, the chromatic aberration occurring in the plastic lens is corrected by using the cemented lens 245, the sixth lens 206, and the seventh lens 207.

The chromatic aberration occurring in the plastic lens can be compensated for by the plastic lens when the fourth lens 204 and the fifth lens 205, which are the cemented lenses, satisfy the refractive index difference of 0.1 or more and 0.15 or less and the Abbe number difference of 20 or more and 60 or less. The refractive index difference is rounded to the third decimal place, and the Abbe number difference is rounded to the first decimal place to compare the values.

When comparing the focal lengths in absolute values, the focal length of the second lens 202 is the largest among the lenses, and may be 55 or more or 200 or more. Among the lenses, the second lens 202 made of glass may have the largest focal length and the smallest refractive power. Among the lenses, the lens with the second largest focal length after the second lens 202 may be the sixth lens 206 made of plastic. The focal length of the fifth lens 205 is the smallest among the lenses, and the absolute value of the focal length of the fifth lens 205 may be 15 or less or 10 or less. Among the lenses, the fifth lens 205 made of plastic may have the smallest focal length and the largest refractive power. Since lenses made of plastic having small refractive power are disposed on the sensor side of the fifth lens 205, the refractive power of the fifth lens 205 may increase.

Among the lenses other than the cemented lens 245, the lens having the minimum focal length may be the third lens 203. The difference between the maximum focal length and the minimum focal length may be 50 or more or 80 or more. Accordingly, the optical system may have enhanced MTF characteristics, aberration control characteristics, resolution characteristics, and the like in the set angle of view range, and may have good optical performance in the edge portion of the angle of view.

A critical point exists on the sensor side of the seventh lens 207. The critical point is the point where the trend of the sag value changes. That is, the point where the sag value increases and then decreases, or the point where the sag value decreases and then increases. Referring to FIG. 20, it can be seen that the critical point exists on the object side surface of the seventh lens 207 between a point 1.8 mm apart and a point 2.2 mm apart in the direction perpendicular to the optical axis. The sag value on the object side of the seventh lens 207 increases to a point 2.0 mm apart in the direction perpendicular to the optical axis, and then is decreasing from a point 2.0 mm apart to a point 4.1 mm apart in the direction perpendicular to the optical axis.

It can be seen that the sensor side surface of the seventh lens 207 has a critical point between a point 2.8 mm apart in the direction perpendicular to the optical axis and a point 3.2 mm apart. The sensor side surface of the seventh lens 207 has a sag value that increases to a point 2.9 mm apart in the direction perpendicular to the optical axis, and then decreases from a point 2.9 mm apart in the direction perpendicular to the optical axis to a point 4.6 mm apart. If the critical point exists on the sensor side surface of the seventh lens 207, that is, on the sensor side surface of the last lens, that is, on the lens surface closest to the sensor, TTL can be reduced, thereby facilitating miniaturization and weight reduction of the optical system.

The first lens 201 may have a thickness (T1) in that the maximum thickness is 1 or more times of the minimum thickness, for example, 1 to 1.2 times, and the center thickness (CT1) is a minimum and the edge thickness (ET1) may be a maximum. The second lens 202 may have a thickness (T2) in that the maximum thickness is 1 to 1.2 times of the minimum thickness. The center thickness (CT2) of the second lens 202 may be a maximum and the edge thickness (ET2) is a minimum. The thickness (T3) of the third lens 203 may be a maximum at the center and a minimum at the edge, and the maximum thickness is in a range of 1.5 to 2 times the minimum thickness. The thickness (T4) of the fourth lens 204 may be a maximum at the center and a minimum at the edge, and the maximum thickness is in a range of 1.6 to 2.2 times the minimum thickness. The thickness (T5) of the fifth lens 205 may be minimum at the center and maximum at the edge and the maximum thickness is in a range of 1.2 to 1.5 times the minimum thickness. The thickness (T6) of the sixth lens 206 may be maximum at the center and minimum at the edge and the maximum thickness is in a range of 1 to 1.2 times the minimum thickness. The thickness (T7) of the seventh lens 207 may be minimum at the center and maximum at the edge and the maximum thickness is in a range of 1 to 1.2 times the minimum thickness.

The center thickness (CT45) of the cemented lens 245 may be greater than the edge thickness (ET45). The center thickness (CT45) of the cemented lens 245 is a distance from the center of the object side seventh surface S7 of the fourth lens 204 to the center of the tenth surface S10 of the fifth lens 205, and the edge thickness (ET45) is a distance from the end of the effective area of the seventh surface S7 to the tenth surface S10 in the optical axis direction. The maximum thickness of the cemented lens 245 is the center portion, the minimum thickness is the edge portion, and the maximum thickness may be in a range of 1 to 1.2 times the minimum thickness.

Among the gaps G1 to G6 between the lenses, the first gap G1 between the first and second lenses 201 and 202 may have a maximum center portion and a minimum edge portion. The second gap G2 between the second and third lenses 202 and 203 may have a maximum edge portion and a minimum center portion. The third gap G3 between the third and fourth lenses 203 and 204 may have a maximum edge portion and a minimum center portion. The fifth gap G5 between the fifth and sixth lenses 205 and 206 may have a maximum center portion and a minimum edge portion. The sixth gap G6 between the sixth and seventh lenses 206 and 207 may have a maximum center portion and a minimum edge portion.

As shown in FIG. 21, in the optical system and camera module of FIG. 15, the chief ray angle (CRA) may be 10 degrees or more, for example, in a range of 10 to 35 degrees or 10 to 25 degrees, at 1-field, which is the end of the diagonal length of the image sensor. In addition, the difference in the chief ray angle from a low temperature (−40 degrees) to a high temperature (95 degrees) may be 1 degree or less. Accordingly, even if the temperature changes from a low temperature to a high temperature, the difference in the angle of the chief ray is not large and stable optical performance can be achieved.

As shown in FIG. 28, a graph showing the relative illumination according to the image height in the optical system according to an embodiment shows that the relative illumination is 70% or more, for example, 75% or more from the center of the image sensor to the diagonal end. That is, it can be seen that there is almost no difference in the relative illumination (zoom positions 1, 2, and 3) according to room temperature, low temperature, and high temperature up to 4.5 mm from the optical axis.

FIGS. 22 to 24 are graphs showing diffraction modulation transfer function (MTF) at room temperature, low temperature, and high temperature in the optical system of FIG. 15, and are graphs showing modulation according to spatial frequency. As shown in FIGS. 22 to 24, in a second embodiment of the present invention, the deviation of MTF at low temperature or high temperature with respect to room temperature may be less than 10%, that is, 7% or less.

FIGS. 25 to 27 are graphs showing aberration characteristics at room temperature, low temperature, and high temperature in the optical system of FIG. 15. FIGS. 25 to 27 are graphs measuring spherical aberration (longitudinal spherical aberration), astigmatic field curves, and distortion from left to right in the aberration graphs. In FIGS. 25 to 27, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graphs for astigmatism and distortion are graphs for light in wavelength bands of about 546 nm. In the aberration diagrams of FIGS. 25 to 27, it can be interpreted that the closer each curve at room temperature, low temperature, and high temperature is to the Y-axis, the better the aberration correction function is. It can be seen that the optical system 1500 according to an embodiment has measurement values close to the Y-axis in almost all areas. That is, the optical system 1500 according to a second embodiment has improved resolution and can have good optical performance not only in the center portion of the field of view (FOV) but also in the edge portion. Here, the low temperature is-20 degrees or lower, for example, in the range of −20 to −40 degrees, the room temperature is in the range of 22 degrees±5 degrees or in the range of 18 degrees to 27 degrees, and the high temperature can be in the range of 85 degrees or higher, for example, in the range of 85 degrees to 105 degrees. Accordingly, it can be seen that the decrease in the luminance ratio (modulation) from the low temperature to the high temperature of FIGS. 25 to 27 is less than 10%, for example, 5% or lower, or is hardly changed.

Table 3 compares changes in optical characteristics such as EFL, BFL, F number (F #), TTL, and field of view (FOV) at room temperature, low temperature, and high temperature in an optical system according to a second embodiment of the present invention, and it can be seen that the change rate of optical characteristics at low temperature is 5% or less, for example, 3% or less, with respect to room temperature, and it can be seen that the change rate of optical characteristics at low temperature is 5% or less, for example, 3% or less, with respect to room temperature.

TABLE 3

| | | | | Low | High |
|---|---|---|---|---|---|
| | Room | Low | High | temperature/ | temperature/ |
| | temper- | temper- | temper- | Room | Room |
| | ature | ature | ature | temperature | temperature |
| EFL(F) | 15.1 | 15.0382 | 15.1752 | 99.59% | 200.49% |
| BFL | 2.5 | 2.4971 | 2.50346 | 99.88% | 200.13% |
| F# | 1.600 | 1.5934 | 1.60808 | 99.58% | 200.50% |
| TTL | 33.965 | 33.8963 | 34.0458 | 99.79% | 200.23% |
| FOV | 33.9838 | 34.1084 | 33.8365 | 200.36% | 99.56% |

Therefore, as shown in Table 3, it can be seen that the change in optical characteristics according to the temperature change from low temperature to high temperature, for example, the change rate of effective focal length (EFL), TTL, BFL, F number, and field of view (FOV), is 10% or less, that is, 5% or less, for example, in the range of 0 to 5%. This makes it possible to design temperature compensation for plastic lenses even when using at least one or two or more plastic lenses, thereby preventing a decrease in the reliability of optical characteristics.

The optical system of the second embodiment disclosed above can effectively control aberration characteristics such as chromatic aberration and distortion aberration, and can have good optical performance not only in the center portion of the field of view (FOV) but also in the edge portion.

Table 4 shows the items of the mathematical formulas described above in the optical system 1500 of the second embodiment, including the total track length (TTL) (mm), back focal length (BFL), effective focal length (F) (mm), ImgH (mm), effective diameter (CA) (mm), thickness (mm), TTL (mm), TD (mm) which is the optical axis distance from the first surface S1 to the fourteenth surface S14, the focal lengths (F1, F2, F3, F4, F5, F6, and F7) (mm) of each of the first to seventh lenses, sum of refractive indices, sum of Abbe numbers, sum of thicknesses (mm), sum of gaps between adjacent lenses, effective diameter characteristics, sum of refractive indices of glass lenses, sum of refractive indices of plastic materials, angle of view (FOV) (degree), edge thickness (ET), focal lengths of the first and second lens groups, F number, and the like.

TABLE 4

| Category | Value | Category | Value |
|---|---|---|---|
| F | 15.1 | ET1 | 5.0690 |
| F1 | −51.4737 | ET2 | 4.8408 |
| F2 | 89.2542 | ET3 | 2.0094 |
| F3 | 18.9633 | ET4 | 2.0144 |
| F4 | 21.8199 | ET5 | 4.0551 |
| F5 | −13.0662 | ET6 | 3.0923 |
| F6 | 67.6090 | ET7 | 3.5094 |
| F7 | −63.9471 | F-number | 1.600 |
| F_LG1 | −153.9345163 | FOV | 33.9838 |
| F_LG2 | 14.49508546 | EPD | 9.4375 |
| ΣIndex | 11.6613 | BFL | 2.7263 |
| ΣAbbe | 289.4202 | TD | 31.2387 |
| ΣCT | 26.8543 | ImgH | 4.630 |
| ΣCG | 4.3843 | SD | 19.8841 |
| CA_max | 12.645 | TTL | 33.9650 |
| CA_min | 8.177 | GLca_Aver | 11.3396 |
| CA_Aver | 10.5248 | PLca_Aver | 9.914 |
| CT_max | 4.9970 | Image sensor | 3840*2160 |
| CT_min | 2.9323 | CT_Aver | 3.836 |

The optical systems 1000 and 1500 according to the first and second embodiments disclosed above can satisfy at least one or two or more of the mathematical expressions described below. Accordingly, the optical systems 1000 and 1500 according to the embodiment can have improved optical characteristics. For example, when the optical systems 1000 and 1500 satisfies at least one mathematical expression, the optical systems 1000 and 1500 can effectively control aberration characteristics such as chromatic aberration and distortion aberration, and can have good optical performance not only in the center portion of the field of view (FOV) but also in the edge portion. In addition, the optical systems 1000 and 1500 can have improved resolution. In addition, the thickness of the lens on the optical axis OA and the gap of adjacent lenses on the optical axis OA described in the mathematical expression s can refer to the embodiments disclosed above.

$$0.5 < CT 1 / ET 1 < 1 \qquad [ Mathematical Expression 1 ]$$

In Mathematical Expression 1, CT1 is the center thickness of the first lenses 101 and 201, and ET1 is the edge thickness of the first lenses 101 and 201. Through this, it is possible to set a factor affecting the angle of view of the optical system, and it is possible to set a factor affecting the effective focal length (EFL). Mathematical Expression 1 can preferably satisfy 0.6≤CT1/ET1<1 in the first and second embodiments.

$$0.1 < CT 1 / CA\_L1S1 < 0.5 \qquad [ Mathematical Expression 2 ]$$

In Mathematical Expression 2, CT1 is the center thickness of the first lenses 101 and 201, and CA_LIS1 is the effective diameter (CA_L1S1) of the object-side surface (S1) of the first lenses 101 and 201. When Mathematical Expression 2 is satisfied, the strength and optical properties of the injection-molded lens made of glass can be prevented from being deteriorated. If it is lower than the range of Mathematical Expression 2, the lens may be broken or injection molding may be difficult, and if it is larger than the range, the TTL may increase and the weight of the optical system may become heavier. Mathematical Expression 2 can preferably satisfy 0.15<CT1/CA_L1S1<0.25 in the first embodiment. Mathematical Expression 2 can preferably satisfy 0.2<CT1/CA_L1S1<0.4 in the second embodiment.

$$Po 1 < 0 \qquad [ Mathematical Expression 3 ]$$

In Mathematical Expression 3, Pol represents the sign of the refractive power of the first lenses 101 and 201. It can be set to have a short effective focal length compared to TTL in the optical system for the performance of the optical system. If Mathematical Expression 3 is satisfied, the light incident on the object side to the first lenses 101 and 201 can be spread in a direction away from the optical axis. The entire optical system can have a stable structure that spreads and then gathers the light.

$$F {6}^{*} F 7 < 0 \qquad [ Mathematical Expression 3 - 1 ]$$

In Mathematical Expression 3-1, F6 represents the focal length of the sixth lenses 106 and 206, and F7 represents the focal length of the seventh lenses 107 and 207. Through the condition of Mathematical Expression 3-1, the products of the focal lengths of the plastic lenses can be disposed by mixing negative (−) and positive (+) refractive powers so that they can compensate for each other.

$$1.7 < n 1 < 2.2 \qquad [ Mathematical Expression 4 ]$$

In Mathematical Expression 4, n1 is the refractive index of the d-line of the first lenses 101 and 201. Mathematical Expression 4 sets the refractive index of the first lens high, so that it can control the factor affecting the reduction of the third-order aberration (Seidel aberration) of the optical system, and can reduce aberration that may occur when the TTL becomes somewhat longer. Mathematical Expression 4 can preferably satisfy 1.75<n1<2.1 in the first and second embodiments. If it is designed to be lower than the lower limit of Mathematical Expression 4, it may not be effective in reducing aberration, and the power of the first lens may be weakened so that light cannot be collected efficiently, which may deteriorate the performance of the optical system. If it is designed to be higher than the upper limit of Mathematical Expression 4, there is a disadvantage in that it becomes difficult to obtain materials. In addition, if the refractive index of the first lenses 101 and 201 is designed to be lower than the lower limit of Mathematical Expression 4, the radius of curvature of the first and second lenses 101, 201, 102, and 202 must be increased in order to increase the refractive power of the first and second lenses 101, 201, 102, and 202. In this case, lens manufacturing becomes more difficult, the lens defect rate increases, and the yield may decrease.

$$1.6 \leq A v e r ( n 1 : n 7 ) \leq 1.7 \qquad [ Mathematical Expression 4 - 1 ]$$

In Mathematical Expression 4-1, Aver (n1: n7) is an average of the refractive index values at the d-line of the first to seventh lenses 101 to 107, and 201 to 207. When the optical systems 1000 and 1500 according to the embodiment satisfies Mathematical Expression 4-1, the optical systems 1000 and 1500 can set the resolution and suppress the influence on TTL.

$$27 < FOV\_H < 33 \qquad [ Mathematical Expression 5 ]$$

In Mathematical Expression 5, FOV_H represents a horizontal angle of view, and can set the range of the vehicle optical system. Mathematical Expression 5 preferably satisfies 28≤ FOV_H≤31, or a range of 29.9 degrees+3 degrees in the first and second embodiments, and the sensor length in the horizontal direction at this time is based on 8.064 mm+0.5 mm. In addition, when Mathematical Expression 5 is satisfied, when the temperature changes from room temperature to high temperature, the change rate of the effective focal length and the change rate of the angle of view can be set to 5% or less, for example, 0 to 5%. In addition, even if two or more, for example, three or more, plastic lenses are mixed and used in the optical systems 1000 and 1500, the deterioration of the optical characteristics can be prevented through temperature compensation of the plastic lenses.

$$( First embodiment ) L 3 R 1 > 0 , L 3 R 2 < 0 \qquad [ Mathematical Expression 6 ]$$

$$( Second embodiment ) L 3 R 1 > 0 , L 3 R 2 < 0 , \vert L 3 R 1 \vert = \vert L 3 R 2 \vert$$

In Mathematical Expression 6, L3R1 is the radius of curvature of the object side surface of the third lenses 103 and 203, and L3R2 is the radius of curvature of the sensor side surface of the third lenses 103 and 203. The third lenses 103 and 203 may have a convex shape on both sides. Since the third lenses 103 and 203 have a convex shape on both sides, light can be refracted so that the effective diameters of the fourth to seventh lenses 104, 204, 105, 205, 106, 206, 107, and 207 disposed on the sensor side surface of the third lenses 103 and 203 do not increase, and the number of lenses can be reduced. In the second embodiment, since the condition of |L3R1|=|L3R2| is satisfied, each of the object side surface and the sensor side surface has a convex shape with the same curvature, so that regardless of the direction in which one side or the other side of the third lens 103 is disposed, the same optical characteristics can be obtained, and this can facilitate lens assembly.

$$1 < L7S2\_max \_sag to Sensor < 3 \qquad [ Mathematical Expression 7 ]$$

In Mathematical Expression 7, L7S2_max_sag to Sensor means the straight line distance from the maximum sag value of the seventh lenses 107 and 207 to the image sensor 300. If this is satisfied, the TTL can be reduced, and conditions for manufacturing the camera module can be set. In addition, L7S2_max_sag to Sensor can set a space in which a filter 500 and a cover glass 400 located between the image sensor 300 and the seventh lenses 107 and 207 can be disposed. If the range of Mathematical Expression 7 is smaller than the lower limit, the space for placing circuit structures such as filters and image sensors becomes more restricted, and the process of assembling circuit structures such as filters and image sensors into the optical system may become difficult. If the range of Mathematical Expression 7 is larger than the upper limit, the process of assembling circuit structures such as filters and image sensors into the optical system is easy, but the TTL becomes longer, making it difficult to miniaturize the optical system.

That is, Mathematical Expression 7 can set the minimum distance between the image sensor 300 and the last lens, and preferably satisfies 1<L7S2_max_sag to Sensor≤BFL. In addition, if there is no point P2 where the last lens protrudes further toward the image sensor than the center of the sensor-side, the value of Mathematical Expression 7 can be equal to the back focal length (BFL). BFL is the optical axis distance from the image sensor 300 to the center of the sensor side surface of the last lens. In detail, if 2.5<L7S2_max_sag to Sensor<3.0 is satisfied, the manufacturing convenience and TTL reduction are easier.

$$1 < CT 1 / CT 7 < 3 \qquad [ Mathematical Expression 8 ]$$

In Mathematical Expression 8, CT1 is the center thickness of the first lenses 101 and 201, and CT7 is the center thickness of the seventh lenses 107 and 207. When Mathematical Expression 8 is satisfied, the aberration characteristics can be improved, and the influence on the reduction of the optical system can be set. Mathematical Expression 8 can preferably satisfy 1<CT1/CT7<2 in the first and second embodiments. Mathematical Expression 8 can set the object side lens and the sensor side lens of the optical system to be a glass lens and a plastic lens, and limit the difference in their center thicknesses. Accordingly, the chromatic aberration of the optical system can be improved, good optical performance can be achieved at the set angle of view, and total track length (TTL) can be controlled.

$$1 < CT 45 / CT 6 < 5 \qquad [ Mathematical Expression 9 ]$$

In Mathematical Expression 9, CT45 is the center thickness of the fourth and fifth lenses 104, 204, 105, and 205, for example, the center thickness of the cemented lens 145, and CT6 is the center thickness of the sixth lenses 106 and 206. When the optical system satisfies Mathematical Expression 9, the thicknesses of the cemented lens 145 and the sixth lenses 106 and 206 adjacent thereto can be set to improve the aberration characteristics. Mathematical Expression 9 can preferably satisfy 1<CT45/CT6<3 or 1.5<CT45/CT6<2.5 in the first and second embodiments. CT45 can be greater than the center thickness (CT1-CT7) of each of the first to seventh lenses. Here, the condition of CT45 ΣET45 can be satisfied.

$$0.5 < CT 45 - ET 45 < 1 \qquad [ Mathematical Expression 10 ]$$

In Mathematical Expression 10, CT45 is the center thickness of the fourth and fifth lenses 104, 204, 105, and 205, for example, the center thickness of the cemented lens 145, and ET45 is the optical axis distance from the end of the effective area on the object side surface of the fourth lenses 104 and 204 to the end of the effective area on the sensor side surface of the fifth lenses 105 and 205. When the optical system satisfies Mathematical Expression 10, the center thickness and the edge thickness of the cemented lens can be set to improve the aberration characteristics. Mathematical Expression 10 can preferably satisfy 0.5≤CT45/ET45<0.5 in the first and second embodiments. ET45 can be greater than the edge thickness (ET1-ET7) of each of the first to seventh lenses.

$$0 < CA\_L1S1 / CA\_L4S1 < 2 \qquad [ Mathematical Expression 11 ]$$

In Mathematical Expression 11, CA_LIS1 denotes an effective diameter of the first surface S1 of the first lenses 101 and 201, and CA_L4S1 denotes an effective diameter of the seventh surface S7 of the fourth lenses 104 and 204. When Mathematical Expression 11 is satisfied, the optical systems 1000 and 1500 can control incident light and set factors affecting aberration. Mathematical Expression 11 can preferably satisfy 1<CA_L1S1/CA_L4S1<1.5 in the first embodiment. Mathematical Expression 11 can preferably satisfy 1<CA_L1S1/CA L4S1<1.2 in the second embodiment.

$$0 < CA\_L7S2 / CA\_L5S2 < 2 \qquad [ Mathematical Expression 12 ]$$

In Mathematical Expression 12, CA_L5S2 denotes the effective diameter of the tenth surface S10 of the fifth lenses 105 and 205, and CA_L7S2 denotes the effective diameter of the fourteenth surface S14 of the seventh lenses 107 and 207. When Mathematical Expression 12 is satisfied, the optical systems 1000 and 1500 can control the incident light path and set factors for performance changes according to CRA and temperature. Preferably, Mathematical Expression 12 can satisfy 0.5<CA_L7S2/CA_L5S2<1.5 in the first embodiment. Mathematical Expression 12 can satisfy 0.5<CA_L7S2/CA_L5S2<1 in the second embodiment.

$$0 < CA\_LIS2 / CA\_L2S1 < 2 \qquad [ Mathematical Expression 13 ]$$

In Mathematical Expression 13, CA_L1S2 denotes an effective diameter of the second surface S2 of the first lenses 101 and 201, and CA_L2S1 denotes an effective diameter of the third surface S3 of the second lenses 102 and 202. When Mathematical Expression 13 is satisfied, the optical systems 1000 and 1500 can control light traveling to the first lens group LG1 and the second lens group LG2, and can set a factor affecting a decrease in lens sensitivity. Mathematical Expression 15 can preferably satisfy 1<CA_L1S2/CA_L2S1<1.5 in the first embodiment. Mathematical Expression 15 can preferably satisfy 0.5<CA_L1S2/CA_L2S1<1.2 in the second embodiment.

$$0.5 < CA\_L4S1 / CA\_L5S2 < 2.5 \qquad [ Mathematical Expression 14 ]$$

In Mathematical Expression 14, CA_L4S1 denotes the effective diameter of the seventh surface S7 of the fourth lenses 104 and 204, and CA_L5S2 denotes the effective diameter of the tenth surface S10 of the fifth lenses 105 and 205. When the optical systems 1000 and 1500 satisfy Mathematical Expression 14, the size of the cemented lens can be set. Mathematical Expression 14 can preferably satisfy 0.8≤CA_L4S1/CA_L5S2<1.5 in the first embodiment. Mathematical Expression 14 can preferably satisfy 1≤CA_LAS1/CA_L5S2<1.5 in the second embodiment.

$$2 < L 3 R 1 / ( CA\_L3S1 / 2 ) < 5 \qquad [ Mathematical Expression 15 ]$$

In Mathematical Expression 15, L3R1 represents the radius of curvature of the object-side surface of the third lenses 103 and 203, and CA_L3S1 represents the effective diameter of the object side fifth surface S5 of the third lenses 103 and 203. If the biconvex third lenses 103 and 203 satisfy Mathematical Expression 15, the optical systems 1000 and 1500 can improve chromatic aberration. If it is smaller than the lower limit value of Mathematical Expression 15, the occurrence of aberration by the fifth surface S5 increases, and if it is larger than the upper limit value, the occurrence of aberration of the fifth surface S5 decreases, but since the radius of curvature of the sixth surface S6 must be smaller, the occurrence of aberration increases at the sixth surface S6, which causes a problem of affecting the aberration of the fourth to seventh lenses 104, 204 to 107, and 207. Preferably, in the first embodiment, the range of 2<L3R1/(CA_L3S1/2)<4 can be satisfied. Preferably, in the second embodiment, the range of 3<L3R1/(CA_L3S1/2)<4 can be satisfied. Since the radius of curvature of the sixth surface S6 can be designed to be large while reducing the aberration occurring in the fifth surface S5, it is easy to manufacture the third lenses 103 and 203. The aberration occurring in the optical system can be reduced, the manufacture of the third lenses 103 and 203 can be made easier, and the yield can be increased.

$$CA\_L4 > CA\_L5 > CA\_L6 > CA\_L7 \qquad [ Mathematical Expression 15 - 1 ]$$

$$CA\_L7S1 < ( ImgH * 2 ) \qquad [ Mathematical Expression 15 - 2 ]$$

In Mathematical Expressions 15-1 to 15-2, CA_L4, CA_L5, CA_L6, and CA_L7 are effective diameters (average effective diameters) of the fourth to seventh lenses 104, 204 to 107, and 207, and ImgH is half of the diagonal length of the image sensor 300. Accordingly, the light path can be set to the area of the image sensor 300 by the effective diameters of the fourth lenses 104 and 204 to the seventh lenses 107 and 207. Since the fourth and fifth lenses 104, 204, 105, and 205 and the seventh lenses 107 and 207 are plastic lenses having aspherical surfaces, and the sixth lenses 106 and 206 is a glass lens having a spherical surface, aberrations between the lenses can be mutually compensated.

$$1 < CA\_GL \_AVER / CA\_PL \_AVER < 15 \qquad [ Mathematical Expression 16 ]$$

In Mathematical Expression 16, CA_GL_AVER represents the average effective diameter of glass lenses, and CA_PL_AVER represents the average effective diameter of plastic lenses. By setting the effective diameter size of the glass lens and the effective diameter size of the plastic lens in Mathematical Expression 16, the path of incident light can be effectively guided. Mathematical Expression 16 can preferably satisfy 1<CA_GL_AVER/CA_PL_AVER<1.3 in the first and second embodiments.

Here, nGL>nPL can be satisfied. nGL is the number of glass lenses, and nPL is the number of plastic lenses. Also, the condition of nGL-nPL=0 or 1 can be satisfied.

$$12 \leq GL\_CA1 \_AVER / PL\_CA1 \_AVER \leq 2 \qquad [ Mathematical Expression 17 ]$$

In Mathematical Expression 17, GL_CA1_AVER is an average of the effective diameters of the object side surfaces of the lenses made of glass, for example, it is an average of the effective diameters of the object side surfaces of the first, second, third, and sixth lenses 101, 201, 102, 202, 103, 203, 106, and 206. PL_CA1_AVER is an average of the effective diameters of the object side surfaces of the lenses made of plastic, for example, it is an average of the effective diameters of the object side surfaces of the fourth, fifth, and seventh lenses 104, 204, 105, 205, 107, and 207. Since the effective diameter size of the plastic lens is designed to be relatively small compared to that of the glass lens, Mathematical Expression 17 can be satisfied. Mathematical Expression 17 can preferably satisfy 1.3≤GL_CA1_AVER/PL_CA1_AVER≤1.8 in the first and second embodiments.

$$CG 3 < CG 5 < C G 1 \qquad [ Mathematical Expression 18 ]$$

In Mathematical Expression 18, CG1 may be the center gap between the first and second lenses 101, 201, 102, and 202, CG3 may be the center gap between the third and fourth lenses 103, 203, 104, and 204, and CG5 may be the center gap between the fifth and sixth lenses 105, 205, 106, and 206. When Mathematical Expression 18 is satisfied, the center gap between glass lenses having relatively thick thicknesses can be reduced, thereby reducing the TTL and improving the optical performance in the edge portion of the field of view (FOV).

$$1 < CT 7 / CG 6 < 3 \qquad [ Mathematical Expression 19 ]$$

In Mathematical Expression 19, CG6 is the center gap or the optical axis distance between the sixth and seventh lenses 106, 206, 107, and 207. By setting the center thickness (CT7) of the seventh lenses 107 and 207 and the center gap between the sixth and seventh lenses in Mathematical Expression 19, the optical performance in the edge portion of the angle of view can be improved. Mathematical Expression 19 can preferably satisfy 1.1<CT7/CG6<1.5 in the first embodiment. Mathematical Expression 19 can preferably satisfy 2<CT7/CG6<2.5 in the second embodiment.

$$5 < \vert F 6 / F 5 \vert < 10 \qquad [ Mathematical Expression 20 - 1 ]$$

In Mathematical Expression 20-1, F5 is the focal length of the fifth lens 105, and F6 is the focal length of the sixth lens 106. In Mathematical Expression 20-1, the relationship between the focal lengths of the fifth lens 105 and the sixth lens 106 can be set. The absolute value of the focal length of the sixth lens 106 being disposed on the sensor side with respect to the cemented lens 145 in the optical system 1000, is formed to be the largest, and the absolute value of the focal length of the fifth lens 105 being disposed on the sensor side of the cemented lens 145, is formed to be the smallest. Through this, the incidence efficiency can be increased, and the refractive power of the optical system can be adjusted to guide it to the image sensor 300. In the first embodiment, Mathematical Expression 20-1 can preferably satisfy 6<|F6/F5|<9.

$$2 ( CG 5 + CG 6 ) < CT 45 \qquad [ Mathematical Expression 20 - 2 ]$$

In Mathematical Expression 20-2, CT45 is the center thickness of the cemented lens 245. By arranging the center thickness of the cemented lens to be greater than twice the sum of the center gap between the fifth and sixth lenses (CG5) and the center gap between the sixth and seventh lenses (CG6), the resolution and chromatic aberration can be improved and the center gaps can be reduced.

$$1 < CT 1 / CT 2 < 2 \qquad [ Mathematical Expression 21 ]$$

In Mathematical Expression 21, CT1 is the center thickness of the first lenses 101 and 201, and CT2 is the center thickness of the second lenses 102 and 202. By setting the center thickness (CT1) of the first lens to be thicker than the center thickness (CT2) of the second lens in Mathematical Expression 21, factors affecting aberration can be controlled. Preferably, in the first and second embodiments, Mathematical Expression 21 can satisfy 1<CT1/CT2<1.5.

$$1 < L 7 R 1 / CT 7 < 200 \qquad [ Mathematical Expression 22 ]$$

In Mathematical Expression 22, L7R1 is the radius of curvature of the 13th surface (S13) of the seventh lenses 107 and 207, and CT7 is the center thickness of the seventh lenses 107 and 207. By setting the radius of curvature (L7R1) of the object side surface of the seventh lenses 107 and 207 and the center thicknesses of the seventh lenses 107 and 207 in Mathematical Expression 22, the refractive power of the seventh lenses 107 and 207 can be controlled. Accordingly, good optical performance can be achieved in the center portion and the edge portion of the angle of view. Preferably, Mathematical Expression 22 can satisfy 180<L7R1/CT7<200 in the first embodiment. Preferably, Mathematical Expression 22 can satisfy 5<L7R1/CT7<10 in the second embodiment.

$$0 < CT\_Max / CG\_Max < 5 \qquad [ Mathematical Expression 23 ]$$

In Mathematical Expression 23, CT_Max is the maximum center thickness among the lenses, and CG_Max is the maximum gap between adjacent lenses. When Mathematical Expression 23 is satisfied, the optical system can have good optical performance at a focal length at a set angle of view, and can reduce TTL. Mathematical Expression 23 can preferably satisfy 0.1<CT_Max/CG_Max<0.5 in the first embodiment. Mathematical Expression 23 can preferably satisfy 2<CT_Max/CG_Max<4 in the second embodiment.

$$1 < Σ CT / Σ CG < 7 \qquad [ Mathematical Expression 24 ]$$

In Mathematical Expression 24, ECT is the sum of the central thicknesses of the lenses, and ECG is the sum of the gaps between adjacent lenses. When Mathematical Expression 24 is satisfied, the optical system can have good optical performance at a focal length at a set angle of view, and can reduce the TTL. Mathematical Expression 24 can preferably satisfy 1<ΣCT/2CG<1.5 in the first embodiment. Mathematical Expression 24 can preferably satisfy 5<ΣCT/2CG<7 in the second embodiment.

$$10 < Σ Index < 20 \qquad [ Mathematical Expression 25 ]$$

In Mathematical Expression 25, EIndex means the sum of refractive indices at the d-line of each of the plurality of lenses. When Mathematical Expression 25 is satisfied, TTL can be controlled in the optical systems 1000 and 1500 in which plastic lenses and glass lenses are mixed, and improved resolution can be achieved. In addition, when the number of glass lenses is greater than the number of plastic lenses, and when the number of glass lenses having a relatively thick thickness is greater, the sum of TTL and refractive indices can be set. Mathematical Expression 25 can preferably satisfy 10<ΣIndex<15 in the first and second embodiments.

$$10 < Σ Abb / Σ Index < 35 \qquad [ Mathematical Expression 26 ]$$

In Mathematical Expression 26, ΣAbb represents the sum of Abbe's numbers of each of the plurality of lenses. When Mathematical Expression 26 is satisfied, the optical systems 1000 and 1500 can have improved aberration characteristics and resolution. Mathematical Expression 26 can control the optical characteristics by setting the sum of Abbe's numbers and the sum of refractive indices of the lenses. Mathematical Expression 26 can preferably satisfy 20<ΣAbb/ΣIndex<30 in the first and second embodiments.

$$1 < Σ CT / Σ ET < 2 \qquad [ Mathematical Expression 27 ]$$

In Mathematical Expression 27, ECT is the sum of the center thicknesses of the lenses, and EET is the sum of the edge thicknesses, that is, the ends of the effective areas of the lenses. When Mathematical Expression 27 is satisfied, the optical system can have good optical performance at the focal length at the set angle of view, and can reduce the TTL. Mathematical Expression 27 can preferably satisfy 1<ΣCT/ΣET<1.5 in the first and second embodiments.

$$1 < CA\_L3S1 / CA\_min < 2 \qquad [ Mathematical Expression 28 ]$$

In Mathematical Expression 28, CA_L3S1 is the effective diameter of the object side fifth surface S5 of the third lenses 103 and 203, and CA_Min represents the minimum effective diameter among the object side surfaces and the sensor side surfaces of the lenses. When Mathematical Expression 28 is satisfied, the optical system can provide a slimmer module while controlling incident light and maintaining optical performance. Mathematical Expression 28 can preferably satisfy 1.5<CA_L2S1/CA_min<2 in the first embodiment. Mathematical Expression 28 can preferably satisfy 1<CA_L2S1/CA_min<1.5 in the second embodiment.

$$1 < CA\_max / CA\_min < 3 \qquad [ Mathematical Expression 29 ]$$

In Mathematical Expression 29, CA_max represents a maximum effective diameter among the object side surfaces and the sensor side surfaces of the lenses, and CA_Min represents a minimum effective diameter among the object side surfaces and the sensor side surfaces of the lenses. When Mathematical Expression 29 is satisfied, the optical system can set a size for a slim and compact structure while maintaining optical performance. Mathematical Expression 29 can preferably satisfy 1<CA_max/CA_min<2.5 in the first embodiment. Mathematical Expression 29 can preferably satisfy 1<CA_max/CA_min<2 in the second embodiment.

$$1 < CA\_max / CA\_Aver < 3 \qquad [ Mathematical Expression 30 ]$$

In Mathematical Expression 30, CA_max represents the maximum effective diameter among the object side surfaces and the sensor side surfaces of the lenses, and CA_Aver represents the average of the effective diameters of the object side surfaces and the sensor side surfaces of the lenses. When Mathematical Expression 30 is satisfied, the optical system can set a size for a slim and compact structure while maintaining optical performance. Mathematical Expression 30 can preferably satisfy 1<CA_max/CA_Aver<1.5 in the first and second embodiments.

$$0.5 < CA\_min / CA\_Aver < 1 \qquad [ Mathematical Expression 31 ]$$

In Mathematical Expression 31, CA_Min represents a minimum effective diameter among the object side surfaces and the sensor side surfaces of the lenses, and CA_Aver represents an average of the effective diameters of the object side surfaces and the sensor side surfaces of the lenses. When Mathematical Expression 31 is satisfied, the optical system can set a size for a slim and compact structure while maintaining optical performance. Mathematical Expression 31 can preferably satisfy 0.5<CA_min/CA_Aver<0.8 in the first and second embodiments.

$$1 < CA\_max / ( 2 * ImgH ) < 3 \qquad [ Mathematical Expression 32 ]$$

Mathematical Expression 32, CA_max represents the maximum effective diameter among the object side surfaces and the sensor side surfaces of the lenses, and ImgH represents the diagonal length from the optical axis of the image sensor 300. When Mathematical Expression 32 is satisfied, the optical system can maintain good optical performance and set a size for a slim and compact structure. Mathematical Expression 32 can preferably satisfy 1<CA_max/(2*ImgH)<2 in the first and second embodiments.

$$1 < TD / CA\_max < 4 \qquad [ Mathematical Expression 33 ]$$

In Mathematical Expression 33, TD is the optical axis distance from the center of the object-side surface of the first lenses 101 and 201 to the center of the sensor-side surface of the last lens, and CA_max represents the maximum effective diameter among the object side surfaces and the sensor side surfaces of the lenses. When Mathematical Expression 33 is satisfied, the total optical axis distance and the maximum effective diameter of the lenses can be set, so that the size for good optical performance can be set. Mathematical Expression 33 can preferably satisfy 2<TD/CA_max<3 in the first and second embodiments.

$$0 < F / L 1 R 1 < 1 \qquad [ Mathematical Expression 34 ]$$

In Mathematical Expression 34, F is the effective focal length of the optical system, and LIR1 is the radius of curvature of the object-side surface of the first lenses 101 and 201. When Mathematical Expression 34 is satisfied, the influence on the incident light and the TTL can be controlled. Mathematical Expression 34 can preferably satisfy 0.5≤F/LIR1<1 in the first and second embodiments.

$$1 < Max\_th / Min\_th < 3 \qquad [ Mathematical Expression 35 ]$$

In Mathematical Expression 35, Max_th is the thickness of the thickest region of the lens, and Min_th is the thickness of the thinnest region of the lens. The thickest thickness of the lens, Max_th, may be the center thickness (CT) of the lens, and Min_th, the thinnest thickness of the lens, may be the edge thickness (ET) of the lens, but the opposite case is also possible. The thickest thickness of the lens, Max_th, may be the edge thickness (ET) of the lens, and Min_th, the thinnest thickness of the lens, may be the center thickness (CT) of the lens. The edge thickness (ET) refers to the thickness at the end of the effective diameter. When Mathematical Expression 35 is satisfied, the optical system can control the influence on the effective focal length. Mathematical Expression 35 can preferably satisfy the condition of 1<MAX_th/MIN_th≤2 in the first embodiment. Mathematical Expression 35 can preferably satisfy the condition of 2<MAX_th/MIN_th≤3 in the second embodiment.

Here, the ratio of the maximum thickness and the minimum thickness of the plastic lens can satisfy the following conditions. Max_PL_th is the thickness value of the thickest area of the plastic lens, and Min_PL_th is the thickness value of the thinnest area of the plastic lens. Max_PL_th can be the center thickness (CT) of the plastic lens, and Min_PL_th can be the edge thickness (ET) of the plastic lens. The edge thickness (ET) means the thickness at the end of the effective diameter. The opposite case is also possible. Max_PL_th can be the edge thickness (ET) of the plastic lens, and Min_PL_th can be the center thickness (CT) of the plastic lens. The edge thickness (ET) means the thickness at the end of the effective diameter.

Condition 1:1<Max_PL_th/Min_PL_th<2.5

If it is less than the lower limit value of the range of Condition 1, it is difficult to manufacture a plastic lens. That is, it is manufactured by injecting high temperature resin and curing it at a low temperature, but if the thickness difference is large, the shrinkage will not be uniform as the lens cools at a low temperature, which may result in a high surface defect rate. In addition, if it is greater than the range of Condition 1, the plastic lens shrinks and expands as the temperature changes from −40 degrees to 105 and 205 degrees, and during this process, the rate of change in the lens shape appears large, which may deteriorate the optical performance.

Preferably, the conditions 1.0<Max_PL_th/Min_PL_th<1.8 and 1.0<Max_PL_th/Min_PL_th<1.5 can be satisfied.

$$0 < EPD / \vert L 1 R 1 \vert < 1 \qquad [ Mathematical Expression 36 ]$$

In Mathematical Expression 36, EPD represents the size (mm) of the entrance pupil of the optical systems 1000 and 1500, and LIR1 represents the radius of curvature of the first surface S1 of the first lenses 101 and 201. When the optical systems 1000 and 1500 according to the embodiment satisfy Mathematical Expression 36, the optical systems 1000 and 1500 can control incident light. Mathematical Expression 36 can preferably satisfy the condition of 0.3<EPD/ILIR1|≤0.9 in the first and second embodiments.

$$Po 4 * Po 5 < 0 \qquad [ Mathematical Expression 37 ]$$

In Mathematical Expression 37, Po4 is the refractive power value of the fourth lenses 104 and 204, and Po5 is the refractive power value of the fifth lenses 105 and 205. That is, the refractive powers of the fourth and fifth lenses 104, 204, 105, and 205 have opposite refractive powers, so that aberration can be improved and light can be effectively guided to the image sensor. When the condition of Po4*Po5>0, the effect of improving chromatic aberration in the cemented lens does not appear significantly.

$$30 < v 4 - v 5 < 40 \qquad [ Mathematical Expression 38 ]$$

In Mathematical Expression 38, v4 is the Abbe number of the fourth lenses 104 and 204, and V5 is the Abbe number of the fifth lenses 105 and 205. When Mathematical Expression 38 is satisfied, the Abbe number difference of at least two lenses forming the cemented lens can be maintained at a certain value or more, and chromatic aberration can be improved. Mathematical Expression 38 can preferably satisfy 30≤v4-v5≤35 in the first and second embodiments. When the cemented lens is less than the lower limit value of Mathematical Expression 38, the improvement in the aberration characteristic of the optical system may be minimal. Accordingly, when the Abbe number difference between the object side lens and the sensor side lens in the cemented lens is 30 or more and 35 or less, the aberration characteristic can be improved.

$$0 < \vert F 1 \vert / F < 10 \qquad [ Mathematical Expression 39 ]$$

Mathematical Expression 39 is where F is the effective focal length of the optical system and F1 is the focal length of the first lenses 101 and 201. When Mathematical Expression 39 is satisfied, TTL applied to the vehicle optical system can be set. Mathematical Expression 39 can preferably satisfy 1<|F1|/F<7 in the first and second embodiments.

$$F\_LG1 / F\_LG2 < 0 \qquad [ Mathematical Expression 40 ]$$

In Mathematical Expression 40, F_LG1 is the focal length of the first lens group LG1, and F_LG2 is the focal length of the second lens group (F_LG2). The focal length of the first lens group can have a negative value, and the focal length of the second lens group can have a positive value. When Mathematical Expression 40 is satisfied, the optical systems 1000 and 1500 can improve aberration characteristics such as chromatic aberration and distortion aberration. Mathematical Expression 40 can preferably satisfy 5<|F_LG1/F_LG2|<8 in the first embodiment. Mathematical Expression 40 can preferably satisfy 8<|F_LG1/F_LG2|<12 in the second embodiment.

$$0.1 < nGL / nPL < 2 \qquad [ Mathematical Expression 41 ]$$

In Mathematical Expression 41, nGL represents the number of glass lenses, and nPL represents the number of plastic lenses. By arranging the number of glass lenses in Mathematical Expression 41 to be more than 1 time and less than 2 times the number of plastic lenses, the thickness of the optical system can be reduced, and a wider range of refractive powers can be provided through the aspherical surface. Mathematical Expression 41 can preferably satisfy 1<nGL/nPL<1.5 in the first embodiment. Mathematical Expression 41 can preferably satisfy 0.1<nGL/nPL<1 in the second embodiment.

$$CA\_L 7 \leq CA\_L3 < CA\_L1 \qquad [ Mathematical Expression 42 ]$$

In Mathematical Expression 42, CA_L1 is the average effective diameter of the object-side surface and the sensor side surface of the first lenses 101 and 201, CA_L3 is the average effective diameter of the object side surface and the sensor side surface of the third lenses 103 and 203, and CA_L7 is the average effective diameter of the object side surface and the sensor side surface of the seventh lenses 107 and 207. When Mathematical Expression 42 is satisfied, the first and second lens groups can be set and aberration can be improved through the first lens of the second lens group LG2. CA_L1 can have the maximum effective diameter in the optical system.

$$0 < ΣPL\_CT / ΣGL\_CT < 1 \qquad [ Mathematical Expression 43 ]$$

In Mathematical Expression 43, ΣPL_CT is the sum of the central thicknesses of the plastic lens (or lenses), and ΣGL_CT is the sum of the central thicknesses of the glass lenses. When Mathematical Expression 43 is satisfied, the overall TTL can be controlled by setting the thickness relationship of the plastic lens and the glass lens with respect to the TTL. Mathematical Expression 43 can preferably satisfy 0.3<ΣPL_CT/EGL CT<0.8 in the first embodiment. Mathematical Expression 43 can preferably satisfy 0.5<ΣPL_CT/ΣGL_CT<1 in the second embodiment.

$$0 < ΣPL\_Index / ΣGL\_Index < 2 \qquad [ Mathematical Expression 44 ]$$

In Mathematical Expression 44, EPL_Index is the sum of the refractive indices of the plastic lens (or lenses) at the d-line, and ΣGL_Index is the sum of the refractive indices of the glass lenses at the d-line. When Mathematical Expression 44 is satisfied, the refractive index relationship between the plastic lens and the glass lens can be set to control the overall resolution. Mathematical Expression 44 can preferably satisfy 0.5<ΣPL_Index/ΣGL_Index<1 in the first embodiment. Mathematical Expression 44 can preferably satisfy 1<ΣPL_Index/ΣGL_Index<1.5 in the second embodiment.

$$10 < TTL < 45 \qquad [ Mathematical Expression 45 ]$$

In Mathematical Expression 45, total track length (TTL) means the distance (mm) from the center of the first surface S1 of the first lenses 101 and 201 to the upper surface of the image sensor 300 on the optical axis OA. By making TTL in Mathematical Expression 45 exceed 10 or 20, a vehicle optical system can be provided. Mathematical Expression 45 can preferably satisfy the condition of 30<TTL≤40 or TD<TTL in the first and second embodiments.

$$2 < ImgH < 10 \qquad [ Mathematical Expression 46 ]$$

Mathematical Expression 46 can set the diagonal size (2*ImgH) of the image sensor 300 and provide an optical system having a vehicle sensor size. Mathematical Expression 46 can preferably satisfy 4≤ImgH<6 in the first and second embodiments.

$$1 < BFL < 3.5 \qquad [ Mathematical Expression 47 ]$$

In Mathematical Expression 47, BFL is the optical axis distance from the image sensor 300 to the center of the sensor side of the last lens. When Mathematical Expression 47 is satisfied, the installation space of the filter 500 and the cover glass 400 can be secured, the assembling property of the components can be improved through the gap between the image sensor 300 and the last lens, and the joining reliability can be improved. Mathematical Expression 47 can preferably satisfy 1.5≤BFL≤3 in the first and second embodiments. When the BFL is less than the range of Mathematical Expression 47, some of the light traveling to the image sensor may not be transferred to the image sensor, which may cause a decrease in resolution. When the BFL exceeds the range of Mathematical Expression 47, stray light may be introduced, which may deteriorate the aberration characteristics of the optical system.

$$3 < F < 40 \qquad [ Mathematical Expression 48 ]$$

Mathematical Expression 48 can set the overall focal length (F) to suit the vehicle optical system. Mathematical Expression 48 can preferably satisfy 5<F<20 in the first and second embodiments.

$$FOV < 45 \qquad [ Mathematical Expression 49 ]$$

In Mathematical Expression 49, field of view (FOV) means the angle of view (degree) of the optical systems 1000 and 1500, and can provide a vehicle optical system of less than 45 degrees. In the first and second embodiments, FOV can preferably satisfy 20≤FOV≤40.

$$1 < TTL / CA\_max < 5 \qquad [ Mathematical Expression 50 ]$$

In Mathematical Expression 50, CA_max means the largest effective diameter (mm) among the object side surfaces and the sensor side surfaces of a plurality of lenses, and total track length (TTL) means the distance (mm) from the vertex of the first surface S1 of the first lenses 101 and 201 to the upper surface of the image sensor 300 on the optical axis OA. Mathematical Expression 50 sets the relationship between the total optical axis length of the optical system and the maximum effective diameter, so as to provide an improved vehicle optical system. Mathematical Expression 50 can preferably satisfy 1.5<TTL/CA_max≤3 in the first and second embodiments.

$$2 < TTL / ImgH < 10 \qquad [ Mathematical Expression 51 ]$$

Mathematical Expression 51, total track length (TTL) means the distance (mm) from the vertex of the first surface S1 of the first lens to the upper surface of the image sensor 300 on the optical axis OA, and ImgH means the diagonal size of the image sensor 300. When Mathematical Expression 51 is satisfied, the optical systems 1000 and 1500 can have TTL for application to the vehicle image sensor 300, thereby providing further improved image quality. Mathematical Expression 51 can preferably satisfy 4<TTL/ImgH<10 in the first and second embodiments.

$$0.1 < BFL / ImgH < 1 \qquad [ Mathematical Expression 52 ]$$

In Mathematical Expression 52, BFL is the optical axis distance from the image sensor 300 to the center of the sensor side surface of the last lens, and ImgH means the diagonal size of the image sensor 300. When Mathematical Expression 52 is satisfied, the optical systems 1000 and 1500 can secure back focal length (BFL) for applying the size of the vehicle image sensor 300, set the gap between the last lens and the image sensor 300, and have good optical characteristics in the center portion and edge portion of the field of view (FOV). Mathematical Expression 52 can preferably satisfy 0.2<BFL/ImgH<0.8 in the first and second embodiments.

$$5 < TTL / BFL < 20 \qquad [ Mathematical Expression 53 ]$$

Mathematical Expression 53, total track length (TTL) means the distance (mm) from the vertex of the first surface S1 of the first lens to the upper surface of the image sensor 300 on the optical axis OA, and BFL means the optical axis distance from the image sensor 300 to the center of the sensor side surface of the last lens. When Mathematical Expression 53 is satisfied, the optical systems 1000 and 1500 can secure BFL. Mathematical Expression 53 can preferably satisfy 10<TTL/BFL<15 in the first and second embodiments.

$$1 < TTL / F < 3 \qquad [ Mathematical Expression 54 ]$$

Mathematical Expression 54, total track length (TTL) means the distance (mm) from the vertex of the first surface S1 of the first lens to the upper surface of the image sensor 300 on the optical axis OA, and F is the effective focal length of the optical system. Accordingly, an optical system for a driver assistance system can be provided. Mathematical Expression 54 can preferably satisfy 1.5≤TTL/F≤2.8 or 2≤TTL/F≤2.8 in the first and second embodiments. When the optical system (1000, 1500) according to the embodiment satisfies Mathematical Expression 54, the optical systems 1000 and 1500 can have an appropriate focal length in a set TTL range, and provides an optical system that can form an image while maintaining an appropriate focal length even when the temperature changes from low temperature to high temperature. If it is below the lower limit of Mathematical Expression 54, the refractive power of the lenses needs to be increased, making it difficult to correct spherical aberration or distortion aberration. If it is above the upper limit of Mathematical Expression 54, the effective diameter or TTL of the lenses becomes longer, which may cause the problem of the imaging lens system becoming larger.

$$3 < F / BFL < 10 \qquad [ Mathematical Expression 55 ]$$

Mathematical Expression 55 is a method in which F is an effective focal length of the optical system and BFL means an optical axis distance from the image sensor 300 to the center of the sensor side of the last lens. When Mathematical Expression 55 is satisfied, the optical systems 1000 and 1500 can have a set angle of view and an appropriate focal length, and a vehicle optical system can be provided. In addition, the optical systems 1000 and 1500 can minimize the gap between the last lens and the image sensor 300, and thus can have good optical characteristics at the edge portion of the field of view (FOV). Mathematical Expression 55 can preferably satisfy 3<F/BFL<6 in the first and second embodiments.

$$1 < F / ImgH < 5 \qquad [ Mathematical Expression 56 ]$$

Mathematical Expression 56 is an optical system in which F is an effective focal length and ImgH represents a diagonal size of an image sensor 300. Such optical systems 1000 and 1500 can have improved aberration characteristics in the size of a vehicle image sensor 300. Mathematical Expression 56 can preferably satisfy 2<F/ImgH<4 in the first and second embodiments.

$$1 < F / EPD < 5 \qquad [ Mathematical Expression 57 ]$$

Mathematical Expression 57 is where F is the effective focal length of the optical system and EPD represents the size of the entrance pupil. Accordingly, the overall brightness of the optical system can be controlled. In the first and second embodiments, Mathematical Expression 57 can preferably set 1<F/EPD<2.

$$0 < BFL / TD < 0.3 \qquad [ Mathematical Expression 58 ]$$

Mathematical Expression 58, where TD is the optical axis distance of the lenses of the optical systems 1000 and 1500 and BFL is the optical axis distance from the image sensor 300 to the center of the sensor side of the last lens. Accordingly, the resolution of the optical system can be maintained while controlling the overall size. Mathematical Expression 58 can preferably satisfy 0<BFL/TD<0.1 in the first and second embodiments. When the condition value of BFL/TD is 0.1 or more, the BFL is designed to be large compared to the TD, so that the size of the entire optical system becomes large, making it difficult to miniaturize the optical system, and the distance between the seventh lenses 107 and 207 and the image sensor becomes long, so that an unnecessary amount of light may increase between the seventh lenses 107 and 207 and the image sensor, which causes a problem of lowering the resolution such as deterioration of aberration characteristics.

$$0 < EPD / ImgH / FOV < 0.2 \qquad [ Mathematical Expression 59 ]$$

Mathematical Expression 59 can set the relationship between the entrance pupil size (EPD), the length of half the maximum diagonal length of the image sensor (ImgH), and the angle of view. Accordingly, the overall size and brightness of the optical system can be controlled. Mathematical Expression 59 can preferably satisfy 0<EPD/ImgH/FOV<0.1 in the first and second embodiments.

$$5 < FOV / F \# < 30 \qquad [ Mathematical Expression 60 ]$$

Mathematical Expression 60 can set the relationship between the angle of view and the F number (F #) of the optical system. Mathematical Expression 60 can preferably satisfy 10<FOV/F #<25 in the first and second embodiments. Here, F #is provided to be 1.6 or less, so as to provide a bright image.

$$0.2 < CG 1 / TTL < 0.6 \qquad [ Mathematical Expression 61 ]$$

In Mathematical Expression 61, CG1 means the optical axis gap between the first lens 101 and the second lens 102, and total track length (TTL) means the distance (mm) from the vertex of the first surface S1 of the first lens to the upper surface of the image sensor 300 on the optical axis OA. Among the gaps between lenses spaced apart in the optical system 1000, the gap between the first lens 101 and the second lens 102 may be the largest. When the optical system 1000 satisfies Mathematical Expression 61 and increases the gap between the first lens 101 and the second lens 102, the radius of curvature of the first lens 101 is increased, making lens manufacturing easy, while also having the effect of correcting chromatic aberration. In the first embodiment, Mathematical Expression 61 may preferably satisfy 0.3<CG1/TTL<0.5.

$$5 < \vert F 2 / F 5 \vert < 10 \qquad [ Mathematical Expression 62 ]$$

In Mathematical Expression 62, F2 is the focal length of the second lens 202, and F5 is the focal length of the fifth lens 205. In Mathematical Expression 62, the relationship between the focal lengths of the second lens 202 and the fifth lens 205 can be set. In the optical system 1500, the absolute value of the focal length of the second lens 202 made of glass is formed to be the largest, and the absolute value of the focal length of the fifth lens 205 made of plastic is formed to be the smallest, thereby increasing the incidence efficiency and controlling the refractive power between the lenses made of glass and plastic to guide them to the image sensor 300. In the second embodiment, Mathematical Expression 62 preferably satisfies 5<|F2/F5|<8.

$$2 < \vert F 2 / F 3 \vert < 10 \qquad [ Mathematical Expression 63 ]$$

In Mathematical Expression 63, F2 is the focal length of the second lens 202, and F3 is the focal length of the third lens 203. The absolute value of the focal length of the second lens 202 made of glass within the optical system 1500 is formed to be the largest, and the absolute value of the focal length of the third lens 203 made of glass within the optical system 1500 other than the cemented lens 245 is formed to be the smallest, thereby increasing the incidence efficiency and controlling the refractive power between the lenses made of glass and plastic to guide them to the image sensor 300. Mathematical Expression 63 can preferably satisfy 2<|F2/F3|<5 in the second embodiment.

$$0.05 < \vert sag\_i / ( CA\_i / 2 ) \vert < 0.2 \qquad [ Mathematical Expression 64 ]$$

$$( i = S 1 , S 2 , S 3 , S 4 )$$

Mathematical Expression 64 can set the relationship between the sag values of the first to fourth surfaces S1, S2, S3, and S4 of the first and second lenses 101, 201, 102, and 202 and the effective diameter (CA), and if it is satisfied, the refractive power of the lenses can be improved. Here, if Mathematical Expression 64 further satisfies the condition of n1>1.7, it is possible for the first and second lenses to gather light with sufficient power even if the radius of curvature of the first and second lenses 101, 201, 102, and 202 is not designed sharply within the effective diameter.

$$Z = \frac{c {Y}^{2}}{1 + \sqrt{1 - ( 1 - K ) {c}^{2} {Y}^{2}}} + {AY}^{4} + {BY}^{6} + {CY}^{8} + {DY}^{10} + {EY}^{12} + {FY}^{14} + … \qquad [ Mathematical Expression 65 ]$$

In Mathematical Expression 65, Z can represent sag, which means the distance from any location on the aspheric surface to the vertex of the aspheric surface along the optical axis. Y can represent the distance from any location on the aspheric surface to the optical axis in the direction perpendicular to the optical axis. c can represent the curvature of the lens, and K can represent the conic constant. In addition, A, B, C, D, E, and F can represent aspheric constants.

The optical systems 1000 and 1500 according to the first and second embodiments can satisfy at least one or more of Mathematical Expressions 1 to 64. In this case, the optical systems 1000 and 1500 can have improved optical characteristics. In detail, when the optical systems 1000 and 1500 satisfy at least one or more of Mathematical Expressions 1 to 64, the optical systems 1000 and 1500 can have improved resolution and improve aberration and distortion characteristics. In addition, the optical systems 1000 and 1500 can secure a back focal length (BFL) for applying a vehicle image sensor 300, can compensate for optical characteristic degradation due to temperature change, and can minimize the gap between the last lens and the image sensor 300, thereby having good optical performance in the center portion and edge portion of the field of view (FOV).

Table 5 shows the result values for Mathematical Expression 1 to Mathematical Expression 64 described above in the optical systems 1000 and 1500 of the embodiment. Referring to Table 5, it can be seen that the optical systems 1000 and 1500 satisfy at least one, two or more, or three or more of Mathematical Expression 1 to Mathematical Expression 64. In detail, it can be seen that the optical systems 1000 and 1500 according to the embodiments satisfy all of Mathematical Expression 1 to Mathematical Expression 64. Accordingly, the optical systems 1000 and 1500 can have good optical performance in the center portion and the edge portion of the field of view (FOV) and can have excellent optical characteristics.

TABLE 5

| | | First | Second |
|---|---|---|---|
| Mathematical Expression | | embodiment | embodiment |
| 1 | 0.5 < CT1/ET1 < 1 | 0.881 | 0.9500 |
| 2 | 0.1 < CT1/CA_L1S1 < 0.5 | 0.201 | 0.3808 |
| 3 | Po1 < 0 | −0.0128 | −0.0194 |
| 4 | 1.7 < n1 < 2.2 | 1.7727 | 1.8877 |
| 5 | 27 < FOV_H < 33 | 29.98 | 29.95 |
| 6 | (First embodiment) | Satisfy | Satisfy |
| | L3R1 > 0, L3S2 < 0 | | |
| | (Second embodiment) | | |
| | L3R1 > 0, L3R2 < 0, | | |
| | \|L3R1\| = \|L3R2\| | | |
| 7 | 1 < L7S2_max_sag to Sensor < 3 | 2.7 | 2.599 |
| 8 | 1 < CT1/CT7 < 3 | 1.662 | 1.49963 |
| 9 | 1 < CT45/CT6 < 5 | 1.698 | 1.7737 |
| 10 | 0.5 < (CT45-ET45) < 1 | 0.676 | 0.3983 |
| 11 | 0 < CA_L1S1/CA_L4S1 < 2 | 1.3484 | 1.045 |
| 12 | 0 < CA_L7S2/CA_L5S2 < 2 | 1.003 | 0.961 |
| 13 | 0 < CA_L1S2/CA_L2S1 < 2 | 1.334 | 1.005 |
| 14 | 0.5 < CA_L4S1/CA_L5S2 < 2.5 | 1.364 | 1.270 |
| 15 | 2 < L3R1/(CA_L3S1/2) < 5 | 2.909 | 3.657 |
| 16 | 1 < CA_GL_AVER/ | 1.038 | 1.1437 |
| | CA_PL_AVER < 1.5 | | |
| 17 | 1.2 < GL_CA1_AVER/ | 1.566 | 1.133 |
| | PL_CA1_AVER < 2 | | |
| 18 | CG3 < CG5 < CG1 | Satisfy | Satisfy |
| 19 | 1 < CT7/CG6 < 3 | 1.2074 | 2.2203 |
| 20-1 | 5 < \|F6/F5\| < 10 | 8.205 | — |
| 20-2 | 2(CG5 + CG6) < CT45 | — | Satisfy |
| 21 | 1 < CT1/CT2 < 2 | 1.329 | 1.0375 |
| 22 | 150 < L7R1/CT7 < 200 | 196.255 | 7.4410 |
| 23 | 0 < CT_Max/CG_Max < 5 | 0.2959 | 3.2413 |
| 24 | 1 < ΣCT/ΣCG < 7 | 1.3012 | 6.1250 |
| 25 | 10 < ΣIndex < 20 | 11.6546 | 11.6613 |
| 26 | 10 < ΣAbb/ΣIndex < 35 | 27.786 | 24.8189 |
| 27 | 1 < ΣCT/ΣET < 2 | 1.1129 | 1.0920 |
| 28 | 1 < CA_L3S1/CA_min < 2 | 1.6499 | 1.4611 |
| 29 | 1 < CA_max/CA_min < 3 | 2.174 | 1.5464 |
| 30 | 1 < CA_max/CA_Aver < 3 | 1.481 | 1.2014 |
| 31 | 0.5 < CA_min/CA_Aver < 1 | 0.681 | 0.7769 |
| 32 | 1 < CA_max/(2*ImgH) < 3 | 1.782 | 1.3655 |
| 33 | 1 < TD/CA_max < 4 | 2.2527 | 2.4703 |
| 34 | 0 < F/L1R1 < 1 | 0.6396 | 0.5184 |
| 35 | 1 < Max_th/Min_th < 3 | 1.9475 | 2.5226 |
| 36 | 0 < EPD/\|L1R1\| < 1 | 0.3997 | 0.3240 |
| 37 | Po4 * Po5 < 0 | Satisfy | Satisfy |
| 38 | 30 < V4-V5 < 40 | 34.4943 | 34.4943 |
| 39 | 0 < \|F1\|/F < 10 | 5.1124 | 3.4088 |
| 40 | F_LG1/F_LG2 < 0 | −5.9376 | −10.6197 |
| 41 | 0.1 < nGL/nPL < 2 | 1.333 | 0.75 |
| 42 | CA_L7 < CA_L3 < CA_L1 | Satisfy | Satisfy |
| 43 | 0 < ΣPL_CT/ΣGL_CT < 1 | 0.6417 | 0.9849 |
| 44 | 0 < ΣPL_Index/ΣGL_Index < 2 | 0.7165 | 1.2173 |
| 45 | 10 < TTL < 45 | 39.9073 | 33.9650 |
| 46 | 2 < ImgH < 10 | 4.630 | 4.630 |
| 47 | 1 < BFL < 3.5 | 2.7135 | 2.7263 |
| 48 | 3 < F < 40 | 15.2996 | 15.100 |
| 49 | FOV < 45 | 34.1913 | 33.9838 |
| 50 | 1 < TTL/CA_max < 5 | 2.417 | 2.6859 |
| 51 | 2 < TTL/ImgH < 10 | 8.619 | 7.3358 |
| 52 | 0.1 < BFL/ImgH < 1 | 0.6219 | 0.5888 |
| 53 | 5 < TTL/BFL < 20 | 14.7069 | 12.4582 |
| 54 | 1 < TTL/F < 3 | 2.6083 | 2.2493 |
| 55 | 3 < F/BFL < 10 | 5.6383 | 5.5386 |
| 56 | 1 < F/ImgH < 5 | 3.3044 | 3.2613 |
| 57 | 1 < F/EPD < 5 | 1.600 | 1.600 |
| 58 | 0 < BFL/TD < 0.3 | 0.0729 | 0.0872 |
| 59 | 0 < EPD/ImgH/FOV < 0.2 | 0.0604 | 0.0599 |
| 60 | 5 < FOV/F# < 30 | 21.369 | 21.2398 |
| 61 | 0.2 < CG1/TTL < 0.6 | 0.329 | — |
| 62 | 5 < \|F2/F5\| < 10 | — | 6.8309 |
| 63 | 2 < \|F2/F3\| < 10 | — | 4.7066 |
| 64 | 0.05 < \|sag_i/(CA_i/2)\| < 0.2 | Satisfy | Satisfy |
| | (i = S1, S2, S3, S4) | | |

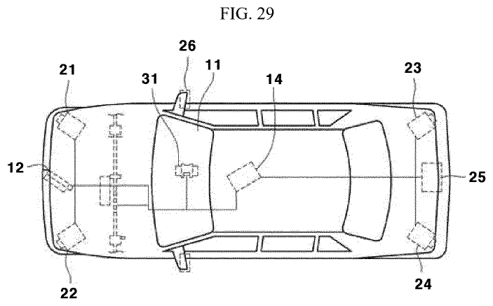

FIG. 29 is an example of a plan view of a vehicle to which a camera module or optical system according to an embodiment of the invention is applied. Referring to FIG. 29, a vehicle camera system according to an embodiment of the invention includes an image generation unit 11, a first information generation unit 12, a second information generation unit 21, 22, 23, 24, 25, and 26, and a control unit 14. The image generation unit 11 may include at least one camera module 31 being disposed in own vehicle, and may capture images of the front of the own vehicle and/or the driver to generate images of the front or interior of the vehicle. The image generation unit 11 may photograph images of the front of the own vehicle as well as the surroundings of the own vehicle in one or more directions using the camera module 31, to generate images of the surroundings of the own vehicle. Here, the front and surrounding images may be digital images, and may include color images, black and white images, and infrared images. In addition, the front and surrounding images may include still images and moving images. The image generation unit 11 provides the driver image, the front image, and the surrounding image to the control unit 14. Next, the first information generation unit 12 may include at least one radar and/or camera being disposed in the own vehicle, and detects the front of the own vehicle to generate the first detection information. Specifically, the first information generation unit 12 is disposed in the own vehicle, and detects the position and speed of vehicles located in front of the own vehicle, the presence and position of pedestrians, and the like to generate the first detection information.

By using the first detection information generated by the first information generation unit 12, the distance between the own vehicle and the vehicle in front can be controlled to be maintained at a constant level, and the stability of vehicle operation can be improved in specific preset cases, such as when the driver wants to change the driving lane of the own vehicle or when backing up. The first information generation unit 12 provides the first detection information to the control unit 14. The second information generation units 21, 22, 23, 24, 25, and 26 detect each side of the own vehicle and generates the second detection information based on the front image generated by the image generation unit 11 and the first detection information generated by the first information generation unit 12. Specifically, the second information generation unit 21, 22, 23, 24, 25, and 26 can include at least one radar and/or camera being disposed in the own vehicle, and can detect the position and speed of vehicles located on the side of the own vehicle or photograph images. Here, the second information generation units 21, 22, 23, 24, 25, and 26 can be disposed at the front two corners, side mirrors, and rear center and rear two corners of the own vehicle, respectively.

At least one information generation unit of these vehicle camera systems may be equipped with the optical system and the camera module having the same as described in the embodiments disclosed above, and may provide or process information acquired through the front, rear, each side or corner area of the own vehicle to a user to enable autonomous driving or to protect the vehicle and objects from surrounding for safety.

The optical system of the camera module according to the embodiment of the invention can be mounted in multiple units in a vehicle for safety regulation, reinforcement of autonomous driving function, and increased convenience. In addition, the optical system of the camera module is applied in a vehicle as a component for control such as a lane keeping assistance system (LKAS), a lane departure warning system (LDWS), and a driver monitoring system (DMS). Such a vehicle camera module can implement stable optical performance even under changes in ambient temperature, and can provide a module with price competitiveness, thereby securing the reliability of vehicle components.

The features, structures, effects, and the like described in the embodiments above are included in at least one embodiment and are not necessarily limited to only one embodiment. Furthermore, the features, structures, effects, and the like illustrated in each embodiment can be combined or modified and implemented in other embodiments by a person with ordinary knowledge in the field to which the embodiments belong. Therefore, contents related to such combinations and modifications should be interpreted as being included in the scope of the embodiments.

In addition, although the above has been described with reference to embodiments, these are merely examples and do not limit the present invention, and those with ordinary skill in the art to which the present invention pertains will recognize that various modifications and applications not exemplified above are possible without departing from the essential characteristics of the present invention. For example, each component specifically shown in the examples can be modified and implemented. And, the differences related to such modifications and applications should be interpreted as being included in the scope of the present invention defined in the appended claims.

1. An optical system comprising:
a first lens to a seventh lens being disposed along an optical axis,
wherein the first lens has a negative (−) refractive power,
wherein the combined refractive power of the second lens to the seventh lens has a positive (+) refractive power, and
wherein the second lens among the first lens to the seventh lens has a smallest effective diameter, and the effective diameter of the first lens is the greatest.

2. The optical system according to claim 1,
wherein the fourth lens, the fifth lens, and the seventh lens are made of a plastic material, and
wherein at least one among the first lens to the third lens and the sixth lens is made of a glass material.

3. The optical system according to claim 1,
wherein the effective diameters of the sixth lens and the seventh lens are smaller than the effective diameter of the fifth lens.

4. The optical system according to claim 3,
wherein an object side surface of the second lens has a flat surface.

5. The optical system according to claim 1,
wherein among the first lens to the seventh lens, the lens having the smallest absolute value of focal length is one among the third lens to the fifth lens.

6. The optical system according to claim 5,
wherein the absolute values of the focal lengths of the third to fifth lenses satisfy the following conditional expression:
$$\vert F 3 \vert \geq \vert F 4 \vert \geq \vert F 5 \vert \qquad 〈 Conditional expression 〉$$
(In the above conditional expression, F3 is the focal length of the third lens, F4 is the focal length of the fourth lens, and F5 is the focal length of the fifth lens).

7. An optical system comprising:
a first lens to a seventh lens being disposed along the optical axis, wherein the first lens has a negative (−) refractive power,
wherein the combined refractive power of the second lens to the seventh lens has a positive (+) refractive power, and
wherein the effective diameter of the first lens is larger than the effective diameter of the third lens.

8. The optical system according to claim 7,
wherein the optical system includes a cemented lens in which a lens having positive (+) refractive power and a lens having negative (−) refractive power are bonded, and
wherein the cemented lens is formed of two lenses being consecutively disposed among the third to fifth lenses.

9. The optical system according to claim 8,
wherein the cemented lens is made of a plastic material, and
wherein at least one among the first lens to the third lens and the sixth lens is made of a glass material.

10. The optical system according to claim 7,
wherein among the first lens to the seventh lens, the absolute value of the focal length of the fifth lens is the smallest, and the absolute value of the focal length of the sixth lens is the largest.

11. The optical system according to claim 8, wherein at least one of the lenses being disposed most adjacent to the cemented lens on the object side of the cemented lens and the lenses being disposed most adjacent to the cemented lens on the sensor side of the cemented lens has a biconvex shape.

12. The optical system according to claim 7, wherein the absolute value of the radius of curvature of a sensor side surface of the cemented lens is smaller than the absolute value of the radius of curvature of the object side surface of the cemented lens.

13. An optical system comprising:
a first to a seventh lens being disposed along an optical axis,
wherein among the first to seventh lenses, the absolute value of the focal length of the sixth lens is the largest, the absolute value of the focal length of the fifth lens is the smallest, and the following conditional expression is satisfied:
$$0.2 < CG 1 / TTL < 0.6 \qquad 〈 Conditional expression 〉$$
(In the conditional expression, CG1 is a distance between the first lens and the second lens on the optical axis, and TTL is a distance from an object side surface of the first lens in the optical axis to the image sensor).

14. The optical system according to claim 13, wherein the ratio of the absolute values of the focal lengths of the sixth lens and the fifth lens is greater than 5 times and less than 10 times.

15. The optical system according to claim 13, wherein the absolute values of the focal lengths of the third to fifth lenses satisfy the following conditional expression:
$$\vert F 3 \vert \geq \vert F 4 \vert \geq \vert F 5 \vert \qquad 〈 Conditional expression 〉$$
(In the above conditional expression, F3 is the focal length of the third lens, F4 is the focal length of the fourth lens, and F5 is the focal length of the fifth lens).

16. The optical system according to claim 13, wherein in the optical axis, the seventh lens is the smallest thickness among the first to seventh lenses, and
wherein in the optical axis, the fourth lens is the largest thickness among the first to seventh lenses.

17. The optical system according to claim 13, wherein the thickness of the second lens in the optical axis is smaller than the thicknesses of the third lens and the fourth lens.

18. The optical system according to claim 13, wherein the first lens has a meniscus shape convex toward the object side.

19. The optical system according to claim 13, wherein the third lens has a biconvex shape.

20. The optical system according to claim 13, wherein the first lens, the fifth lens, and the seventh lens have negative (−) refractive power, and
wherein the second lens, the third lens, the fourth lens, and the sixth lens have positive (+) refractive power.
